(19) United States
(12) Patent Application Publication
(10) Pub. No.: US 2024/0208145 A1
(43) Pub. Date: Jun. 27, 2024

(54) COMFORT FIBER

(71) Applicant: Moon Creative Lab Inc., Palo Alto, CA (US)

(72) Inventors: Naum Naveh, Ra'anana (IL); Gilad Otorgust, Herzliya (IL); Danit Peleg, Tel Aviv (IL); Tetsuya Ohara, Lafayette, CA (US)

(73) Assignee: Moon Creative Lab Inc., Palo Alto, CA (US)

(21) Appl. No.: 18/584,576

(22) Filed: Feb. 22, 2024

Related U.S. Application Data
(63) Continuation-in-part of application No. PCT/US2022/081567, filed on Dec. 14, 2022.
(60) Provisional application No. 63/486,385, filed on Feb. 22, 2023.

(30) Foreign Application Priority Data
Dec. 15, 2021 (JP) 2021203507

(51) Int. Cl. B29C 64/314; B29C 48/05; B29C 48/21; B29C 48/40; B33Y 70/00; B29C 64/118; B29K 21/00; B29K 105/12; B29K 105/16

(52) U.S. Cl. CPC B29C 64/314; B29C 48/05; B29C 48/21; B29C 48/40; B33Y 70/00; B29C 64/118; B29K 2021/003; B29K 2105/12; B29K 2105/16

(57) ABSTRACT

To provide a forming material or a flock product having a comfortable tactile feeling. A core/sheath structure composing a forming material or a formed product which is a melted and cured product of the forming material, comprising: a core having a linear shape and an outer peripheral surface and including a first thermoplastic polymer; and a sheath covering the outer peripheral surface and including a second thermoplastic polymer and at least one selected from a group consisting of fibers and particles dispersed in the second thermoplastic polymer. A flock product comprising: a main body having a surface and composed of a forming material including a thermoplastic polymer or a formed product which is a melted and cured product of the forming material; an adhesive layer arranged on the surface; and a flock pierced into the adhesive layer.

### REFERENCE TO RELATED APPLICATIONS

The present application claims priority to U.S. Provisional Application No. 63/486,385 (filed on Feb. 22, 2023) and to PCT Application No. PCT/US2022/081567 (filed on Dec. 14, 2022), which claims priority to Japanese Patent Application No. 2021-203507 (filed on Dec. 15, 2021). Each of U.S. Provisional Application No. 63/486,385, PCT Application No. PCT/US2022/081567, and Japanese Patent Application No 2021-203507 are incorporated by reference herein in their entirety.

### FIELD OF THE INVENTION

The present disclosure relates to core/sheath structure, method for manufacturing flock products, and flock products. These flock products are filaments that may be crafted or formed (e.g., woven) into textiles with desirable properties.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

U.S. Patent Application Publication No. 2017/0268133 discloses a consumable filament. The consumable filament is melted and extruded in an additive manufacturing system. The consumable filament includes a core portion and a sheath portion encasing the core portion. The core portion comprises a matrix of a first base polymer and particles dispersed in the matrix. The sheath portion comprises a second base polymer. The particles of the core portion are selected from metallic particles, nonmetallic particles, magnetic particles, and a combination thereof, and may be ferrite particles (paragraph [0005]). The particles of the core portion do not penetrate an outer surface of the sheath portion (paragraph [0074]).

### SUMMARY

In one or some embodiments, a core/sheath structure composing a forming material or a formed product which is generated from the forming material is disclosed. The core/sheath structure includes: a core having a linear shape and an outer peripheral surface and including at least one thermoplastic polymer; and a sheath at least partly covering the outer peripheral surface and including one or both of fibers or particles.

In one or some embodiments, a formed product is disclosed. The formed product includes: one or more layers, the one or more layers comprising at least one core/sheath structure comprising: a core having a linear shape and an outer peripheral surface and including at least one thermoplastic polymer; and a sheath at least partly covering the outer peripheral surface and including one or both of fibers or particles.

In one or some embodiments, a method (such as an at least partly or an entirely computer-implemented method) for manufacturing a flock product is disclosed. The method includes: arranging an adhesive layer on a surface of a material to be treated composed a forming material including a thermoplastic polymer or a formed product which is a melted and cured product of the forming material; abutting at least one flock to or piercing the at least one flock into the adhesive layer; and after abutting the at least one flock to or piercing the at least one flock into the adhesive layer, curing the adhesive layer.

In one or some embodiments, a flock product is disclosed. The flock product includes a main body having a surface and composed of a forming material including a thermoplastic polymer or a formed product which is a melted and cured product of the forming material; an adhesive layer arranged on the surface; and a flock abutting on or pierced into the adhesive layer.

In one or some embodiments, a method (such as an at least partly or an entirely computer-implemented method) for producing a filament is disclosed. The method includes: using one or more extruders to extrude a first set of materials for a core of the filament and a second set of materials for a sheath of the filament, wherein the second set of materials comprises at least one or both of fibers or particles; using a core section and a sheath section of at least one die head in order to route the first set of materials and the second set of materials, respectively, that are extruded from the one or more extruders; and during or after using the core section and the sheath section of the at least one die head, forming the filament by cooling the first set of materials and the second set of materials.

In one or some embodiments, a method (such as an at least partly or an entirely computer-implemented method) for processing a 3D printed formed product is disclosed. The method includes: receiving a formed product that has been 3D printed; and after receiving the formed product, performing at least one of laser radiation treatment or plasma treatment on the formed product.

In one or some embodiments, an apparatus configured to process a 3D printed formed product is disclosed. The apparatus includes: at least one of a laser radiation device or a plasma treatment device configured to receive a formed product 3D printed from at least one 3D printer; and at least one controller configured to control the at least one of the laser radiation device or the plasma treatment device in order to apply laser radiation or plasma treatment on the formed product.

In one or some embodiments, a core/sheath structure composing a forming material or a formed product which is generated from the forming material is disclosed. The core/sheath structure includes: a core having a linear shape and an outer peripheral surface and including at least one thermoplastic polymer; and a sheath at least partly covering the outer peripheral surface and including: (i) one or both of fibers or particles; and (ii) at least one of: a soluble substance; an antimicrobial substance; an ultraviolet protection substance; an odor management substance; or a moisture management substance.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a perspective view schematically illustrating a forming material of a first embodiment.

FIG. 2 is a cross-sectional view schematically illustrating a forming material of a first embodiment.

FIG. 3 is a photograph of a cross section of a prototype of a forming material of a first embodiment.

FIG. 4 is a cross-sectional view schematically illustrating a forming material of a variant of a first embodiment.

FIG. 5 is a plan view schematically illustrating a formed product of a second embodiment.

FIG. 6 is a cross-sectional view schematically illustrating a linear body provided in a formed product of a second embodiment.

FIG. 7 is a scanning electron microscope (SEM) micrograph of an entire cross section of a linear body provided in a prototype of a formed product of a second embodiment.

FIG. 8 is a SEM micrograph of a periphery of a cross section of a linear body provided in a prototype of a formed product of a second embodiment.

FIG. 9 is an enlarged cross-sectional view schematically illustrating a vicinity of an interface between a formed product of a second embodiment and a human skin contacting a formed product.

FIG. 10 is a SEM micrograph of a cross section of a prototype of a formed product of a second embodiment.

FIG. 11 is a SEM micrograph of a cross section of a prototype of a formed product of a second embodiment.

FIG. 12 is a SEM micrograph of a cross section of a prototype of a formed product manufactured by using a monofilament.

FIG. 13 is a SEM micrograph of a cross section of a prototype of a formed product manufactured by using a monofilament.

FIG. 14 is a SEM micrograph of an upper surface of a prototype of a formed product manufactured by using a monofilament.

FIG. 15 is a SEM micrograph of an upper surface of a prototype of a formed product manufactured by using a monofilament.

FIG. 16 is a SEM micrograph of a prototype of a formed product manufactured by using a forming material of a variant of a first embodiment.

FIG. 17 is a micrograph of a monofilament made of polyester.

FIG. 18 is a micrograph of a multifilament made of polyester.

FIG. 19 is a side view schematically illustrating a three-dimensional (3D) printer used for manufacturing a formed product of a second embodiment.

FIG. 20 is a plan view schematically illustrating a flock product of a third embodiment.

FIG. 21 is an enlarged cross-sectional view schematically illustrating a vicinity of an interface between a formed product of a third embodiment and a human skin contacting a formed product.

FIG. 22 is a perspective view schematically illustrating an electrostatic deposition apparatus used for manufacturing a flock product of a third embodiment.

FIG. 23 is a flowchart showing a flow of manufacturing of a flock product of a third embodiment.

FIG. 24 is a photograph of a prototype of a main body provided in a flock product of a third embodiment.

FIG. 25 is a photograph of a prototype of a flock product of a third embodiment.

FIG. 26 illustrates a comparative cross-sectional view of a contemporary filament and a comfort fiber.

FIG. 27A illustrates a cross section of a comfort fiber with a medium loading of particles in the associated sheath layer.

FIG. 27B illustrates a cross section of a comfort fiber with a high loading of particles in the associated sheath layer.

FIG. 28 is a flow diagram depicting the process of creating a comfort fiber and an article of clothing from the comfort fiber.

FIGS. 29A-B depict a monofilament based on TPU.

FIGS. 30A-B depict a core/sheath filament with cotton powder in the sheath layer.

FIGS. 31A-B depict different scaled magnified views of an outer surface of a core/sheath filament with cotton particles in the sheath layer.

FIG. 32A-B depict a core/sheath filament with wool particles in the sheath layer.

FIGS. 33A-B depict magnified views of an outer surface of a core/sheath filament with wool particles in the sheath layer.

FIGS. 34A-B depict cross-section views of a 3D printed fabric based on a core/sheath filament (e.g., a comfort filament) with cotton particles in the sheath layer.

FIGS. 35A-B depict cross-section views of a 3D printed fabric based on a core/sheath filament (e.g., a comfort filament) with cotton particles in the sheath layer.

FIGS. 36A-B depict a printed fabric based on a TPU monofilament.

FIGS. 37A-B depict cross-section views of the printed fabric based on a TPU monofilament presented in FIGS. 36A-B.

FIGS. 38A-B depict a final product (e.g., a printed fabric) based on a core/sheath filament (e.g., a comfort fiber) with cotton particles in the sheath layer.

FIG. 39 is a table summarizing tensile test results for 100, 200 and 300% elongation at standard conditions (23° C., 50% RH).

FIG. 40 is a table summarizing tensile test results for the chemical resistance to sea-water and chlorinated water, considering the modulus (recorded stress) at 100, 200 and 300% elongation as a measure to chemical resistance.

FIG. 41 is a table illustrating the moisture level for different comfort filament, at different exposure times.

FIG. 42 is a block diagram of an example system for filament production.

FIG. 43 is an example flow diagram for filament production.

FIG. 44 is a block diagram of an example system for applying laser radiation.

FIG. 45 is an example flow diagram for laser ablation.

FIG. 46 is a block diagram of an example system for plasma treatments.

FIG. 47 is an example flow diagram for plasma treatments.

FIG. 48 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation. The term “substantially” means within no more than ±10% variation, such as no more than ±9% variation, no more than ±8% variation, no more than ±7% variation, no more than ±6% variation, no more than ±5% variation, no more than ±4% variation, no more than ±3% variation, no more than ±2% variation, no more than ±1% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

3D printing may be performed in one of several ways. In one way, 3D printing may comprise an extrusion printing process. For example, fused deposition modeling (FDM) may use filaments, such as disclosed in U.S. Patent Application Publication No. 2017/0268133 using consumable filament, as discussed in the background.

In the context of filaments, when a formed product is manufactured by using consumable filaments such as disclosed in U.S. Patent Application Publication No. 2017/0268133, the formed product may have a rubbery or a plastic-like tactile feeling, or the like, and may not have a comfortable tactile feeling. In this regard, in one or some embodiments, a formed product or a flock product having a comfortable tactile feeling is disclosed.

In one or some embodiments, a forming material (e.g., a filament for a 3D printer) is disclosed that includes a core and one or more sheaths (e.g., one or more shells). In one or some embodiments, the sheath(s) include one or both of fibers or particles. As discussed in more detail below, the fibers and/or particles in the sheath(s), as a segmented and/or separate layer and/or protruding from an external surface of the core and thus being closer than the core to the skin of a user, may impart properties to the forming material. Thus, in one or some embodiments, the one or more sheaths may include at least one material (e.g., the fibers and/or particles) that is different from material(s) in the core. Alternatively, one or more material(s) in the sheath(s) may be included in the core.

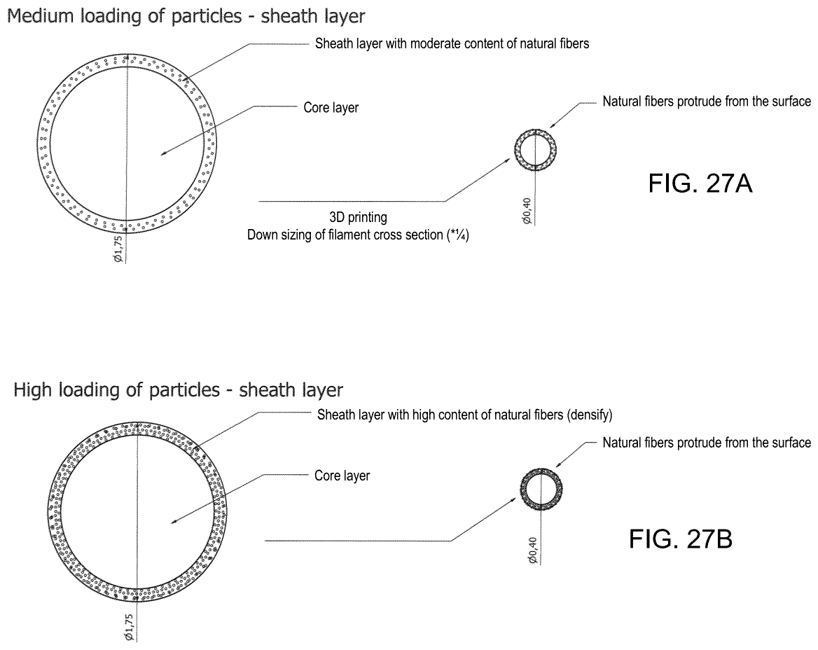

In one or some embodiments, the forming material may then be used to created a formed product. As discussed in more detail below, the formed product may be produced from the forming material in one of several ways, such as by: 3D printing using the forming material as a filament in order to generate the formed product; knitting, weaving, and/or sewing the forming material; etc. In either instance, the formed product generally retains the core/sheath construction of the underlying forming material. For example, with regard to 3D printing, the formed product may comprise one or more layers (interchangeably termed printed layers), with the one or more layers generally retains the core/sheath construction, though with potentially certain modifications. In one particular modification, the one or more layers may have a different diameter than the forming material (e.g., the diameter of the one or more layers may be smaller than the diameter of the forming material: see FIGS. 27A-B in which the diameter of the printed layer decreases to 0.4 mm from a diameter of 1.75 mm of the forming material, effectively downsizing by at least ¼). In another particular modification, an exterior surface of the one or more layers may be different from an exterior surface of the forming material (e.g., one or more materials in the sheath layer, such as fibers and/or particles, may protrude from the exterior surface of the layer (see FIGS. 27A-B), which may be of benefit to the user of the formed product). Thus, the formed product may be composed of one or more layers that have a core/sheath structure, as discussed further below.

In one or some embodiments, various materials in the sheath of the forming material are contemplated, which in turn may impact the formed product. As one example, a thermoplastic polymer may be used in the sheath(s) which is of the same type or a different type from the thermoplastic polymer in the core. As another example; fibers and/or particles may be included in the core that may be: (i) the same type or a different type from the fibers and/or particles in the sheath(s); or (ii) the same or different concentration from the concentration of fibers and/or particles in the sheath(s). In this regard, the sheath(s), which in one embodiment is formed separately from the core and including the fibers and/or particles, may impart the desired properties for the forming material that may be different from the properties imparted by the core itself. Alternatively, the sheath may be formed by the fibers and/or particles protruding from the core.

Thus, various ways are contemplated for the fibers and/or the particles to be manifested in the sheath. In one or some embodiments, the fibers and/or particles may be within a material that is separate from (and placed on an outer surface of) the core. For example, the core may comprise at least one thermoplastic polymer (such as a single thermoplastic polymer) and the one or more sheaths may comprise the fibers and/or particles within or on at least one thermoplastic polymer that at least partly encircles the core (e.g., a single sheath that at least partly encircles the core that comprises a thermoplastic polymer and one or both of the fibers or particles). In this way, the fibers and/or particles may be suspended in and/or on another medium (such as thermoplastic polymer(s) similar or identical to the core or a material other than a thermoplastic polymer). In one embodiment, the at least one thermoplastic layer of the core is the same as the at least one thermoplastic layer of the sheath. Alternatively, the at least one thermoplastic layer of the core is different from the at least one thermoplastic layer of the sheath in one or more aspects (e.g., different Shore A values). Regardless, the fibers and/or particles that are part of the sheath(s) may impart qualities different from the thermoplastic elastomer(s) of the core.

Alternatively, or in addition, to the fibers and/or particles being within a material that is separate from (and placed on an outer surface of) the core, the fibers and/or particles in the sheath may be directly placed on a surface. As one example, the fibers and/or particles may be sprayed with adhesive onto an outer surface of the core. In this regard, the sheath consists of the fibers and/or particles (and optionally with an adhesive) placed on the outer surface of the core, without any intermediary material (such as a thermoplastic layer) from which to be suspended therein. In one particular non-limiting example, flock fibers may be deposited (e.g., flocked) on the outer surface of the core once emerged from the die head, with an adhesive, such as a thermoplastic emulsion, being used to bond the fibers until printing. As another example, the fibers and/or particles may be sprayed with adhesive onto an outermost surface of a sheath. Again, in this way, the fibers and/or particles may contact the skin of a user, and thereby may impart qualities different from the core and/or any intermediary sheaths.

Thus, in one or some embodiments, the sheath(s) may be composed of any one, any combination, or all of: (i) plastic polymer(s) (e.g., thermoplastic polymer(s)); (ii) fibers and/or particles; (iii) soluble substance(s) (e.g., water-soluble substance(s), such as a water-soluble synthetic polymer (e.g., Polyvinyl alcohol (PVA)); (iv) antimicrobial substance(s) (e.g., any one, any combination, or all of antibacterial, antifungal, antiviral); (v) sun or Ultraviolet Protection Factor (UPF) protection (e.g., zinc oxide); (vi) odor management (e.g., zinc oxide; coffee powders); or (vii) moisture management (e.g., coffee powders). In this regard, because the various respective components of (i)-(vii) may be included in the sheath (and in one embodiment, only in the sheath), the amount of the respective components needed for an acceptable effect may be less than if the respective components were included within the core, which is of particular benefit, particularly for more expensive materials (e.g., wool).

As one example, the sheath may be composed (or consist) of plastic polymer(s), fibers and/or particles, and soluble substance(s). As another example, the sheath may be composed (or consist) of plastic polymer(s) and soluble substance(s). In either instance, with regard to a sheath being at least partly composed of a soluble material, such as a water soluble material, after 3D printing the formed product, the formed product may be subject to post processing in order to remove at least some of the soluble material.

Various percentages of the TPU and the fibers/particles are contemplated. In one or some embodiments, the percentage of TPU may be greater than the percentage of the fibers/particles. As one example, the percentage of TPU may be at least double, at least triple, at least quadruple, or at least quintuple the percentage of the fibers/particles.

In the context of a sheath with a water soluble material, the post processing of the formed product may comprise exposing the formed product to water (e.g., washing the formed product with water). In performing the washing, part or all of the water soluble material may be removed from the sheath, which may enhance the fibers and/or particles in the sheath or make the effect of the fibers and/or particles on the skin more pronounced (e.g., softer feeling to the skin).

Various percentages of the TPU, the PVA, and the fibers/particles are contemplated. In one or some embodiments, the percentage of TPU may be greater than each of the percentage of the PVA and the fibers/particles. Alternatively, the percentage of TPU may be greater than the percentage of the PVA and the percentage of the fibers/particles combined. Still alternatively, the percentage of TPU may be equal (or less than) the percentage of fibers/particles. In this regard, the formed product, depending on the selected percentages, may be more or less durable, more or less fragile, more or less elastic, etc.

As one example, in one or some embodiments, the sheath(s) may comprise a thermoplastic polymer, fibers and/or particles, and a PVA substance. After 3D printing, the formed product may be exposed to water in order to break-down part or all of the PVA in the sheath(s). In this regard, with the removal of the PVA, an effect of the fibers and/or particles in the sheath(s) on the skin of the wearer may be further accentuated.

As discussed above, the forming material may be used in one of several ways for 3D printing and/or for non-3D printing in order to generate the formed product. For example, in one or some embodiments, the forming material (e.g., the filament with the core/sheath(s)) may be introduced directly into the 3D printer to 3D print the formed product. The formed product may thus be composed of one or more layers (interchangeably termed 3D-printed layers) with at least one, at least some, or all of the one or more layers having the core/sheath structure (with one, some, or all of the features of the core and/or the sheath described herein). In this regard, the 3D printer, using the forming material, may generate the formed product in layer(s) with the core/sheath structure, and may thus be afforded the benefits of the core/sheath structure. As one example, the core/sheath structure enables various materials to be included within the sheath, such as fibers and/or particles, which may allow for less use of the fibers and/or particles (since the fibers and/or particles are not included in the core or are included in a lower percentage in the core), while still allowing the benefits of the fibers and/or particles (e.g., the fibers and/or particles may contact the skin). Thus, in one or some embodiments, a formed product may be printed entirely from forming material with the core/sheath structure, so that all layers of the formed product have the core/sheath structure. Alternatively, a formed product may be printed from a first forming material with the core/sheath structure and a second forming material with the core structure (without a sheath), so that one or some layers of the formed product have the core/sheath structure (e.g., the outer layers that may contact the skin) and that other layers of the formed product have the core structure (e.g., the inner layers that may not contact the skin).

As another example, the forming product may be formed without 3D printing (e.g., by knitting, weaving, etc.) using the forming material (e.g., by knitting, weaving, etc. filaments). The forming material used in such a manner may be bound together (e.g., different filaments knitted or weaved together) in one of several ways, such as by applying heat and/or applying adhesive. Similar to above, a formed product may be generated entirely from forming material with the core/sheath structure, so that all layers of the formed product have the core/sheath structure. Alternatively, a formed product may be generated from a first forming material with the core/sheath structure and a second forming material with the core structure (without a sheath), so that one or some layers of the formed product have the core/sheath structure (e.g., the outer layers that may contact the skin) and that other layers of the formed product have the core structure (e.g., the inner layers that may not contact the skin). Regardless, the formed product (similar to the formed product by 3D printing) may have the core/sheath structure in one or more its layers.

In one or some embodiments, after generating the formed product (e.g., generating the formed product using 3D printing or not using 3D printing), one or more additional processes or treatments may be performed, including any one, any combination, or all of flocking, laser radiation treatment (e.g., laser ablation), or plasma treatment.

Thus, in one or some embodiments, flocking may be performed in which a flock (e.g., fibers) may be attached or bound to a surface of the formed product. For example, the flock may be bound to the surface that includes an adhesive by the flock abutting to and/or piercing into the surface of the formed product. In the context of abutting and/or piercing, an external force may be applied, such as via an electrostatic deposition device.

In one or some embodiments, laser radiation treatment (e.g., laser ablation) may be used to process the formed product (e.g., after 3D printing or after knitting and/or weaving filaments together). In particular, the formed product may comprise one or more layers, such as outer layers (e.g., whose outer surface may contact the skin of a user) and inner layers (e.g., none of whose surfaces contact the skin of the user). In one or some embodiments, one or more lasers may be used to apply laser radiation (e.g., perform laser ablation) in which laser radiation is applied to the one or more layers. As one example, laser radiation may be applied to one or more parts of the outer layer, such as one or both of the outer surface of the outer layer (which may contact the skin of the user) or an inner portion of the outer layer. In particular, laser radiation (e.g., laser ablation) may be applied to the surface of the outer layer (e.g., a surface of a sheath of the outer layer in a core/sheath structure of the formed product; or a surface of a core of the outer layer in a core structure (without a sheath) of the formed product) in order to ablate a pattern or other indicia on the surface of the outer layer. Alternatively, or in addition, laser radiation (e.g., laser ablation) may be applied to an interior of the outer layer (e.g., in the sheath of the outer layer in a core/sheath structure of the formed product; in a core of the outer layer in a core/sheath structure of the formed product; or in the core of the outer layer in a core structure (without a sheath) of the formed product), with the laser radiation modifying the interior of the outer layer in one of several ways (e.g., ablating or removing material, such as TPU in the sheath and/or in the core in order to accentuate other materials, such as fibers/particles in the sheath and/or in the core; and/or activating, using the laser radiation, materials within the sheath and/or in the core).

Alternatively, or in addition, as another example, laser radiation may be applied to one or more parts of the inner layer of the formed product, such as one or both of the outer surface of the inner layer or an inner portion of the inner layer. In particular, laser radiation (e.g., laser ablation) may be applied to an interior of the inner layer (e.g., in the sheath of the inner layer in a core/sheath structure of the formed product; in a core of the inner layer in a core/sheath structure of the formed product; or in the core of the inner layer in a core structure (without a sheath) of the formed product), with the laser radiation modifying the interior of the outer layer in one of several ways (e.g., ablating or removing material, such as TPU in the sheath and/or in the core in order to accentuate other materials, such as fibers/particles in the sheath and/or in the core; and/or activating, using the laser radiation, materials within the sheath and/or in the core). In this way, laser radiation may be used to modify properties of the formed product, such as moisture management (e.g., wicking and moisture uptake) and drapability.

In one or some embodiments, plasma treatment may be used to process the formed product (e.g., after 3D printing or after knitting and/or weaving filaments together). In particular, plasma surface treatment may be used to modify surface properties of the formed product, such as surface energy, functionalization and cleaning the surface (e.g., cleaning from contaminates).

### First Embodiment

### 1. Outline of Formed Material

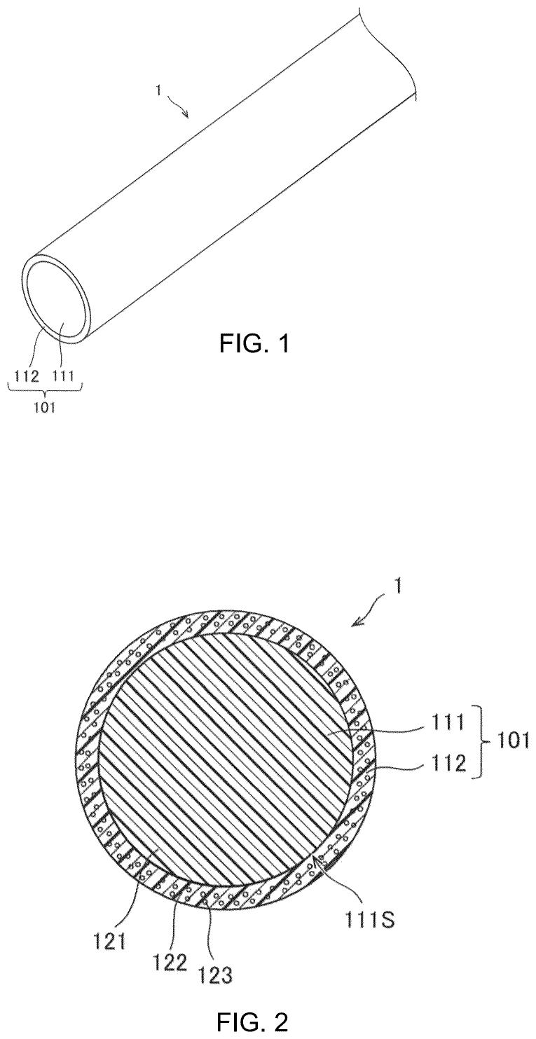

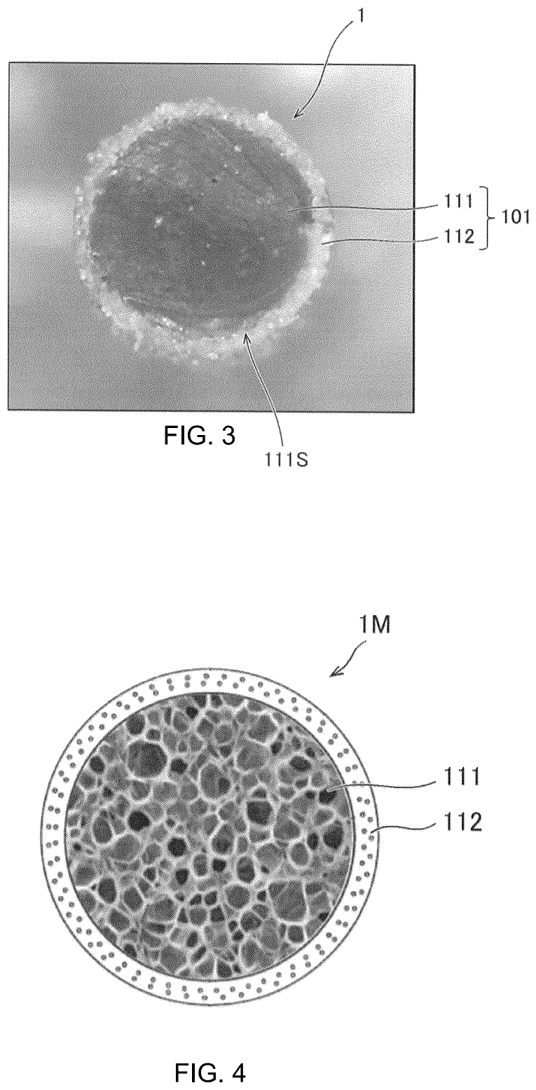

Referring to the figures, FIG. 1 is a perspective view schematically illustrating a forming material of a first embodiment. FIG. 2 is a cross-sectional view schematically illustrating forming material of a first embodiment. FIG. 3 is a photograph of a cross section of a prototype of a forming material of a first embodiment.

In one or some embodiments, a forming material 1 of a first embodiment shown in FIGS. 1, 2 and 3 may be used for manufacturing a formed product. Various formed products are contemplated. As one example, the formed product may be flat in form, similar to a section or bolt of fabric. In such a form, the formed product may be subjected to further processing, such as additional cutting or binding (e.g., connection to other fabrics formed by the forming material 1 or to other fabrics not formed by the forming material), so that the formed product may be transformed into an article for sale (e.g., a shirt, trousers, handbag, etc.). As another example, the formed product may comprise an end product for sale (e.g., a shirt, trousers, handbag, etc.) or may comprise a near-end product for sale (e.g., subject to additional processing, including flocking, laser ablation). In this regard, the formed product may take one of several forms and may be used at various steps in the manufacturing process.

When the formed product is manufactured by using the forming material 1, the forming material 1 may be melted, a shape may be given to the molten forming material, and the forming material given a shape may be cured. In this regard, the formed product that is a melted and cured product of the forming material 1 may be manufactured in one or some embodiments. Therefore, the forming material 1 may comprise a consumable good consumed for manufacturing the formed product.

In one or some embodiments, the forming material 1 may be used, for example, to manufacture the formed product by a three-dimensional (3D) printer, and may be used to manufacture the formed product by a fused filament fabrication (FFF) method or a fused deposition modeling (FDM) method. However, in alternate embodiments, the forming material 1 may be used to manufacture the formed product by a forming apparatus other than a 3D printer, or may be used to manufacture the formed product by a forming method other than the FFF method or the FDM method.

In one or some embodiments, the forming material 1 has a linear shape and/or has a thermoplastic property. In one or some embodiments, when the forming material 1 is used to manufacture the formed product, the forming material 1 may be heated while being sent in the length direction. Thereby, the forming material 1 may be melted. In one or some embodiments, the forming material 1 has flexibility and elasticity. The forming material 1 having these characteristics may also be called a filament. In one or some embodiments, when the forming material 1 is used to manufacture the formed product by a 3D printer, the forming material 1 has a circular cross-sectional shape and has a diameter suitable for the 3D printer. The diameter of the forming material 1 is, for example, 1.75 mm or 2.85 mm. See FIGS. 27A-B illustrating diameter of forming material as 1.75. However, the forming material 1 may have a cross-sectional shape other than a circular cross-sectional shape, and may have a diameter other than 1.75 mm or 2.85 mm. As one example, the circular cross-sectional shape may be less than 1.75 mm. As another example, the circular cross-sectional shape may be greater than 2.85 mm. As still another example, the circular cross-sectional shape may be in between 1.75 mm and 2.85 mm.

In one or some embodiments, the main part of the forming material 1 has a thermoplastic property. Thereby, the forming material 1 may be melted to be separated into a plurality of components. In addition, new forming materials or other types of products may be manufactured from the forming material 1. For this reason, the forming material 1 may be recyclable.

In one or some embodiments, the forming material 1 is sold in the self-made (do-it-yourself or DIY) market to consumers who may make their own formed products. Alternatively, or in addition, formed products manufactured by using the forming material 1 may be sold to ordinary consumers in ordinary stores and in ordinary markets.

### 2. Cross-Sectional Structure and Material Property of Forming Materials

As illustrated in FIGS. 1, 2 and 3, the forming material 1 may be composed of a core/sheath structure 101 comprising a core 111 and a sheath 112 and may have a two-layer structure. The sheath 112 may also be called a shell. The core/sheath structure 101 may also be called the core/shell structure. Alternatively, the forming material 1 may have a multilayer structure, with a three-layer structure or more. The forming material 1 having a multilayer structure with a two-layer structure or more (such as a three-layer structure, a four-layer structure, a five-layer structure, etc.) may also be called a multi-layer filament. In contrast to the multi-layer filament, a forming material having a single-layer structure may be called a monofilament.

As one example, a three-layer structure may include a core (such as core 111), a first sheath, and a second sheath, with the first sheath being coaxial with and positioned between the core and the second sheath. As another example, a four-layer structure may include a core (such as core 111), a first sheath, a second sheath, and a third sheath, with the first sheath being coaxial with and positioned between the core and the second sheath, and the second sheath being coaxial with and between the core and the third sheath.

In one or some embodiments, the core 111 has a linear shape. Further, in one or some embodiments, the core 111 has flexibility. In one aspect, the core 111 may be flexible, such as comprising materials that have a lower Young's modulus and/or lower hardness (e.g., 75 Shore A or less; 70 Shore A or less; 65 Shore A or less; 60 Shore A or less; etc.). As shown in FIGS. 1-2, the core 111 has a circular cross-sectional shape. Alternative cross-sectional shapes (e.g., oval, elliptical, etc.) are contemplated. In this regard, the core 111 may have a cross-sectional shape other than a circular cross-sectional shape. In one or some embodiments, the sheath 112 covers the outer peripheral surface 111S of the core 111. Therefore, the sheath 112 may be an outer layer located at the outside in a radial direction of the core 111 and is an outermost layer disposed at an outermost radial direction of the forming material 1. In this regard, the sheath 112 at least partly covers the outer peripheral surface 111S of the core 111. In this regard, in one or some embodiments, the sheath 112 may cover the entirety of the outer peripheral surface 111S (e.g., 100% of the entirety of the outer peripheral surface 111S). Alternatively, the sheath 112 may cover at least some (but not all) of the entirety of the outer peripheral surface 111S (e.g., the sheath 112 may cover at least or more than 50% of the entirety of the outer peripheral surface 111S; the sheath 112 may cover at least 60% of the entirety of the outer peripheral surface 111S; the sheath 112 may cover at least 70% of the entirety of the outer peripheral surface 111S; the sheath 112 may cover at least 75% of the entirety of the outer peripheral surface 111S; the sheath 112 may cover at least 80% of the entirety of the outer peripheral surface 111S; the sheath 112 may cover at least 85% of the entirety of the outer peripheral surface 111S; the sheath 112 may cover at least 90% of the entirety of the outer peripheral surface 111S; the sheath 112 may cover at least 95% of the entirety of the outer peripheral surface 111S; the sheath 112 may cover at least 96% of the entirety of the outer peripheral surface 111S; the sheath 112 may cover at least 97% of the entirety of the outer peripheral surface 111S; the sheath 112 may cover at least 98% of the entirety of the outer peripheral surface 111S; the sheath 112 may cover at least 99% of the entirety of the outer peripheral surface 111S).

As illustrated in FIG. 2, the core 111 includes a first thermoplastic polymer 121. The sheath 112 includes a second thermoplastic polymer 122 and one or both of fibers or particles (hereinafter, referred to as fibers/particles 123, with any mention of fibers/particles 123 referring to one or both of fibers or particles). Thus, in one or some embodiments, the fibers and the particles may comprise separate forms. In one or some embodiments, the fibers may be characterized in one of several ways, such as based on its shape. For example, fibers may comprise a strand of material with an elongated cylindrical shape having a relatively small diameter (D) (or width) and higher length (L), so the ratio L/D is high (e.g., at least 5; at least 10; at least 15; etc.). In one or some embodiments, the particles may be characterized by their shape, such as spherical, cubical, rectangular, or irregular. In one or some embodiments, only particles are included in the sheath 112. Alternatively, only fibers are included in the sheath 112. Still alternatively, both particles and fibers are included in the sheath 112. Further, in one or some embodiments, the fibers may: comprise (or consist of) natural material(s); comprise (or consist of) synthetic material(s); or comprise (or consist of) both natural and synthetic materials. Similarly, in one or some embodiments, the particles may: comprise (or consist of) natural material(s); comprise (or consist of) synthetic material(s); or comprise (or consist of) both natural and synthetic materials. In one or some embodiments, selection of the material for one or both of the fibers or particles may be based on the ultimate desired feel of the end product (e.g., whether the end product is a fabric or the end product is a wearable product, such as a shirt, a skirt, trousers, a handbag, or the like).

In one or some embodiments, the second thermoplastic polymer 122 is a matrix. The fibers/particles 123 are dispersed in the second thermoplastic polymer 122 that is a matrix. In one or some embodiments, the dispersion and/or distribution of the fibers/particles 123 in the second thermoplastic polymer 122 may be dependent on one or more aspects of the extruder/mixing process. In one or some embodiments, the fibers/particles 123 may be evenly dispersed and/or evenly distributed throughout the second thermoplastic polymer 122. Alternatively, the fibers/particles 123 may be randomly dispersed and/or randomly distributed throughout the second thermoplastic polymer 122. In one or some embodiments, the fibers/particles 123 may, at one end, be at least partly buried, contained within, or buried within the second thermoplastic polymer 122, with an opposite end of the fibers/particles 123 protruding from the second thermoplastic polymer 122. In this way, the fibers/particles 123 may form a protrusion at a surface of the formed product to be produced, and impart a comfortable tactile feeling to the formed product to be produced. Further, the portion of the fibers/particles 123 buried or within the second thermoplastic polymer 122 may contribute to moisture management properties associated with the second thermoplastic polymer 122.

In one or some embodiments, the first thermoplastic polymer 121 and the second thermoplastic polymer 122 are a main component of the core 111 and sheath 112 respectively.

In one or some embodiments, the first thermoplastic polymer 121 and the second thermoplastic polymer 122 may be a same type of thermoplastic polymer. Alternatively, the first thermoplastic polymer 121 and the second thermoplastic polymer 122 may be different types of thermoplastic polymers. Thus, in one or some embodiments, the first thermoplastic polymer 121 and the second thermoplastic polymer 122 are composed of the same polymer (such as the same type of polymer). In particular, in one or some embodiments, the first thermoplastic polymer 121 and the second thermoplastic polymer 122 may be identical in all respects. Alternatively, certain, but not all, properties of the first thermoplastic polymer 121 and the second thermoplastic polymer 122 may be identical, such as any one, any combination, or all of: same type; same grade; same structure; same hardness; same mechanical properties; same density; same rheological properties; same crystallinity; or the like.

Alternatively, the first thermoplastic polymer 121 and the second thermoplastic polymer 122 may comprise different polymers (such as different types of polymers). In particular, in one or some embodiments, the first thermoplastic polymer 121 and the second thermoplastic polymer 122 may be different in all respects. Alternatively, certain, but not all, properties of the first thermoplastic polymer 121 and the second thermoplastic polymer 122 may be different, such as any one, any combination, or all of: different type; different grade; different structure; different hardness; different mechanical properties; different density; different rheological properties; different crystallinity; or the like.

In one or some embodiments, each thermoplastic polymer of the first thermoplastic polymer 121 and the second thermoplastic polymer 122 may be one thermoplastic polymer. Alternatively, one or both of the first thermoplastic polymer 121 and the second thermoplastic polymer 122 may be a mixture of two or more thermoplastic polymers.

In one or some embodiments, one, some, or each thermoplastic polymer may include, for example, one or both of a rigid component and a flexible component. Thus, in one embodiment, each of the first thermoplastic polymer 121 and the second thermoplastic polymer 122 include a flexible component. Alternatively, in one or some embodiments, the thermoplastic polymer may include a more rigid component and a less rigid component (alternatively termed, a less flexible component and a more flexible component).

In one or some embodiments, the more rigid component (e.g., the rigid component) may include, for example, a thermoplastic resin. Various thermoplastic resins are contemplated. For example, a thermoplastic resin may include any one, any combination, or all of: acrylonitrile butadiene styrene (ABS); polylactic acid (PLA); polyethylene terephthalate (PET) and other derivatives of polyesters; polycarbonate (PC); polyvinyl alcohol (PVA); polyamide (PA); styrene-based polymers; polyvinyl chloride (PVC); acrylic polymers; and polyolefins such as polyethylene, polypropylene, their copolymers and combinations thereof. Other thermoplastic resins are contemplated.

In one or some embodiments, the less rigid component (e.g., the flexible component) includes, for example, a thermoplastic elastomer. In one or some embodiments, the thermoplastic elastomer (e.g., a thermoplastic rubber) may comprise a class of copolymers or a physical mix of polymers (e.g., at least one plastic and at least one rubber and/or elastomer) that are composed of materials with both thermoplastic and elastomeric properties.

As one or both of the core 111 or the sheath 112 may include a thermoplastic elastomer, the flexibility and the elasticity of the core 111 or sheath 112 may be improved respectively, and, in turn, the flexibility and the elasticity of the forming material 1 may be improved. In addition, the flexibility and the elasticity of the core or the sheath provided in the formed product to be produced may be improved respectively, and, in turn, the flexibility and the elasticity of the formed product to be produced may be improved.

In one or some embodiments, the thermoplastic elastomer may include any one, any combination, or all of: olefin-based thermoplastic elastomer (TPO) (e.g., Thermoplastic polyolefinelastomers); styrene-based thermoplastic elastomer (TPS) (e.g., Styrenic block copolymers); vinyl chloride-based thermoplastic elastomer (TPVC) (e.g., Thermoplastic vulcanizates); amide-based thermoplastic elastomer (TPAE) (e.g., Thermoplastic polyamides); ester-based thermoplastic elastomer (TPEE) (e.g., Thermoplastic copolyester); urethane-based thermoplastic elastomer ((TPU) (e.g., Thermoplastic polyurethanes); Unclassified thermoplastic elastomers (TPZ); and acrylic elastomer, and may include TPU.

In one or some embodiments, the fibers/particles 123 may include one or both of natural materials and synthetic materials (e.g., compounds). Synthetic materials (such as synthetic fibers) may be made by humans through chemical synthesis, as opposed to natural materials (such as natural fibers, natural powders, mineral powders, or the like) that may be directly derived from living organisms (such as plants (e.g., wool or cotton)). Various natural materials are contemplated, Examples of natural powders and fibers include ramie, cotton, wool, silk, chitosan, etc. Examples of mineral powders include chalk and calcium carbonate. Other examples are contemplated.

At least one of the core 111 and the sheath 112 may include a reinforcing component. When the core 111 or the sheath 112 includes a reinforcing component, one or more properties, such as strength, of the core 111 or the sheath 112 may be improved, thus affecting the forming material (e.g., improving the strength of the forming material 1). Thus, in one or some embodiments, the reinforcing component may affect one or more properties, such as any one, any combination, or all of: strength; hardness; stiffness; density; UV-resistance; optical properties; or chemical resistance. In one particular example, the strength of the core or the sheath provided in the formed product to be produced may be improved, and, in turn, the strength of the formed product to be produced may be improved. Various reinforcing components are contemplated. For example, the reinforcing component may include filler. In one or some embodiments, the filler includes any one, any combination, or all of: fibers; particles; particulate powders; nanoparticles; nanofibers; and similar additives. Moreover, the filler may include, for example, one or both of natural materials and synthetic materials.

Further, in one or some embodiments, one or both of the core 111 and the sheath 112 may include liquid additives in addition to a plasticizer. Additionally, or alternatively, one or both of the cores 111 and the sheath 112 may include additives for forming pores. When the core 111 or the sheath 112 includes additives for forming pores, many pores may be formed respectively in the core or the sheath provided in the formed product to be produced, thereby improving one or more a flexibility, an elasticity and an air permeability of the core and/or the sheath provided in the formed product to be produced, and improving one or more of flexibility, elasticity, and air permeability of the formed product to be produced. In one or some embodiments, additives for forming pores may include, for example, one or both of a foaming agent or a whipping agent. A filament of a foamed core/sheath structure in which either the core or the sheath is foamed and other layers are not foamed may impart higher strength than a filament of a fully foamed structure due to high consistency with a strength of unfoamed layers.

In one or some embodiments, the core 111 may include any one, any combination, or all of particles, additives, mixtures, or the like that do not fall under the above-described components. In one or some embodiments, any one, any combination, or all of particles, additives, mixtures, or the like may be dispersed in the first thermoplastic polymer 121, which may comprise a matrix. Alternatively, or in addition, the sheath 112 may include any one, any combination, or all of particles, additives, mixtures, or the like that do not fall under the above-described components. Further, in one or some embodiments, any one, any combination, or all of particles, additives, or mixtures may be dispersed in the second thermoplastic polymer 122, which may comprise a matrix (e.g., the main polymeric component in the material that may comprise the base material in which other ingredients are mixed). In this regard, one or both of the first thermoplastic polymer 121 or the second thermoplastic polymer 122 may have dispersed therein any one, any combination, or all of particles, additives, or mixtures.

In a first example, the first thermoplastic polymer 121 is a TPU having a hardness of 70 Shore A. The second thermoplastic polymer 122 is also a TPU having a hardness of 60 Shore A. In this first example, the first thermoplastic polymer 121 has a greater hardness (e.g., a greater resistance to indentation) than the second thermoplastic polymer 122. In this regard, the first thermoplastic polymer 121 and the second thermoplastic polymer 122 may both be of the same type (e.g., TPU). In one embodiment, other aspects of the first thermoplastic polymer 121 and the second thermoplastic polymer 122 may be the same (such as the same Shore A) or may be different (such as different Shore A values).

In a second example, the first thermoplastic polymer 121 is a TPU. In addition, the second thermoplastic polymer 122 is PVA. In addition, the fibers/particles 123 are natural fibers. In this regard, the first thermoplastic polymer 121 and the second thermoplastic polymer 122 may be of different types (e.g., TPU vs. PVA).

In a third example, the first thermoplastic polymer 121 is a TPU. In addition, the second thermoplastic polymer 122 is a mixture of TPU and PVA. In addition, the sheath 112 includes a whipping (foaming) agent. In this regard, the first thermoplastic polymer 121 and the second thermoplastic polymer 122 may have at least one common material (e.g., TPU). In one or some embodiments, one or both of the first thermoplastic polymer 121 and the second thermoplastic polymer 122 may have an additional material that is not present in the other of the first thermoplastic polymer 121 and the second thermoplastic polymer 122 (e.g., PVA present in the second thermoplastic polymer 122 but not in the first thermoplastic polymer 121).

In a fourth example, the second thermoplastic polymer 122 is a TPU. In addition, the fibers/particles 123 are natural fibers.

In a fifth example, the first thermoplastic polymer 121 and the second thermoplastic polymer 122 are both TPU. In addition, the fibers/particles 123 are ramie fibers.

Various outer diameters of the sheath 112 and of the core 111 (and corresponding ratios) are contemplated. The ratio between an outer diameter of the sheath 112 and a diameter of the core 111 may reflect a composition or a mass fraction of materials composing the core 111 and materials composing the sheath 112, and may be controlled within a wide range from 1:1.01 to 1:10 (e.g., greater than 1:1 (such as 1:1.01); greater than 1:2 (such as 1:2.01); greater than 1:3 (such as 1:3.01); greater than 1:4 (such as 1:4.01); greater than 1:5 (such as 1:5.01); greater than 1:10 (such as 1:10.01); etc.).

### 3. Method for Manufacturing Forming Material

The forming material 1 may be manufactured in one of several ways. In one way, the forming material 1 may be manufactured by co-extruding materials composing the core 111 and materials composing the sheath 112 using an appropriate feed-block and a nozzle. In one or some embodiments, the same manufacturing method may be applied, such as the same manufacturing method may apply when the forming material 1 comprises layers other than the core 111 and the sheath 112. Alternatively, different manufacturing methods may be used.

For example, when the forming material 1 is manufactured, materials composing the core 111 and materials composing the sheath 112 may be co-extruded in a co-extrusion line. In one or some embodiments, the co-extrusion line may comprise two extruders, a feed-block/multi-manifold die head and a nozzle. The two extruders may form two feeds respectively comprising (or consisting of) a feed comprising (or consisting of) materials composing the core 111 and a feed comprising (or consisting of) materials composing the sheath 112. The feed-block/multi-manifold die head may converge the two feeds formed. The nozzle may co-extrude the forming material 1 by using a converged feed.

### 4. Variants

FIG. 4 is a cross-sectional view schematically illustrating a forming material of a variant of a first embodiment.

In the forming material 1 of the first embodiment shown in FIGS. 1, 2 and 3, the core 111 is a solid body. Alternatively, the core may be a non-solid body. For example, in a forming material 1M of a variant of a first embodiment shown in FIG. 4, the core 111 is a porous body. Therefore, in the forming material 1M, many pores are formed in the core 111. This may improve any one, any combination, or all of the flexibility, the elasticity and the air permeability of the core 111, and, in turn, improve any one, any combination, or all of the flexibility, the elasticity and the air permeability of the forming material 1M. In addition, any one, any combination, or all of the flexibility, the elasticity and the air permeability of the core provided in the formed product to be produced may be improved, and any one, any combination, or all of the flexibility, the elasticity and the air permeability of the formed product to be produced may be improved. In one or some embodiments, the core 111, which may be a porous body, may resemble a multifilament.

### Second Embodiment

### 1. Outline of Formed Product

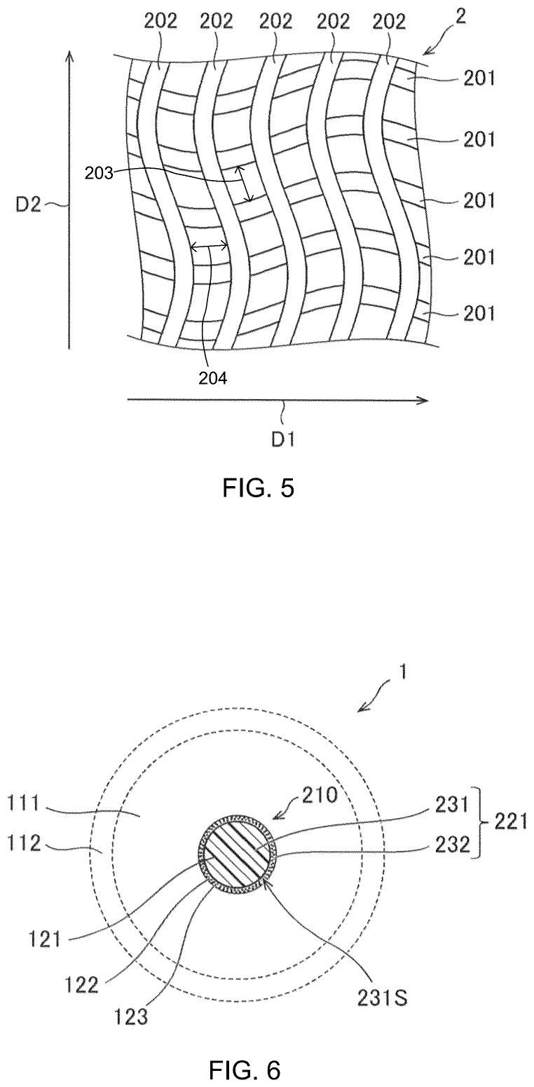

FIG. 5 is a plan view schematically illustrating a formed product of a second embodiment. A formed product 2 of the second embodiment shown in FIG. 5 may be manufactured by using the forming material 1 of the first embodiment. For this reason, the formed product 2 may be a melted and/or cured product of the forming material 1. Alternatively, the formed product may be manufactured by using any other forming material disclosed herein. As shown, formed product 2 may be composed of multiple layers (such as at least two layers, at least three layers, at least four layers, at least five layers, at least six layers, at least seven layers, at least eight layers, at least nine layers, or at least ten layers).

In one or some embodiments, the formed product 2 may be a new type of textile (e.g., cloth) or fabric (e.g., cloth product). The formed product 2 may compose, for example, a clothing that may be worn on a body continuously. Various clothing are contemplated, such as garments, hats, gloves, socks, footwears, accessories, etc. Alternatively, the formed product 2 may compose an article other than the clothing.

The formed product, whether clothing or an article other than clothing, may be a self-made product made by a consumer, an order-made product for a specific consumer, or ready-made products made for unspecified consumers. However, the manufacture of the formed product 2 by a 3D printer may be suitable for the self-made product and/or the order-made product.

The formed product 2 may be sold to ordinary consumers in ordinary stores and in ordinary markets.

In one or some embodiments, a main part of the formed product 2 has a thermoplastic property. Thereby, the formed product 2 may be melted to separate the formed product 2 into a plurality of components. In addition, a newly formed product or other types of products may be manufactured from the formed product 2. For this reason, the formed product 2 may be recyclable after being used.

The properties of the formed product 2 may be adjusted by any one, any combination, or all of: materials composing the forming material 1 used for manufacturing; a structure of the forming material 1 used for manufacturing; process parameters for manufacturing the formed product 2; and the like. Various structures of the formed product are contemplated to meet specific design and functional requirements, including any one, any combination, or all of: solid; hollow; honeycomb infill; gyroid infill; grid infill; triangular infill; sparse infill; concentric infill; rectilinear infill; support structures; or textured surfaces. Further, separate from, but in combination with, the various structures, various process parameters are contemplated may be adjusted or selected to control the quality and/or characteristics of the printed objects, such as any one, any combination, or all of: layer height (e.g., such as no less than 0.05 mm and/or no greater than 0.8 mm; at least 0.1 mm and/or 0.6 mm; such 0.15 mm-0.25 mm; or 0.2 mm); number of layers (e.g., at least 2 layers; at least 5 layers; etc.); print speed (e.g., such as no less than 4 mm/s and/or no greater than 120 mm/s; at least 150 mm/s; at least 160 mm/s; at least 200 mm/s; at least 300 mm/s); nozzle temperature (e.g., such as no less than 190° C. and/or no greater than 260° C., depending on the filament material); bed temperature (e.g., such as no less than 25° C. and/or no greater than 100° C.); infill density (e.g., such as no less than 5% and/or no greater than 100%); and wall thickness (e.g., such as no less than 0.4 and/or no greater than 1.2 mm). It is contemplated that adjustments may be made to improve the any one, any combination, or all of flexibility, the softness, the strength and the air permeability of the formed product 2, in addition to the ease of manufacturing of the formed product 2.

### 2. Planar Shape of Formed Product

As shown in FIG. 5, in one or some embodiments, the formed product 2 comprises first linear bodies 201 and second linear bodies 202.

Each of first linear bodies 201 extends to a first direction D1 while meandering. The first linear bodies 201 are arranged in a second direction D2. FIG. 5 illustrates one example lattice structure. Merely by way of example, other lattice structures are contemplated, including zig-zag, inverted zig-zag, wave-like infill, linen, or wide waves (with vertical line or horizontal line in the middle). There is a gap 203 between the adjacent first linear bodies 201. Each of second linear bodies 202 extends to the second direction D2 while meandering. The second linear bodies 202 are arranged in the first direction D1. There is a gap 204 between the adjacent second linear bodies 202. In one or some embodiments, the gap 203 between the adjacent first linear bodies 201 is the same as the gap 204 between the adjacent second linear bodies 202. Alternatively, the gap 203 between the adjacent first linear bodies 201 may be different from the gap 204 between the adjacent second linear bodies 202. In this regard, the formed product 2 may have its characteristics, such as its thickness and/or cross-section, varied depending on various aspects of the 3D printer, such as the printed nozzle of the 3D printer. Thus, the formed product 2 may be changed, reflecting a freedom of design.

In one or some embodiments, the second direction D2 is perpendicular to the first direction D1. Alternate directions to perpendicular are contemplated, including parallel or at a predetermined angle other than 90°. Thereby, in planar view, the first linear bodies 201 intersect with the second linear bodies 202. Further, the formed product 2 has a lattice-like planar shape. Alternatively, the formed product 2 may have a structure different from the structure shown in FIG. 5.

In one or some embodiments, the second linear bodies 202 may be arranged on the first linear bodies 201 in one of several ways. In one way, the 3D printer may build object layer-by-layer by extruding filament through a heated nozzle, depositing and solidifying material one thin horizontal cross-section at a time, thereby building the formed product 2 illustrated in FIG. 5. Alternatively, instead of 3D printing, different filaments may be placed on top of one another or woven together, and thereafter heated to bind the various filaments together. In either instance, the second linear bodies 202 and the first linear bodies 201 are bound to one another.

### 3. Cross-Sectional Structure and Material Property of Linear Bodies

FIG. 6 is a cross-sectional view schematically illustrating one example of a linear body provided in a formed product of the second embodiment. In FIG. 6, the forming material is illustrated with a dashed line, so that a size of the forming material of the first embodiment may be compared with a size of the linear body provided in the formed product of the second embodiment. In this regard, various sizes of forming materials are contemplated.

In one or some embodiments, the linear body 210 shown in FIG. 6 may be each one of the first linear bodies 201 and each one of the second linear bodies 202 (illustrated in FIG. 5). Thus, in one or some embodiments, any discussion regarding linear body 210 may comprise the first linear bodies 201 and each one of the second linear bodies 202.

In one or some embodiments, the linear body 210 may be composed of a core (without a sheath). Alternatively, the linear body 210 may be composed of a sheath. In this regard, the linear body 210 may be formed by extending the forming material 1 in a length direction. This is illustrated in FIG. 6 in which the linear body 210 is composed of a core/sheath structure 221 comprising a core 231 and a sheath 232. In one or some embodiments, the diameter of the linear body 210 is smaller than the diameter of the forming material 1. Alternatively, or in addition, the diameter of the core 231 may be smaller than the diameter of the core 111. Still alternatively, or in addition, the thickness of the sheath 232 is thinner than the thickness of the sheath 112.

In one or some embodiments, the core 231 and the sheath 232 provided in the linear body 210 are respectively derived from the core 111 and the sheath 112 provided in the forming material 1. For this reason, the core 231 may have a linear shape. The sheath 232 may cover at least a part of an outer peripheral surface 231S of the core 231 (such as entirely cover the outer peripheral surface 231S of the core 231). Alternatively, the sheath 232 may cover at least some (but not all) of the entirety of the outer peripheral surface 231S (e.g., the sheath 232 may cover at least or more than 50% of the entirety of the outer peripheral surface 231S; the sheath 232 may cover at least 60% of the entirety of the outer peripheral surface 231S; the sheath 232 may cover at least 70% of the entirety of the outer peripheral surface 231S; the sheath 232 may cover at least 75% of the entirety of the outer peripheral surface 231S; the sheath 232 may cover at least 80% of the entirety of the outer peripheral surface 231S; the sheath 232 may cover at least 85% of the entirety of the outer peripheral surface 231S; the sheath 232 may cover at least 90% of the entirety of the outer peripheral surface 231S; the sheath 232 may cover at least 95% of the entirety of the outer peripheral surface 231S; the sheath 232 may cover at least 96% of the entirety of the outer peripheral surface 231S; the sheath 232 may cover at least 97% of the entirety of the outer peripheral surface 231S; the sheath 232 may cover at least 98% of the entirety of the outer peripheral surface 231S; the sheath 232 may cover at least 99% of the entirety of the outer peripheral surface 231S).

In one or some embodiments, the core 231 includes a first thermoplastic polymer 121. In one or some embodiments, the sheath 232 includes a second thermoplastic polymer 122 and fibers/particles 123. As discussed above, in one or some embodiments, the first thermoplastic polymer 121 may be the same as the second thermoplastic polymer 122. Alternatively, the first thermoplastic polymer 121 may be at least partly different from the second thermoplastic polymer 122. In one or some embodiments, the fibers/particles 123 may be dispersed in the second thermoplastic polymer 122. As one example, the fibers/particles 123 may be dispersed within the second thermoplastic polymer 122 by mixing the fibers/particles 123 with the second thermoplastic polymer 122 using a twin-screw compounding or similar melt mixing process). In one or some embodiments, the core 231 and the sheath 232 provided in the linear body 210 may respectively include components that may be included in the core 111 and the sheath 112 provided in the forming material 1. The core 231 may be a porous body.

Further, in one or some embodiments, the sheath 112 entirely covers core 111 (such as illustrated in FIG. 6. Alternatively, the sheath 112 may cover at least some (but not all) of the entirety of the outer peripheral surface of core 111 (such as at least 50%, 60%, 70%, 75%, 80%, 85%, 90%, 95%, 96%, 97%, 98%, or 99% of the outer peripheral surface of core 111).

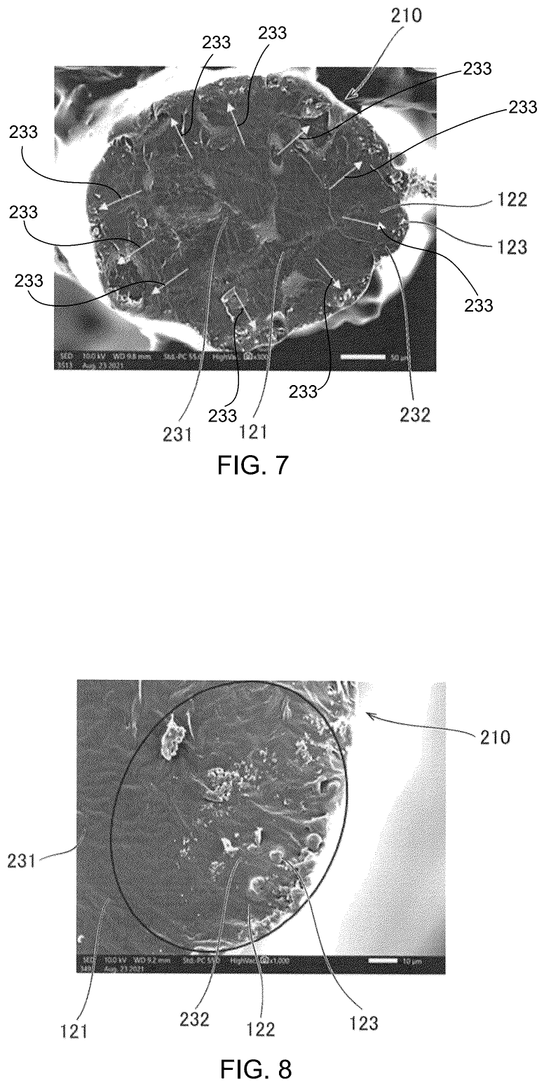

FIG. 7 is an electron microscope (SEM) micrograph of an entire cross section of a linear body provided in a prototype of a formed product of the second embodiment. FIG. 8 is a SEM micrograph of a periphery of a cross section of a linear body provided in a prototype of a formed product of the second embodiment.

In the SEM micrograph of FIG. 7, a clear interface between the core 231 and the sheath 232 cannot be confirmed, but the fibers/particles 123 may be hardly confirmed in an area of the core 231, and dispersed fibers/particles 123 may be confirmed in an area of the sheath 232 ahead of arrows 233. Further, also in the SEM micrograph of FIG. 8, a clear interface between the core 231 and the sheath 232 cannot be confirmed, but the fibers/particles 123 may be hardly confirmed in an area of the core 231, and dispersed fibers/particles 123 may be confirmed in an area of the sheath 232 inside a circle. Therefore, from the SEM micrographs of FIGS. 7 and 8, it may be understood that the sheath 232 includes the fibers/particles 123 and the fibers/particles 123 are dispersed in the second thermoplastic polymer 122. The reason for not being able to confirm a clear interface between the core 231 and the sheath 232 is that the second thermoplastic polymer 122, which is a main component of the sheath 232, is, in one embodiment, similar to the first thermoplastic polymer 121, which may be a main component of the core 231, and may be same as the first thermoplastic polymer 121.

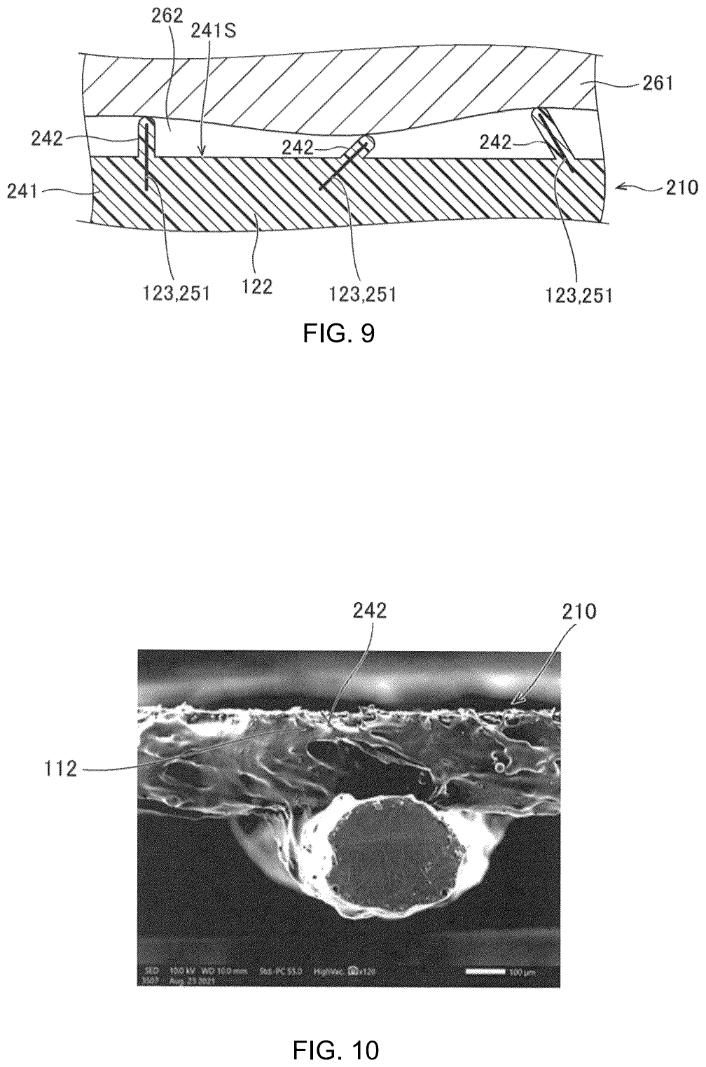

FIG. 9 is an enlarged cross-sectional view schematically illustrating the vicinity of an interface between a formed product of the second embodiment and a human skin contacting the formed product. As illustrated in FIG. 9, the linear body 210 includes a linear main body 241 and protrusions 242.

The linear main body 241 composes a main part of the linear body 210. The protrusions 242 protrude from an outer peripheral surface 241S of the linear main body 241 to form a characteristic irregular unevenness at the outer peripheral surface of the linear body 210. In one or some embodiments, in the filament form, particles are typically evenly dispersed within the matrix (e.g., the polymer); however, dispersion may depend on any one, any combination, or all of the following aspects: particles type (e.g., chemical structure); particles length; level of dispersion; intensity of mixing; compatibility between particles and polymer; etc. Nevertheless, with appropriate control of one or more of the listed aspects, the dispersion of the particles within the matrix may be predetermined to a sufficient degree.

In one or some embodiments, the fibers/particles 123 include crossing fibers/crossing particles 251 that intersect with the outer peripheral surface 241S of the linear main body 241. One end of the crossing fibers/crossing particles 251 is buried in the second thermoplastic polymer 122 composing the linear main body 241. Thereby, the crossing fibers/crossing particles 251 are fixed to the linear main body 241, and the crossing fibers/crossing particles 251 may be prevented from falling off from the linear main body 241. A rest or a remainder of the crossing fibers/crossing particles 251 protrudes from the outer peripheral surface 241S of the linear main body 241 and is covered with the second thermoplastic polymer 122 composing the protrusion 242. Thereby, the crossing fibers/crossing particles 251 may be prevented from being exposed, and it is possible to prevent the human skin 261 from directly contacting the crossing fibers/crossing particles 251. The protrusion 242 comprises the second thermoplastic polymer 122 covering the rest of the crossing fibers/crossing particles 251 and the rest of the crossing fibers/crossing particles 251. The second thermoplastic polymer 122 composing the linear main body 241 and the second thermoplastic polymer 122 composing the protrusion 242 are continuous and integrated. Alternatively, in one or some embodiments, the crossing fibers/crossing particles 251 may be in a sheath layer (e.g., external to the outer surface of the core) and not coated in by second thermoplastic polymer 122 due to the crossing fibers/crossing particles 251 protruding from the core (e.g., the crossing fibers/crossing particles 251 are originally added to the core, and through processing, such as via an applied force, such as electrostatic charge, discussed further below).

The irregular unevenness formed is similar to the unevenness formed when the filling factor of fibers/particles dispersed in a matrix increases. The unevenness may be described as “mountains and valleys,” or a “peaks and valleys.” In the linear body 210, the protrusion 242 may become a mountain (e.g., peak), and between adjacent protrusions 242, that is, an area which is rich in the second thermoplastic polymer 122 may be considered a valley.

A size of the irregular unevenness formed may be controlled by a shape, a size, and the like of the fibers/particles 123. For this reason, a roughness of a surface of the formed product 2 may be controlled by a shape, a size, and the like of the fibers/particles 123. For example, in one or some embodiments, one or more processing parameters and/or setup of the 3D printer may likewise affect roughness (e.g., peaks and valleys).

When the human skin 261 contacts the formed product 2, the human skin 261 contacts the protrusion 242, and a gap 262 is formed between the human skin 261 and the outer peripheral surface 241S of the linear main body 241. An air flow may be generated in the gap 262 formed. For this reason, when the human skin 261 contacts the formed product 2, the air flow generated in the gap 262 may quickly dry the human skin 261, and the human skin 261 may be cooled well. For this reason, the formed product 2 may not have a rubbery or a plastic-like tactile feeling, or the like, and may have a cloth-like tactile feeling and a comfortable tactile feeling.

In addition, when the human skin 261 contacts the formed product 2, the human skin 261 may deflect the protrusion 242 with weak force. In addition, the human skin 261 may only contact a surface of the formed product 2 weakly, and a frictional force generated between the human skin 261 and the formed product 2 may be small. Thereby, the formed product 2 may have a soft tactile feeling.

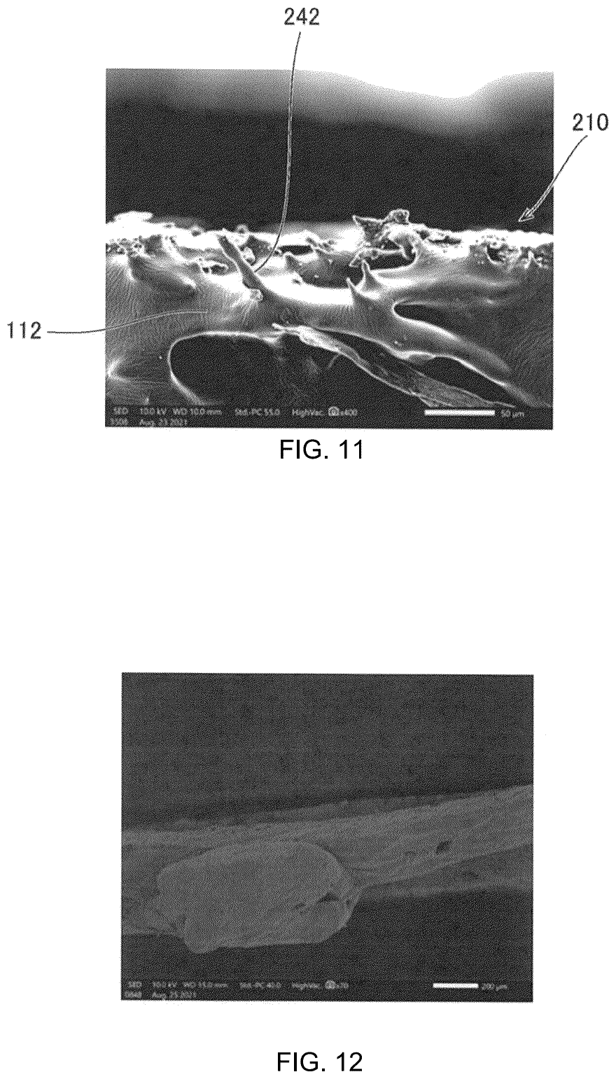

FIGS. 10 and 11 are SEM micrographs of a cross section of a prototype of a formed product of a second embodiment. In the SEM micrographs of FIGS. 10 and 11, it is shown that the protrusion 242 protrudes from the sheath 112 and forms an irregular unevenness on the outer periphery surface of the linear body 210.

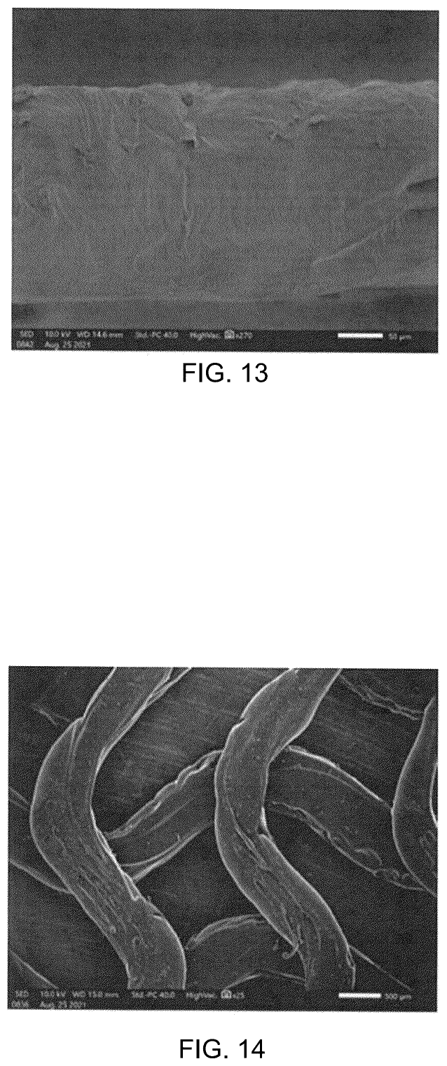

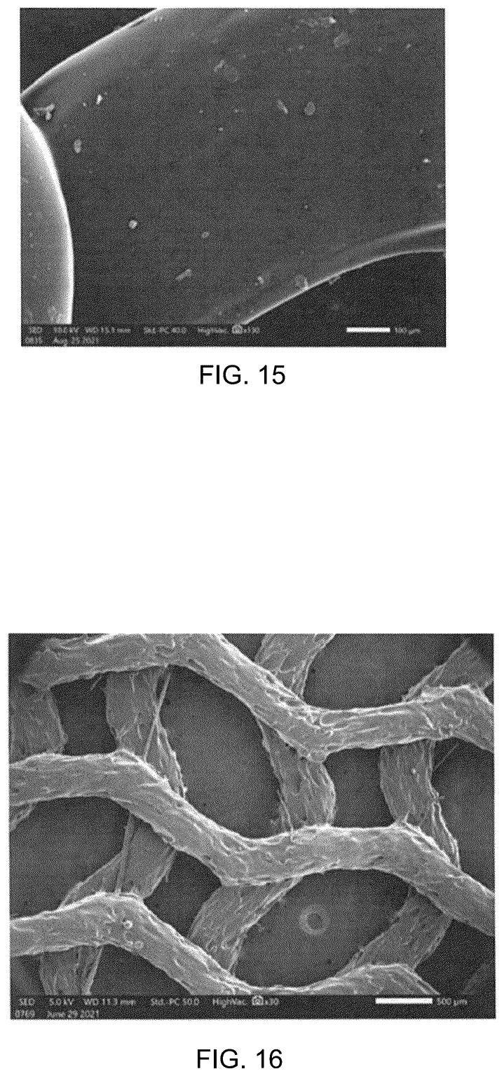

FIGS. 12 and 13 are SEM micrographs of a cross-section of a prototype of a formed product manufactured by using a monofilament. FIGS. 14 and 15 are SEM micrographs on an upper surface of a prototype of a formed product manufactured by using a monofilament.

In the SEM micrographs of FIGS. 12, 13, 14, and 15, it is shown that a surface of the linear body provided in a prototype of a formed product manufactured by using a monofilament is smooth and clean and does not have a distinguished unevenness. In the SEM micrographs of FIGS. 14 and 15, white spots may be considered debris or contaminants.

The formed product 2 having the above-described features may have any one, any combination, or all of flexibility, strength, air permeability, wicking, controlled roughness and smoothness, and may have a cloth-like tactile feeling and a comfortable tactile feeling. In addition, a color of the formed product 2 may be changed.

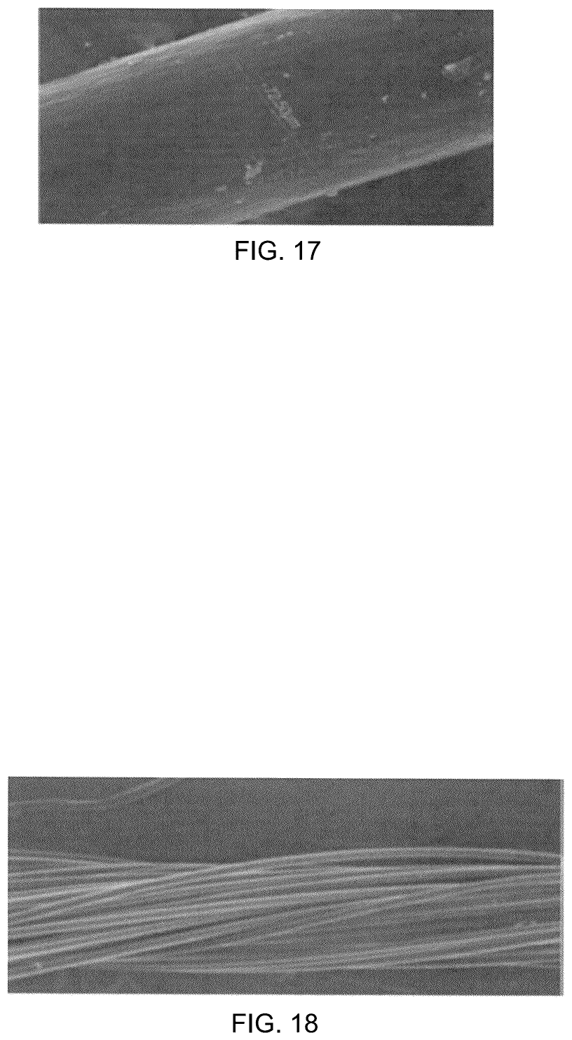

FIG. 16 is an SEM micrograph of a prototype of a formed product manufactured by using a forming material of a variant of a first embodiment. FIG. 17 is a micrograph of a monofilament made of polyester. FIG. 18 is a micrograph of a multifilament made of polyester.

The monofilament made of polyester shown in FIG. 17 is strong, hard, and stiff. For this reason, the monofilament made of polyester may not be considered usable for clothing. Also, when the monofilament is used, an irregular unevenness cannot be formed on a surface of a formed product.

On the other hand, the multifilament made of polyester shown in FIG. 18 is softer and less stiff than the monofilament. For this reason, a multifilament made of polyester may be considered suitable for using in clothing. Also, when the multifilament is used, an irregular unevenness may be formed on a surface of a formed product. However, when the monofilament made of polyester is used, the formed product cannot be printed by a 3D printer.

In the SEM micrograph of FIG. 16, it may be confirmed that an irregular unevenness is formed on a surface of a formed product manufactured by a 3D printer using a forming material 1M in which the core 111 is a porous body.

### 4. Method for Manufacturing Formed Products

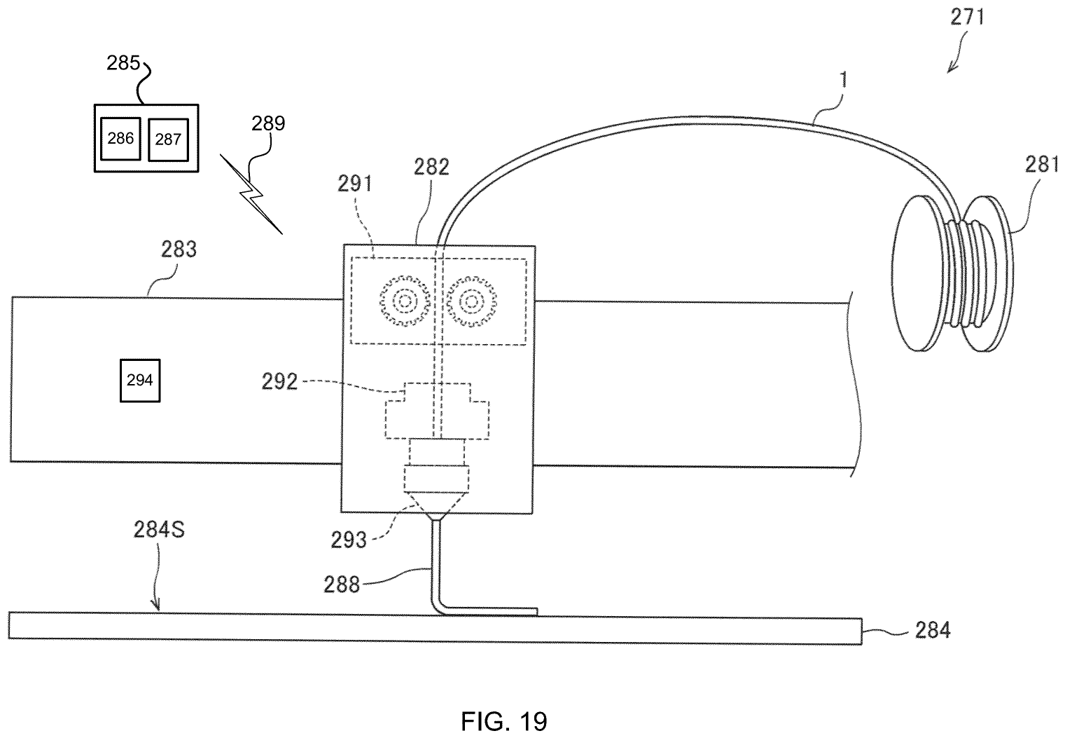

FIG. 19 is a side view schematically illustrating a 3D printer 271 used for manufacturing a formed product of a second embodiment. The 3D printer 271 shown in FIG. 19 prints the formed product 2 by using the forming material 1 by one or more methods, such as by the FFF method. In the following, the forming material 1 may comprise a filament. In this regard, any discussion regarding a filament below may generally be ascribed to any forming material 1.

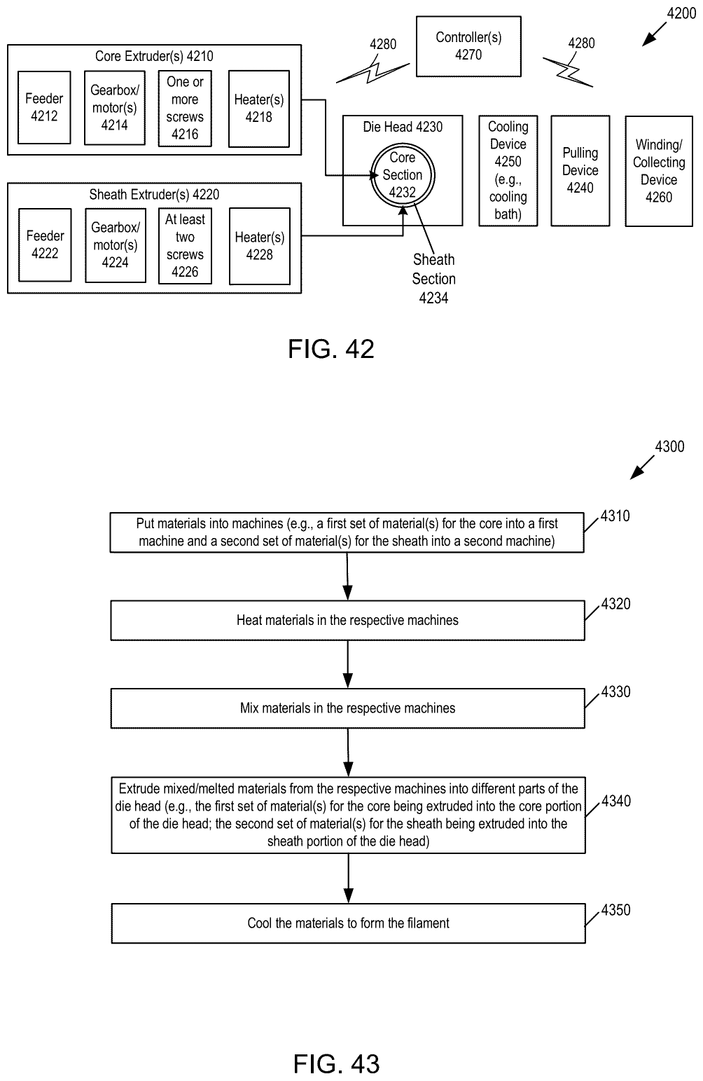

A filament spool 281 is mounted to the 3D printer 271. The 3D printer 271 comprises a printing head 282, a drive mechanism 283, and a plate 284. The 3D printer 271 may further include control electronics 285, which may communicate with any one, any combination, or all of the printing head 282, the drive mechanism 283, and the plate 284 wired and/or wirelessly (see 289). FIG. 42 further discusses an example of control electronics 285.

The control electronics 285 may be configured to control the various parts of the 3D printer 271 in order to perform the 3D printing as discussed herein. The control electronics 285 may include at least one processor 286 (such as CPU 4202 in FIG. 42) and at least one memory 287 (such as one or both of RAM 4206 or ROM 4208). In one or some embodiments, the processor 286 may comprise a microprocessor, controller, PLA, or the like. Similarly, the memory 287 may comprise any type of storage device (e.g., any type of memory). The memory 287 may be a tangible, non-transient, computer readable storage medium that stores software that may comprise instructions. The instructions may be executed by the processor 286 (functioning as part of a computer, see FIG. 42) in order to perform the 3D printing as discussed herein.

Though the processor 286 and the memory 287 are depicted as separate elements, they may be part of a single machine, which includes a microprocessor (or other type of controller) and a memory. Alternatively, the processor 286 may rely on the memory 287 for all of its memory needs.

The processor 286 and the memory 287 are merely one example of the control electronics 285. Other types of control electronics are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The filament spool 281 supplies the filament. In one or some embodiments, the print head 282, under control of the control electronics 285, may melt the filament supplied to generate a molten material and may discharge the molten material 288 generated. The print head 282 may be disposed above an upper surface 284S of the plate 284 in a vertical direction. For this reason, the molten material 288 discharged may be dropped and supplied on the upper surface 284S of the plate 284. The molten material 288 may be supplied directly on the upper surface 284S of the plate 284, or may be supplied on the upper surface 284S of the plate 284 by overlapping on the molten material or the hardened molten material already supplied on the upper surface 284S of the plate 284.

In one or some embodiments, the drive mechanism 283 may comprise one or more motors and, under control of the control electronics 285, may move the print head 282 in a direction parallel to the upper surface 284S of the plate 284 (e.g., the control electronics 285 may send one or more commands to the motor(s) 294 of the drive mechanism 283 in order to move the print head 282). Thereby, a position for supplying the molten material 288 may be moved. The drive mechanism 283 enables a position for supplying the molten material 288 to be arranged at any position within a printing range.

The plate 284 may support the molten material 288 supplied. The molten material 288 supported may be hardened into a melted and cured product. Thus, the plate 284 supports the melted and cured material.

Under control of the control electronics 285, when the 3D printer 271 prints the formed product 2, while the print head 282 discharges the molten material 288, the drive mechanism 283 may move the print head 282 above a linear area where the linear body 210 provided in the formed product 2 is printed. Thereby, a linear molten material may be formed on the linear area. The linear molten material formed may be hardened into the linear body 210.

The print head 282 may comprise a filament feeder 291, a heater 292, and a nozzle 293. Under control of the control electronics 285, the filament supplied to the print head 282 may be inserted into the filament feeder 291. The filament feeder 291 may send the inserted filament in a length direction and may insert the filament into the heater 292.

In one or some embodiments, the heater 292, under control of the control electronics 285, may heat the inserted forming material 1 (e.g., filament) to generate the molten material 288 and may supply the molten material 288 generated to the nozzle 293. The nozzle 293 may discharge the molten material 288 supplied.

When the print head 282 melts the filament to produce the molten material 288, the core/sheath structure may be maintained. For this reason, the linear body 210 may have a core/sheath structure 221. However, in one or some embodiments, since the filament is stretched, a diameter of the linear body 210 may be smaller than a diameter of the filament. Further, in one or some embodiments, a thickness of the sheath 232 may be thinner than a thickness of the sheath 112. For example, a diameter of the linear body 210 is about ¼ of a diameter of the filament. In this regard, in one or some embodiments, the diameter of the filament is: at least twice the diameter of the linear body 210; at least three-times the diameter of the linear body 210; at least four-times the diameter of the linear body 210; at least five-times the diameter of the linear body 210; at least six-times the diameter of the linear body 210; etc. Also, a thickness of the sheath 232 is about ¼ of a thickness of the sheath 112. In this regard, in one or some embodiments, the thickness of the sheath 112 is: at least twice the thickness of the sheath 232; at least three-times the thickness of the sheath 232; at least four-times the thickness of the sheath 232; at least five-times the thickness of the sheath 232; at least six-times the thickness of the sheath 232; etc. Thus, in one case, the filament with a diameter of 1.75 mm becomes the linear body 210 having a diameter of about 0.40 mm. The sheath 112 with a thickness of 0.2 mm becomes the sheath 232 having a thickness of 0.05 mm.

A size of the fibers/particles 123 included in the sheath 112 provided in the filament, for example, a length of the fibers or a size of the particles is selected to be sufficiently smaller than a thickness of the sheath 232 provided in the linear body 210 to be printed. For this reason, it may be unlikely that the fibers/particles 123 enter the core 231 when the formed product 2 is printed. For this reason, most of the fibers/particles 123 may remain in the sheath 232, and a part of the fibers/particles 123 may be crossing fibers/crossing particles 251 that intersect with the outer peripheral surface 111S of the linear main body 241.

### Third Embodiment

### 1. Overview of Flock Product

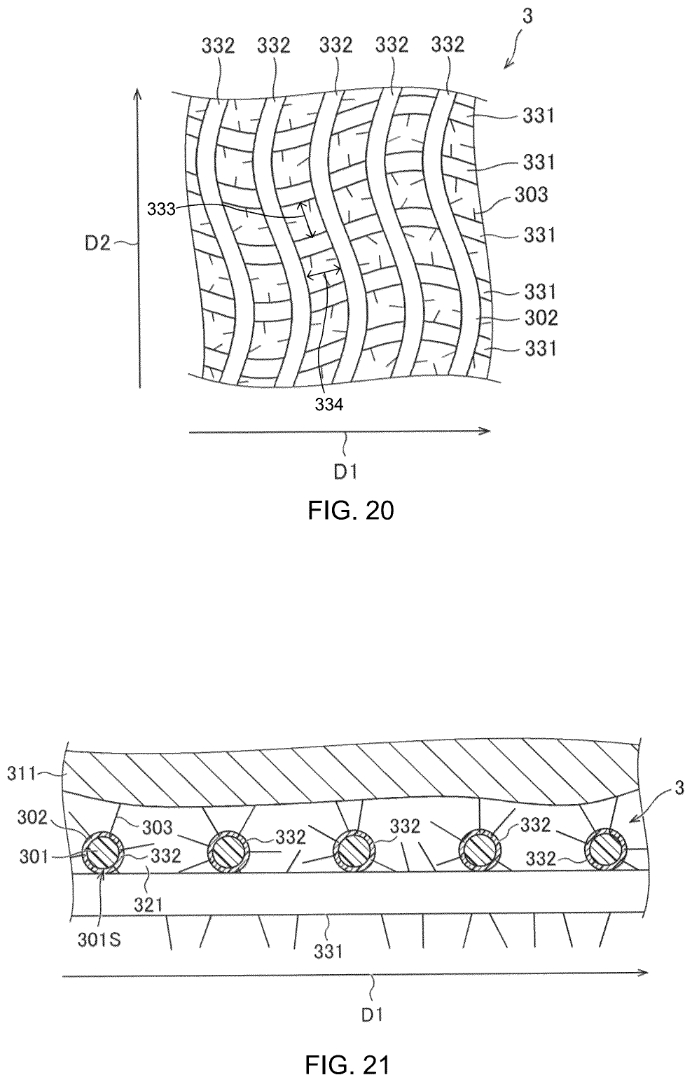

FIG. 20 is a plan view schematically illustrating a flock product of a third embodiment. FIG. 21 is an enlarged cross-sectional view schematically illustrating a vicinity of an interface between a flock product of a third embodiment and a human skin contacting the flock product.

A flock product 3 of the third embodiment shown in FIGS. 20 and 21 is a product in which a formed product manufactured by using a forming material is flocked. The flock Product 3 is a new type of textile or fabric. The flock product 3 may compose, for example, clothing that may be worn on a body continuously. Various clothing are contemplated, such as garments, hats, gloves, socks, footwears, accessories, etc. Alternatively, the flock product 3 may compose an article other than the clothing.

The formed product, whether clothing or an article other than clothing, may be a self-made product made by a consumer, an order-made product made for a specific consumer, or ready-made products made for unspecified consumers. However, the manufacture of the formed products by 3D printers and the manufacture of the flock products 3 by flocking may be suitable for the self-made product and/or the order-made product.

Properties of the flock product 3 may include a thermoplastic property.

### 2. Structure of Flock Products

As illustrated in FIGS. 20 and 21, the flock product 3 includes a main body 301, an adhesive layer 302, and a flock 303. The main body 301 may be a formed product manufactured by using a forming material, that may be a melted and cured product of the forming material. The forming material may be a forming material having a single layer structure, may be the forming material 1 of the first embodiment having a multilayer structure, or may be another forming material, but may include a thermoplastic polymer. In one or some embodiments, the main body 301 may be manufactured by a 3D printer. Alternatively, the main body 301 may be manufactured by machinery other than a 3D printer. The main body 301 may be the forming material itself.

The adhesive layer 302 may be arranged on a surface 301S of the main body 301 and may cover the surface 301S of the main body 301. The adhesive layer 302 may bond the flock 303 to the surface 301S of the main body 301 and may fix the flock 303 on the surface 301S of the main body 301. Various types of bonding are contemplated. In one or some embodiments, heat may be used for curing. Alternatively, curing/drying may be performed at room temperature. In one or some embodiments, the type and/or time for curing may depend on the type of adhesive used.

In one or some embodiments, the flock 303 may be bound to the adhesive layer 302 in one of several ways. In one or some embodiments, the flock 303 may pierce the adhesive layer 302. Alternatively, the flock 303 may bind to the adhesive layer 302 without piercing (instead only via contact).

Thus, in one or some embodiments, piercing may occur when an external force is applied. Various types of applied force are contemplated. As one example, the applied force may comprise powerful electrostatic forces generated during the process in which charged fibers experience a strong attraction towards the grounded substrate due to the opposite electrical charges. When reaching the adhesive, the fibers may embed themselves (e.g., pierce) due to the combined forces of electrostatics and the tacky adhesive. Thus, in one or some embodiments, the result may comprise a dense, velvety pile of fibers standing upright on the substrate or perpendicular to the surface. One end of the flock 303 may be buried in the adhesive layer 302. A rest of the flock 303 may be arranged or positioned outside the adhesive layer 302. For this reason, in one or some embodiments, the flock 303 may protrude from the adhesive layer 302.

As illustrated in FIG. 21, when the human skin 311 contacts the flock product 3, the human skin 311 contacts the flock 303, and a gap 321 may be formed between the human skin 311 and a surface of a structure made of the main body 301 and the adhesive layer 302. An air flow may be generated in the gap 321 formed. For this reason, when the human skin 311 contacts the flock product 3, the air flow generated in the gap 321 may quickly dry the human skin 311, and the human skin 311 may be cooled well. For this reason, the flock product 3 may not have a rubbery or a plastic-like tactile feeling, or the like, and may have a cloth-like tactile feeling and a comfortable tactile feeling.

In addition, if the human skin 311 contacts the flock product 3, the human skin 311 may deflect the flock 303 with weak force. In addition, the human skin 311 may only contact a surface of the flock product 3 weakly, and a frictional force generated between the human skin 311 and the flock product 3 may be small. Thereby, the flock product 3 may have a soft tactile feeling.

In one or some embodiments, the main body 301 includes a thermoplastic polymer. In one or some embodiments, the thermoplastic polymer may be a thermoplastic polyurethane. The characteristics of the main body 301 may be adjusted by the forming material used in manufacturing.

The adhesive layer 302 may comprise (or consists of) a cured adhesive agent. In one or some embodiments, the adhesive agent is adjusted to fit the main body 301 and the flock 303.

In one or some embodiments, the adhesive agent is a thermoplastic adhesive agent or a thermosetting adhesive agent. In this regard, in one or some embodiments, the thermosetting adhesive agent may be used alone as the adhesive agent. If the adhesive agent is the thermosetting adhesive agent, a durability of the adhesive layer 302 may be improved. On the other hand, if the adhesive agent is the thermoplastic adhesive agent, electrostatic deposition of the flock 303 may be easily performed.

In one or some embodiments, the adhesive agent is a polymer adhesive agent, such as a polyurethane adhesive agent or an acrylic adhesive agent, and more particularly only the polyurethane adhesive agent. If the adhesive agent is the polyurethane adhesive agent, polyurethane having a flexibility is included in the adhesive layer 302, and the adhesive layer 302 may be prevented from impairing a flexibility of the flock product 3. The polyurethane adhesive agent may be, for example, a water-based or a solvent-based polyurethane dispersion or a liquid polyurethane.

In one or some embodiments, the flock 303 includes one or both of fibers and particles. The flock 303 may include one or both of natural materials and synthetic materials (e.g., compounds). Natural materials may include any one, any combination, or all of cotton, wool and viscose. Alternatively, natural materials may include substances other than cotton, wool and viscose. The compounds may include any one, any combination, or all of: polyester; polyamide (e.g., nylon); polyurethane; polylactic acid (PLA); polyethylene; and polypropylene. Alternatively, the compounds may include substances other than polyester, polyamide, polyurethane, polylactic acid, polyethylene and polypropylene.

For example, flock fibers may have a length of 0.1 mm or more and 5 mm or less, such as at least 0.4 mm or more and at most 8 mm or less. If a length of the flock fibers is shorter than these ranges, the flock fibers may be embedded in a polymer, may not protrude from a surface, and may not affect a tactile feeling of the surface. Also, in the event that a protruding portion of the flock fibers protruding from the surface is too short, the fibers will be in a standing state, and may give an itchy tactile feeling. If a length of the fibers is longer than these ranges, deposition of the fibers may be insufficient in a flocking process due to a heavier fiber weight. If the flock fibers are too long, the fibers may fall down, so there is a risk of losing a fluffy tactile feeling.

The flock fibers, for example, may have a diameter of at least 1 μm to over 100 μm. In the event that the diameter of the fibers is thinner than this range, in general terms, a lot of powder dust may be generated at the manufacturing site, and there may be a risk of lung diseases when they reach into a lung. For an end user of the product, the flock fibers may be attached to the surface of a printed cloth, so that a similar problem may occur. If a diameter of the flock fibers is thicker than this range, it may be difficult to flock (e.g., embed or disperse) the fibers in a polymer as the fibers may not fit a thickness of the sheath. Also, if the diameter of the fibers is too thick, it may give a stiff tactile feeling and the softness may be lost, and the tactile feeling may be deteriorated.

In a first example, the main body 301 may be manufactured by using a monofilament made of a TPU. The adhesive agent may be a polyurethane adhesive agent. The flock 303 may be cotton fibers. As a result, the main body 300 may become soft, and a tactile feeling of a surface of the flock product 3 may become a comfortable tactile feeling, so that the flock product 3 may be formed as a comfortable clothing.

In a second example, the main body 301 may be manufactured by using a core/sheath (e.g., with the sheath including fibers and/or particles). The adhesive agent may be a polyurethane adhesive agent. In one example, the flock 303 may be cotton fibers. In one embodiment, the flock 303 may have a type of material that is the same as the fibers and/or particles in the sheath (e.g., both are cotton). Alternatively, the flock 303 may have a type of material that is different from the fibers and/or particles in the sheath (e.g., one is a natural fiber (such as the flock 303) and the other is a synthetic fiber). As a result of the combination of the flocking and the sheath, the main body 300 may be both soft, and have a multi-layer tactile feeling of a surface of the flock product 3, so that the flock product 3 may be formed as a comfortable clothing.

As illustrated in FIGS. 20 and 21, the flock product 3 includes first linear bodies 331 and second linear bodies 332. Thus, in one or some embodiments, the depiction in FIG. 20 is similar to that in FIG. 5. As such, in one or some embodiments, any discussion regarding FIG. 5 is applicable to the depiction in FIG. 20. As one example, any discussion regarding the first linear bodies 201 and the second linear bodies 202 may be applicable to first linear bodies 331 and second linear bodies 332, respectively. Each of the first linear bodies 331 may extend in a first direction D1 while meandering. The first linear bodies 331 may be arranged in a second direction D2. There may be a gap 333 between the adjacent first linear bodies 331. Each of the second linear bodies 332 extends in the second direction D2 while meandering. The second linear bodies 332 are arranged in the first direction D1. There may be a gap 334 between the adjacent second linear bodies 332. In one or some embodiments, the second direction D2 is perpendicular to the first direction D1. Alternatively, the second direction D2 is not perpendicular to the first direction D1. Thereby, in planar view, the first linear bodies 331 intersect with the second linear bodies 332. The flock product 3 also has a lattice-like planar shape.

In one or some embodiments, the second linear bodies 332 are arranged on the first linear bodies 331. More specifically, the second linear bodies 332 may contact or touch the first linear bodies 331. Similar to the discussion above, the binding of the first linear bodies 331 and the second linear bodies 332 may be performed in one of several ways, including using heat (e.g., placing melted thermoplastic material on top of previously deposited layers), building objects layer by layer, or 3D printing by weaving the first linear bodies 331 with the second linear bodies 332 in a sequential layering approach.

The flock product 3 having the above-described features may have any one, any combination, or all of softness; comfort; air permeability; a wicking-like effect; controlled roughness and smoothness; or has a cloth-like tactile feeling and a comfortable tactile feeling. That is, a flocking may turn the formed product printed by a 3D printer into textiles or fabrics that may be truly worn. In addition, a color of the flock product 3 may be changed.

### 3. Method for Manufacturing Flock Products

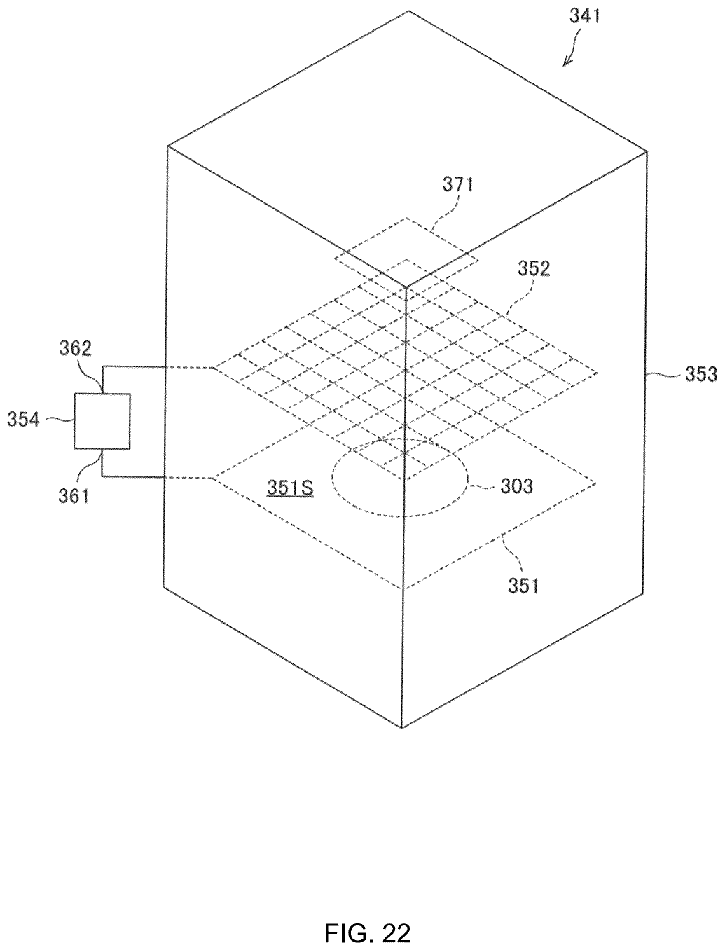

FIG. 22 is a perspective view schematically illustrating a device that may generate an applied force, such as an electrostatic deposition device used in a manufacturing of a flock product of the third embodiment. An electrostatic deposition device 341 shown in FIG. 22 may comprise an upward-type electrostatic deposition device that may draw the flock 303 in a predetermined direction, such as upwards in a vertical direction. Alternatively, the electrostatic deposition device may draw the flock 303 in various other directions, such as in a downward direction, a sideward direction, etc. In this regard, the electrostatic deposition device 341 may be an electrostatic deposition device other than the upward-type electrostatic deposition device. For example, the electrostatic deposition device 341 may be a downward-type electrostatic deposition device or the like that deposits the flock 303 downwards in a vertical direction.

As illustrated in FIG. 22, the electrostatic deposition device 341 may comprise a first electrode 351, a second electrode 352, a chamber 353, and a power supply 354. In one or some embodiments, the first electrode 351 has a flat plate shape. Further, in one or some embodiments, the first electrode 351 is installed horizontally.

In one or some embodiments, the second electrode 352 has a flat plate lattice shape. Further, in one or some embodiments, the second electrode 352 is arranged relative to the first electrode 351, such as above the first electrode 351 in a vertical direction. In one or some embodiments, the second electrode 352 is installed horizontally. For this reason, the second electrode 352 may be parallel to the first electrode 351. In one or some embodiments, the second electrode 352 is grounded. In one or some embodiments, the chamber 353 may accommodate the first electrode 351 and the second electrode 352.

In one or some embodiments, the power supply 354 generates a DC high voltage. A positive electrode 361 of the power supply 354 may be electrically connected to the first electrode 351. A negative electrode 362 of the power supply 354 may be electrically connected to and grounded to the second electrode 352. Thereby, the generated DC high voltage may be applied between the first electrode 351 and the second electrode 352. Other electrical connections between the positive electrode 361 and the negative electrode 362 are contemplated.

When the flock 303 is electrostatically deposited on the workpiece 371, the flock 303 may be placed on an upper surface 351S of the first electrode 351. Further, the workpiece 371 may be installed above the second electrode 352. Thereafter, the power supply 354 may apply a DC high voltage between the first electrode 351 and the second electrode 352. Thereby, the flock 303 may be charged, and, due to the applied voltage, the charged flock 303 may move or fly from the upper surface 351S of the first electrode 351 to the workpiece 371 via the second electrode 352. At that time, the charged flock 303 may pass through a gap formed in the second electrode 352. The flock 303 that reaches the workpiece 371 may adhere to the workpiece 371. Thereby, the flock 303 may be electrostatic deposited on the workpiece 371.

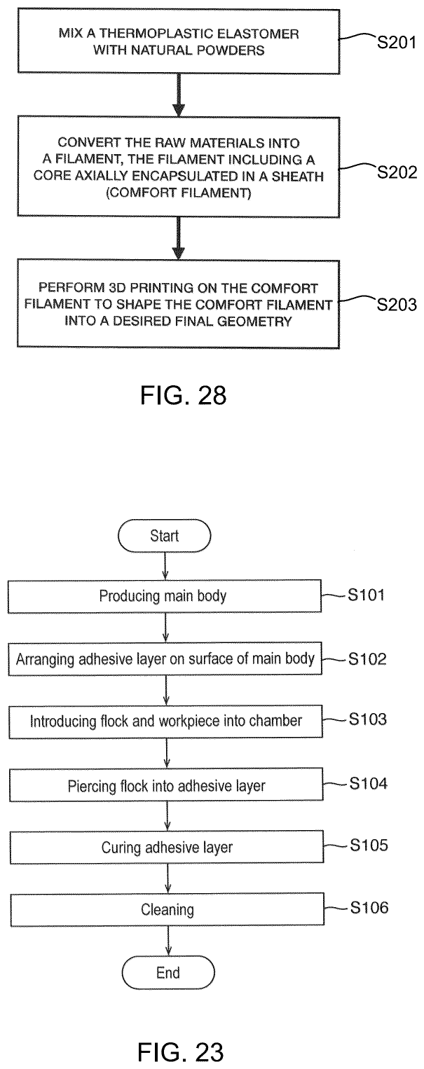

FIG. 23 is a flowchart showing a flow of manufacturing of a flock product of a third embodiment. When the flock product 3 is manufactured, any one, any combination, or all of steps S101 to S106 shown in FIG. 23 may be performed. Step S101 may comprise a primary process for printing the main body 301 by a 3D printer. Steps S102 to S105 following the step S101 may comprise secondary processes for modifying a tactile feeling and/or an appearance of a surface of the main body 301 by an electrostatic deposition, such as an electrostatic flocking, performed on a surface of the printed main body 301. In this regard, in one or some embodiments, the manufacturing of the flock product may be performed in a series of processes, including a primary process for printing the main body and a secondary process for modifying a tactile feeling and/or an appearance of a surface of the main body 301 (e.g., by electrostatic deposition).

In step S101, the main body 301 to be processed may be manufactured. In one or some embodiments, the main body 301 may be manufactured by a 3D printer and manufactured by an FFF method. Alternatively, the main body 301 may be manufactured by a forming device other than a 3D printer, or may be manufactured by a forming method other than the FFF method.

In the subsequent step S102, the adhesive layer 302 may be arranged or positioned on a surface 301S of the main body 301. Thereby, a workpiece 371 made of the main body 301 and the adhesive layer 302 may be produced. In one or some embodiments, at that time, a liquid adhesive agent may be applied to the surface 301S of the main body 301 by one or more of a spray method, a brushing method, a roller coating method, a doctor blade method, or the like. Performing the application of the liquid adhesive agent may be triggered in one of several ways. In one way, performing the application of the liquid adhesive agent may be response to determining that the adhesive layer 302 is positioned on the surface 301S of the main body 301. This determination may be based on one or more sensors, such as a camera, which may determine, from analysis by the control electronics 285 of one or more images of the adhesive layer 302 and/or the surface 301S of the main body 301 that the adhesive layer 302 is positioned on the surface 301S of the main body 301. In this regard, the control electronics 285 may be configured to perform image analysis (e.g., image segmentation and/or object recognition) of the one or more images in order to determine that the adhesive layer 302 is positioned on the surface 301S of the main body 301. Alternatively, or in addition, the control electronics 285 may command one or more motors 294 of the drive mechanism 283 to move the adhesive layer 302 and the surface 301S of the main body 301 relative to one another (e.g., to move the adhesive layer 302 to be arranged or positioned on the surface 301S of the main body 301). The control electronics 285 may wait a predetermined time (without sensing that the adhesive layer 302 is actually arranged or positioned on the surface 301S of the main body 301) to then apply the adhesive agent.

In one or some embodiments, a thin adhesive layer 302 may be applied on at least a part of the 301S of the main body 301, such as applying the thin adhesive layer 302 so that it extends through at least a part of the surface 301S of the main body 301, such as throughout the surface 301S of the main body 301. In one or some embodiments, the adhesive agent to be applied may be selected to fit or be suitable for an electrostatic deposition. The placed adhesive layer 302 may promote or assist in an adhesion between the flock 303 and the main body 301.

In the following step S103, one or both of the flock 303 and the workpiece 371 are introduced into the chamber 353. At that time, the flock 303 may be placed on an upper surface 351S of the first electrode 351. Further, the workpiece 371 may be arranged above the second electrode 352 in a vertical direction. Alternatively, the flock 303 and the workpiece 371 may be positioned relative to one another in different orientations.

In the following step S104, the flock 303 may be pierced into the adhesive layer 302. In this way, the flock 303 may penetrate the adhesive layer 302, thereby establishing a bond between the flock 303 and the adhesive layer 302. In one or some embodiments, the flock 303 is pierced into the adhesive layer 302 by an electrostatic deposition. At that time, the power supply 354 may apply a DC high voltage between the first electrode 351 and the second electrode 352. Thereby, the flock 303 may be charged, and the charged flock 303 flies or moves from the upper surface 351S of the first electrode 351 to the workpiece 371 via the second electrode 352. The flock 303 that reaches the workpiece 371 may adhere to the adhesive layer 302. Thereby, the flock 303 may be adhered to the surface 301S of the main body 301 via the adhesive layer 302, covering the surface 301S of the main body 301. This may bring a new tactile feeling. One end of the attached flock 303 may be at least partly inserted in the adhesive layer, such as buried in the adhesive layer 302, and may be fixed to the adhesive layer 302. In one or some embodiments, the rest or remainder of the attached flock 303 may be arranged or positioned outside the adhesive layer 302. Thereby, the flock 303 may at least partly protrude from the adhesive layer 302 and at least partly be embedded within the adhesive layer 302. For this reason, the flock 303 may be pierced into the adhesive layer 302 with the flock 303 protruding from the adhesive layer 302. If the flock 303 is fibers, the flock 303 may be pierced into the adhesive layer 302 in a state substantially perpendicular to the surface 301S of the main body 301. In this way, the electrostatic field may force the flock 303 to move upward and thereby attach perpendicularly to the surface. In particular, with the flock 303 piercing perpendicularly, the surface area may increase dramatically, thus improving the density and the ultimate textile feel of the product.

In the following step S105, the adhesive layer 302 may be cured. At least partly while curing occurs (such as during the entire curing process), the adhesive layer 302 may be dried and baked by heating or the like.

In the following step S106, cleaning may be performed. At that time, the adhesive layer 302 may remove excessive flocks 303 that are not adhered to the main body 301. This completes the flock product 3.

In one or some embodiments, flocking may be performed manually by a portable electrostatic coating device or the like. Alternatively, flocking may be performed at least partly automatically. For example, any one, any combination, or all of steps S101, S102, S103, S104, S105, and S106 may be performed automatically.

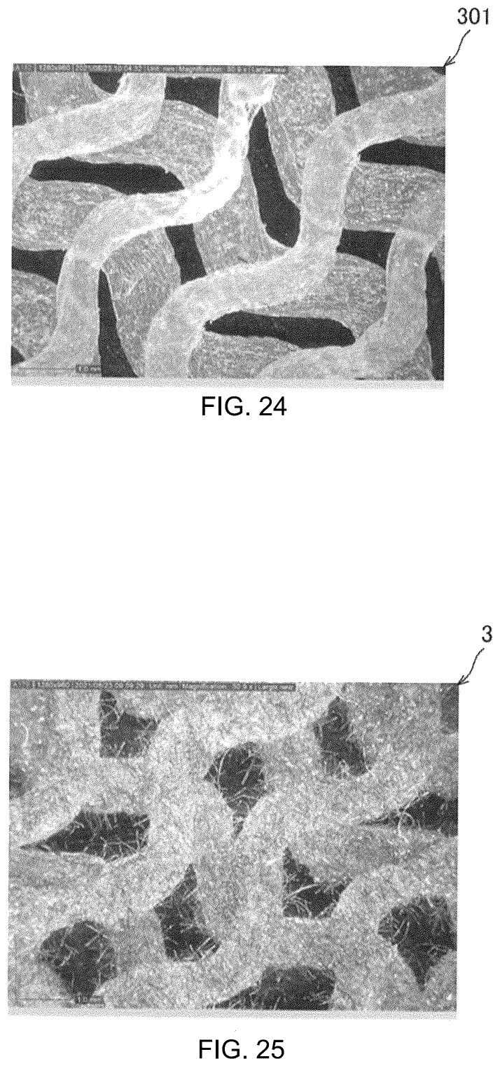

FIG. 24 is a photograph of a prototype of a main body provided in a flock product of the third embodiment. FIG. 25 is a photograph of a prototype of a flock product of the third embodiment. When comparing the main body 301 before flocking shown in FIG. 24 and the flock product 3 after flocking shown in FIG. 25, it may be understood that a complex unevenness may be formed on a surface of the flock product 3 by flocking.

Step S102 for arranging the adhesive layer 302 on the surface 301S of the main body 301 and step S104 for piercing the flock 303 into the adhesive layer 302, may require only a very short time, for example, 3-10 minutes. Even shorter times are contemplated, if the steps are automated. In one or some embodiments, step S105 for curing the adhesive layer 302 takes a longer time, for example, several hours (e.g., at least one hour, which may be at least 2 times, at least three times, at least five times, at least ten times, or at least 20 times greater than one or both of step S102 or step S104). However, by selecting an adhesive agent, it may be possible to reduce the time required for step S105.

The coating state of the flock 303 of the surface 301S of the main body 301 may be adjusted by adjusting one or more parameters of an electrostatic deposition in step S104. For example, by adjusting any one, any combination, or all of voltage and/or amperage of the electrostatic unit, height between electrodes, substrate height from the electrode, or flocking time (e.g., the time that current is applied), the entire surface 301S of the main body 301 may be uniformly coated with the flock 303, or the surface 301S of the main body 301 may be coated with the flock 303 so that a density of the flock 303 has a gradient.

A tactile feeling of the flock product 3 may be adjusted by adjusting any one, any combination, or all of: a type; a decitex (dTex); or a length of the flock 303. Further, various types of fibers may be flocked, including natural fibers or synthetics, including cotton, wool, polyesters, polyamides, or rayon. In one or some embodiments, decitex is a number that indicates how many grams a sewing thread of 10,000 m length weighs. A density of the flock 303 may be adjusted by adjusting the main body 301, properties of the adhesive agent, characteristics of the flock 303 and process conditions.

In one or some embodiments, the flock 303 may be unlikely to be affected by one, some, or all of the materials of the main body 301, but may be adjusted by selecting an adhesive agent. Thereby, the flock product 3 suitable for various applications may be manufactured. In this regard, characteristics of the flock product 3 may be unlikely affected by characteristics of the main body 301, and may be adjusted by selecting an adhesive agent. This may be because the adhesive layer 302 may function as an intermediate layer connecting the flock 303 to the main body 301, effectively isolating the flock 303 from the main body 301. In one or some embodiments, the flocking quality may be affected by any one, any combination, or all of: the main body; the adhesive layer; the flock type; or the flocking processing parameters.

In one or some embodiments, two or more types of the flocks 303 may be combined to obtain a structure and characteristics of the flock product 3 that may not be able to be obtained when one type of the flock 303.

In one or some embodiments, in order to implement the method for manufacturing the flock products described above, a factory may be established for performing the primary process and the secondary processes described above according to customer demands or seasonal collections. In particular, a factory may be established for performing only the above-described secondary processes according to customer demands. In this case, the main body 300 may be provided by the customer.

Various fibers are contemplated. In particular, contemporary implementations of fibers available on the market today include:

(i) Monofilament: These fibers are relatively stiff, to the extent that they may not be appropriate for clothing. These fibers are generally not breathable, or are associated with limited breathability. Any moisture (e.g., sweat) remains on the surface of clothing woven with monofilament fibers, as these fibers do not have any moisture wicking capabilities. These properties of monofilament fibers may make them uncomfortable to wear when woven into clothing.

(ii) Multifilament: Multifilament fibers have properties that provide a soft feel to clothing woven from such fibers. Multifilament fibers are considered more breathable than monofilament fibers, and may allow more moisture to pass through any material woven using these fibers (than compared to material woven using monofilament fibers). Such material may also include more moisture wicking capabilities (when compared to material woven using monofilament fibers), where moisture (e.g., sweat) may not remain on the surface, and may be wicked away by the material.

Current TPU filaments on the market are monofilament structures. These structures may be stiff, and may not be suitable candidate fibers for manufacturing wearable fabrics due to the associated discomfort.

Aspects of the current invention may be related to designing and manufacturing filament structures (also referred to as “fibers”), referred to herein as a “comfort fiber,” or “comfort fibers.” These filament structures may also be referred to as “comfort filament,” or “comfort filaments.” A comfort fiber may inherently include properties similar to moisture wicking, while being soft and comfortable to a wearer of a garment constructed from these filaments. In one aspect, a comfort fiber may include any one, any combination, or all of the desirable features of a multifilament fiber. An example of a comfort fiber is forming material 1. In one aspect, a comfort fiber may be comprised of one or both of:

(i) an outer layer (also known as a “sheath”). This layer may be similar to sheath 112. In one aspect, the sheath may include one or more kinds of natural powders and fibers (e.g., ramie, cotton, wool, silk, chitosan, etc.) that may add texture to an outer surface of the sheath. In another aspect, the sheath may include one or more kinds of natural powders blended with fibers (e.g., when manufacturing sheaths with a higher aspect ratio). In general, the sheath may include any one, any combination or all of powders, natural fibers, and additives combined in appropriate proportions to construct the comfort fiber with one or more requisite properties (e.g., properties similar to moisture wicking). These substances may be dispersed in the sheath layer as a plurality of particles. When water droplets or any other moisture accumulate on a first surface of a fabric (e.g., an inner surface in contact with the skin of an individual wearing the fabric), with the fabric being formed from one or more comfort fibers, these particles may wick moisture vapor from that surface. As a part of this moisture wicking process, the water vapor may go through the powder and may be transferred to a second surface of the fabric (e.g., an outer surface). This transfer may occur via a capillary effect. Such a structure may also be softer and less plastic as compared to contemporary materials, such as polyolefins based fibers (PP and PE fibers) and polyurethane fibers.

(ii) an inner core that is similar in construction and properties to core 111.

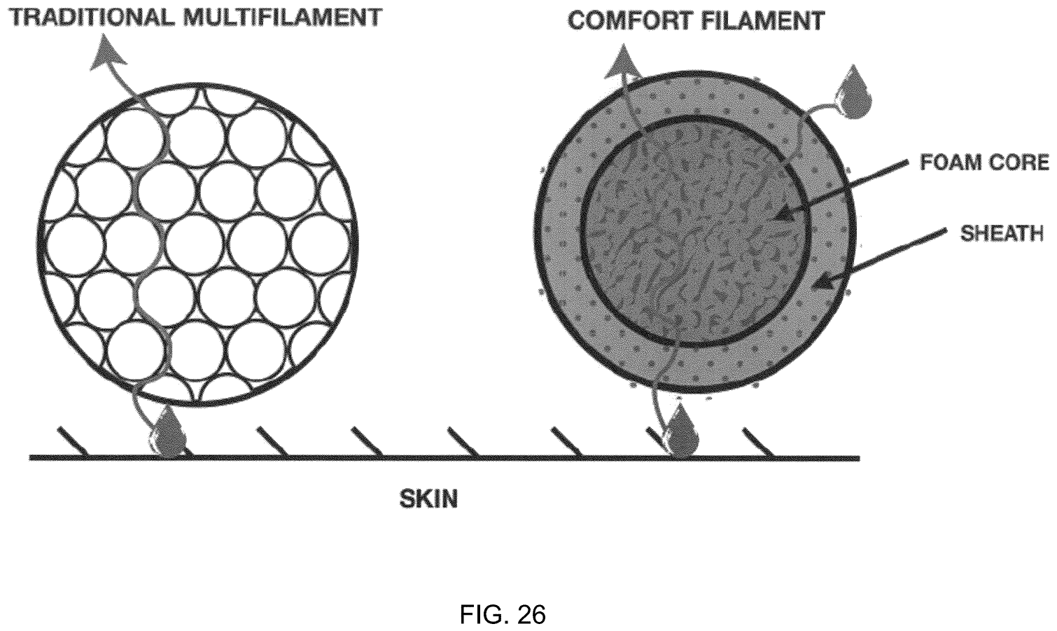

A comparative cross-sectional view of a contemporary filament and a comfort fiber is depicted in FIGS. 26A-B. A traditional multifilament is illustrated in FIG. 26A, while a comfort fiber is illustrated in 26b. The comfort fiber is shown to be comprised of a core made of foam, axially encapsulated in a sheath. In other aspects, the core is not foamed. The comfort fiber may be designed to incorporate the desirable qualities of a multifiber filament (e.g., softness, breathability, moisture wicking, etc.). The foam core may provide the comfort fiber with multifilament properties, such as softness and/or breathability. FIGS. 26A-B depict how the traditional multifilament fiber performs moisture wicking. FIGS. 26A-B also depict the comfort filament providing moisture wicking-like properties as described herein.

In general, a multifilament may be a strong and rigid structure with limited deformability and shape control during a weaving/knitting processes (or less deformability and greater shape control during a weaving/knitting processes than with a monofilament). In its final state (e.g., as a fabric), the multifilament may be held in place only by friction forces that form between adjacent multifilaments. During the weaving/knitting processes, the multifilament may be constrained into crisscross (e.g., warp and weft) patterns, or into unidirectional patterns (e.g., knitting).

Distinctly from the multifilament, the comfort fiber may be shaped during manufacturing (e.g., 3D printing) into different geometries, and is not constrained to crisscross or unidirectional patterns. In its final state (e.g., as a fabric), the comfort filaments may be held together by thermal welding.

The moisture wicking effect of multifilament fibers may be based on several strategies, including any one, any combination, or all of a multi-layer structure, chemical modifications and surface modifications (e.g., plasma treatments). The mechanism of reducing or eliminating moisture/water molecules from the skin in multifilament fibers, especially with the fast wicking/drying fabrics, may be based on capillary effects and hydrophobicity of the inner (skin contact) layer, and good moisture diffusion and evaporation due to the hydrophilicity of the outer layer. The differential capillary effects and water affinity between the different layers may be the key for wicking and quick drying. In case the fabric is not designed to support quick drying using the disclosed strategies, the drying process may be slower due to the high surface area and capillary effect both limiting the diffusion and elimination/desorption of moisture and water molecules. In contrast, the moisture wicking-like effect of the comfort fiber may be based on a different mechanism. Moisture and water molecules may be adsorbed and then absorbed into the comfort filament due to the presence of highly hydrophilic particles (e.g., cotton, wool, ramie etc.) on the surface, and a porous structure with surface protrusions that increase the surface area. The combination of hydrophilic particles and a large surface area may increase the absorption of moisture and water molecules from the skin into the comfort fiber.

In one or some embodiments, quick drying may also be enabled with the comfort filament structure due to any one, any combination, or all of three mechanisms: (i) localization of the hydrophilic matter on the surface only, thus reducing the effective path for diffusion; (ii) capillary effects that impede the drying process are reduced or minimized; (ii) the porous, open structure of the printed fabric allows moisture transfer and evaporation. Therefore, the comfort fiber may have desirable properties which are comparable to and in some cases better than a multifilament.

A SEM micrograph that demonstrates this concept is discussed subsequently.

Aspects of the design of a comfort fiber may allow the comfort fiber to be processed into (e.g., used to design and construct) a finished product (e.g., clothing or garments) using techniques such as any one, any combination, or all of 3D printing, bonding, heat press, weaving, knitting, crocheting, braiding, non-woven processes, and other textile applications. 3D printing may provide an advantage that the production of finished products using comfort fibers is not limited to larger-scale textile houses; rather, individuals with 3D printing machines and relevant experience may manufacture items using comfort fibers at home or in a relatively smaller-scale facility. Being able to use a comfort fiber with properties similar to a multifilament may be advantageous in this respect, because multifilaments may be unable to be used to produce finished products using techniques like 3D printing. In this regard, comfort fiber technology may democratize production of comfortable textiles, providing smaller-scale clothing designers with more options to design comfortable clothing while also providing options for more localized production, thereby reducing impact on the supply chain. Designers may avail themselves of customizable design options (e.g., any one, any combination, or all of color, mechanical properties, chemical properties, texture, softness, moisture wicking-like properties, breathability, etc.). Using 3D printing and small-scale production afforded by the process may allow for product customization and other advantages such as more customized fit, customized design and design details, branding, fabric pattern, etc.

Another advantage of comfort fiber may be that the comfort fiber may be made recyclable, thereby providing an environmentally-friendly property. This may be especially important given the quantities of non-biodegradable clothing that find their way into landfills.

In one aspect, the stages involved in producing a comfort fiber may include one or both of filament production or 3D printing.

### Filament Production

As discussed above, a filament may be used in 3D printing. The filament may be produced in one of several ways. See FIGS. 28 and 43. For example, in one or some embodiments, as a first step, an elastomer, such as a thermoplastic elastomer (TPU or similar) or other thermoplastic polymer/s, may be mixed with natural powder/s via a process (such as twin-screw extrusion). This is illustrated, for example, in step S201 in FIG. 28. The amount of fibers that are mixed with the polymer may range between 5-40% in weight; however, lower or higher amounts may also be used. Any one, any combination, or all of powder content, powder/fibers type and an associated aspect ratio may be relevant factors in controlling the morphology of the final printed product (e.g., the comfort fiber). In one or some embodiments, natural powders may be used for this purpose. Further, in one or some embodiments, the orientation of the fibers and/or particles may be controlled via one or more processing techniques, such as any one, any combination, or all of: printing angle; printing speed; particle length; relative thickness of the sheath layer (e.g., relative to the particle length); or viscosity of the polymer in which the fibers and/or particles reside in the sheath layer. In this way, controlling the orientation of the fibers, for example, may be used to control the effect of the fibers on the skin of a user of the formed product.

In one aspect, a twin-screw extruder (discussed further below) may be used for the melt/mixing process due to its mixing capabilities that may result in homogenous mixture. This, in turn, may result in better dispersion and distribution of the particles inside the polymer matrix, reducing or minimizing agglomeration that may have detrimental effects on the filament properties as well as on the printed article. The outcome compound from the twin-screw extrusion process may be one of the raw materials that may be used for the next step of filament production.

As a second step, converting the raw materials into a filament (e.g., for 3D printing applications) may be executed via, for example, a co-extrusion process. See step S202 in FIG. 28. In such a process, two different extruders may deliver melt stream into a die head. The melt stream may be shaped into a coaxial structure with core and sheath layers. In one aspect, a diameter of the filament is approximately 1.75 mm. Although 1.75 mm is more popular among users, the process is not limited to that specific diameter, and other diameters may be produced (e.g., 2.8 mm or the like). In general, filament diameters larger or smaller than 1.75 mm may be used. The two most common filament diameters for FDM/FFF are 1.75 mm and 2.85 mm; however, other diameters are contemplated.

As discussed above, various hardware is contemplated to produce the filament. One example block diagram 4200 of the hardware is illustrated in FIG. 42 in which a plurality of extruders are used, such as core extruder(s) 4210 and sheath extruder(s) 4220. As discussed above, the core may consist of a single material. Alternatively, the core may comprise a plurality of materials. In the instance where the core consists of a single material, a single extruder may be used. In the instance where the core comprises multiple material (e.g., a TPU and fibers/particles), a twin-screw extruder may be used.

Thus, in one or some embodiments, raw materials may be used as-is (e.g., in their natural form, such as pristine plastic pellets). Alternatively, the raw materials may be used as a compound that contains different additives and/or polymers. A combination between the two is also contemplated. Further, in one or some embodiments, the core layer may mostly be based on a thermoplastic elastomer, while other additives may be added during extrusion in order to grant different properties to the final filament/printed article.

Similarly, in the instance where the sheath comprises multiple materials, a twin-screw extruder may be used. Further, the raw materials for the sheath layer may be based on the compounds described herein, while other additives and/or polymers may be incorporated during filament extrusion. These additives and/or polymers may be added with the goal of achieving the desired properties. The sheath layer may be responsible for the roughness created on the surface of the filament; this aspect, along with material properties and the following printing process, may determine the textile properties of the printed fabric.

In one or some embodiments, the extruder may perform one or more functions, such as any one, any combination, or all of: inserting the material(s) into a vat, container, or the like; melting the material(s); mixing the melted material(s); expressing/pushing the mixed/melted material(s) from the extruder into a die head. In this regard, the extruder may generally include a gearbox/motor(s) 4214, 4224 (e.g., works in combination with the gear box to generate motion and transfer motion to rotate the one or more screws), a feeder 4212, 4222 (e.g., to feed the materials into a vat or container in the predetermined desired portions), one or more screws 4216, 4226 (in order to rotate the ingredients in the vat; a single screw for a single-screw extruder; two screws for a twin-screw extruder), and heater(s) 4218, 4228 (e.g., to heat the materials in the vat). Thus, in one embodiment, core extruder(s) 4210 may comprise a single-screw extruder (having a single screw) in which to mix a single material. Alternatively, core extruder(s) 4210 may comprise a twin-screw extruder (having at least two screws) in which to mix multiple materials. Further, sheath extruder(s) 4220, which may mix multiple materials for the sheath, may comprise a twin-screw extruder that includes at least two screws. In one or some embodiments, one or more sensors may be positioned in or on the container or vat for providing feedback to one or both of the heater(s) 4218, 4228 or the controller(s) 4270 in order to regulate the amount of heat generated by the heater(s) 4218, 4228 to heat Though not illustrated in FIG. 42, one or more pumps may be used to extrude the melted/mixed materials.

Thus, the melted/mixed materials from each of core extruder(s) 4210 and sheath extruder(s) 4220 may be routed to different sections of the die head 4230, such as the output from the core extruder(s) 4210 being routed to core section 4232 and the output from the sheath extruder(s) 4220 being routed to sheath section 4234. In one or some embodiments, the die head 4230 may be at least 100 mm or at least 200 mm in length. In practice, the materials extruded into the die head may be cooled, resulting in the filament. Various ways are contemplated to cool the materials, such as by using a pulling device 4240 in order to pull the materials from a cooling device 4250 (e.g., a cooling bath). After which, a winding/collecting device 4260 may be configured to collect the cooled filament (e.g., a motor and/or a spool).

FIG. 42 further illustrates controller(s) 4270, which may comprise one or more controllers. As shown, the controller(s) 4270 may be external to any one, any combination, or all of the core extruder(s) 4210, sheath extruder(s) 4220, pulling device 4240, cooling device 4250, or winding/collecting device 4260. Alternatively, or in addition, the controller(s) 4270 may be internal to any one, any combination, or all of the core extruder(s) 4210, sheath extruder(s) 4220, pulling device 4240, cooling device 4250, or winding/collecting device 4260. Further, a central controller may control any one, any combination, or all of the core extruder(s) 4210, sheath extruder(s) 4220, pulling device 4240, cooling device 4250, or winding/collecting device 4260. Alternatively, or in addition, a local controller (which may be resident in or associated with) may be used to control (such as responsive to a command sent from the central control and/or based on its own analysis) any one, any combination, or all of the core extruder(s) 4210, sheath extruder(s) 4220, pulling device 4240, cooling device 4250, or winding/collecting device 4260.

In practice, controller(s) 4270 may communicate via wired and/or wireless communication (such as illustrated by 4280). Further, in practice, any one, any combination, or all functions for the core extruder(s) 4210, sheath extruder(s) 4220, pulling device 4240, cooling device 4250, or winding/collecting device 4260 may be automatically controlled by controller(s) 4270. By way of example, any one, any combination, or all of the feeder 4212, 4222, gearbox/motor(s) 4214, 4224, one or more screws 4216, at least two screws 4226, heater(s) 4218, 4228, may be automatically controlled by controller(s) 4270.

FIG. 43 is a flow diagram 4300 of one example of filament production. At 4310, the materials may be put into one or more machines, such as a first set of material(s) (which may consist of a single material or may comprise a plurality of materials) for the core being put into a first machine and a second set of material(s) for the sheath to be put into a second machine. At 4320, the materials are heated in the respective machines (e.g., the first set of material(s) is heated in the first machine and the second set of material(s) is heated in the second machine). After melting of the materials, at 4330, the materials are mixed in the respective machines. At 4340, mixed/melted materials are extruded from the respective machines into different parts of the die head (e.g., the first set of material(s) for the core being extruded into the core portion of the die head; the second set of material(s) for the sheath being extruded into the sheath portion of the die head). At 4350, the materials are cooled to form the filament.

In one or some embodiments, a core/sheath area/diameter ratio (e.g., a cross-section/area ratio) may be an important factor, and may be tuned/balanced to achieve the desirable properties.

Regarding material selection for the sheath layer, the final roughness may be tuned by the amount of particles and/or fibers that are incorporated in the compound in a manner described above. To densify (e.g., increase) the roughness, a higher amount of particles and/or fibers may be used, while the opposite is true if one would like to minimize the roughness. In other aspects, controlling surface roughness may also be made by changing the aspect ratio of the particles.

FIGS. 27A and B depict two different embodiments of a comfort fiber. FIG. 27A shows a cross section of a comfort fiber with a medium loading of particles in the associated sheath layer. This sheath layer may be characterized by a moderate content of natural fibers. FIG. 27B shows a cross section of a comfort fiber with a high loading of particles in the associated sheath layer. This sheath layer is characterized by a relatively high content of natural fibers (higher density). Varying the density of particles in the sheath layer may be used to modify the properties of the printed article/fabric.

As the sheath layer is mostly kept relatively thin, friction developed between the particles and/or fibers and the die walls during extrusion may push the particles toward the surface of the filament. This, in turn, creates a roughness that masks the “plastic feel” of the filament or printed article. The resultant filament that emerges from the die lips may be introduced into a cooling bath to cool down, and then may be dried and collected. The end product of this process is the comfort fiber. In this regard, FIGS. 27A-B illustrates at least three things: (1) the formed product from 3D printing the filament with the core/sheath structure generally retains the core/sheath structure in the layer(s) printed; (2) the shape may change (e.g., the diameter of the 3D printed layer in the formed product is smaller by at least ½ or by at least ¼; see reduction from 1.75 mm to 0.4 mm); (3) one or more materials in the sheath in the filament may protrude from the 3D printed layer in the formed product (e.g., the fibers and/or particles, such as the natural fibers illustrated in FIGS. 27A-B, in the filament may be pushed outward from the sheath in 3D printing the layer, thereby potentially accentuating the effect of the fibers and/or particles on the skin of a user).

Different filaments with a range of properties may be produced by changing any one, any combination, or all of: material composition; core/sheath ratio; extrusion processing parameters; extruders and die head structure; and so on.

### 3D Printing (e.g., for Article Manufacturing)

In one aspect, a comfort fiber may be used to manufacture a finished product (e.g., an article of clothing) via 3D printing. See step S203 in FIG. 28, in which 3D printing is performed on the comfort filament to shape the comfort filament into a desired final geometry. The comfort fiber may be introduced into a 3D printing machine/printer that shapes the comfort fiber to a desired final geometry. Since the flow developed inside the printing head is laminar, the coaxial structure of the comfort fiber may be maintained during the printing process, and the particles and/or fibers may be pushed to the outer surface of the printed layer. As the filament is drawn down during printing, the overall diameter as well as the relative diameter of core/skin layers, may be reduced (depending on the die head). This, in turn, may push the particles and/or fibers to protrude from the surface of the printed layer, creating the desirable (or desired) roughness. Another parameter that may control the level of protrusion (and in turn the roughness) is the ratio between particle/fiber length and sheath layer thickness. Longer fibers may cause pronounced protrusions from the surface, thus increasing the roughness and the count of fibers on the surface. The particles/fibers aspect ratio may also affect their stiffness. This may change the feel and the softness of the printed article/fabric. The resulting roughness in combination with material properties may grant the finished product (e.g., the final printed article/textile) a feel/soft touch. In this regard, various aspects of the comfort fiber, including one or both of the roughness or the stiffness, may be controlled based on the selection of the particles/fibers, based on at least one aspect of the sheath (e.g., the thickness of the polymer in the sheath layer), or based on both of the particles/fibers and the sheath (e.g., the ratio between particle/fiber length and sheath layer thickness).

A combination of any one, any combination, or all of filament structure, material composition, printing processing parameters, printer structure, and printing geometry may determine the final properties of a fabric or textile created using comfort fibers. Properties, including any one, any combination, or all of breathability, wicking-like properties, moisture control, quick drying, hand feel, drapability, and soft touch, may be tuned in each of the production steps to modify the final properties. A comfort fiber may also be processed using a flocking process as described herein. A flow diagram depicting the process of creating a comfort fiber and an article of clothing from the comfort fiber is presented in FIG. 28, as discussed above.

In an embodiment, a printed fabric/textile using comfort fibers is not limited or constrained to the crisscross weaving and/or knitting directions that are prevalent in the textile industry; therefore, a multi-directional pattern may be achieved by processing comfort fibers accordingly.

Various features of the comfort fiber may include any one, any combination, or all of:
(i) circumvent the “plastic” or “synthetic” feel of other consumable filaments that are available in the market by adding a functional sheath layer;
(ii) the surface roughness created by the sheath layer after the printing process and/or the material's composition of this layer may impart any one, any combination, or all of the following properties to a printed article created using comfort fibers: soft touch; air-tunneling (e.g., when contact with skin); wicking-like effect; quick drying; or reduction in the coefficient of friction;
(iii) the combination between materials in the sheath layer may be used to “tailor” or “modify” the roughness and the resulted properties described in (ii);
(iv) the resultant core/sheath structure imparts any one, any combination, or all of the following properties to the printed article: comfortable tactile feeling; flexibility; elasticity; breathability; air permeability; antibacterial properties; high strength; moisture transmission; low weight (e.g., if foamed); or flexibility in design (e.g., custom-made/tailor-made);
(v) the combination between the materials in core/sheath layers and/or the ratio between core/sheath may be used to tailor the properties described in (iv). The printing process itself may provide an additional design dimension that may be used to modify the properties described in (iv);
(vi) the final product printed from the aforementioned structures (and without having flocking on it) may be recycled; and
(vii) the printed filament may be printed directly on different types of substrates including any one, any combination, or all of surfaces, textile fabrics, apparels, plastic and polymers, metal, or ceramics.

### Post Processing of 3D Printed Fabrics

Various post processing of 3D printed fabrics are contemplated. For example, in one or some embodiments, in general, fabric created using comfort fibers without flocking on it, may not have the feel and touch of flock fibers, regardless of the filament used to create the fabric. In addition to flocking, combinations of one or more other processes may be applied to the printed material after 3D printing for additional benefit(s), such as softness. Such processes may include any one, any combination, or all of laser ablation, plasma treatments, surface texture/roughness, or washing techniques.

For example, in one or some embodiments, laser ablation may comprise controlling at least one laser to direct laser energy (interchangeably termed laser radiation or radiation) at a surface of the formed product. In practice, the laser energy, via heat generated in or on the formed product, may change at least a part of the formed product, such as one or both of: (i) a surface; or (ii) an interior of the formed product. As one example, the laser ablation may affect, via heat, the surface of the formed product (e.g., a feel or roughness of the surface; fibers and/or particles on the surface). Alternatively, or in addition, the laser ablation may affect an interior of the formed product (e.g., additives in an interior layer of the formed product may be affected or activated by the laser energy).

As one example, laser ablation may be used on a formed product, such as a formed product that is formed by forming material 1 discussed above with at least one sheath 112. In particular, the formed product may comprise one or more layers, with at least one, at least some, or all of the layers have a core/sheath construction. In one or some embodiments, the laser ablation may affect one, some, or all of the layers of the formed product, including one or both of surface of the layer(s) and/or an interior of the layer(s) having the core/sheath construction. Alternatively, or in addition, the formed product may be partly (or entirely) composed of layers that have a core construction, with laser ablation affecting one, some, or all of the layers of the formed product, including one or both of surface of the layer(s) and/or an interior of the layer(s) having the core construction.

Specifically, the laser ablation may affect the formed product in one of several ways, such as one or both of: (i) affecting the surface of the formed product (e.g., the surface of the layer(s) of the formed product); or (ii) affecting an interior of the formed product (e.g., an interior of the layer(s)). For example, the laser ablation may generate heat in the sheath layer in order to affect one or more of the materials in the sheath layer (e.g., the laser energy affecting one or more materials in the sheath, such as affecting the TPU with the sheath, thereby accentuating the fibers and/or particles within the sheath of the formed product and/or affecting the fibers and/or particles within the sheath directly, as discussed further below). As one example, the laser ablation may create a pattern, whether uniform and/or non-uniform, such as a micro-pattern (e.g., texture) on the surface of the formed product (e.g., a top layer of printed fabrics or other types of formed products) to attain different surface properties, such as any one, any combination, or all of: a soft touch; a textile feel; moisture management (e.g., wicking); or tuning surface energy (e.g., hydrophobic/hydrophilic nature of the surface). In one or some embodiments, the ablated pattern may be unidirectional or multi-directional, and need not be limited to specific geometry. Merely by way of example, the laser ablation may texturize the surface of the formed product in order to achieve a predetermined geometry on the surface, such as a ‘hairy-like’ structure that may comply easily when forced is applied. Typical apparel has, on close inspection, tiny fibers liberated fibers on the surface. These liberated fibers, escaping the grasp of the main textile, may create a delightful sensory experience. In this way, these microscopic wanderers contribute to a softer touch, enhancing the way fabrics react with the skin. With this background, one of the purposes of using the laser treatment is to mimic those tiny “hair like” patterns that alter the surface to be perceived by the user as more pleasant and more soft. Eventually, when the skin is contact with such tiny elements, the user may bend them more easily so that less pressure is applied on the skin. In addition, the air passage is improved due to the gap formed between those fibers and the skin. Theoretically, such geometry is desirable but its highly difficult to achieved by the printing process; therefore, a secondary process of application of laser radiation is used to achieve such effect. Responsive to using a laser than has a resolution in the micron scale (e.g., less than 1 mm), the effect of modifying the surface of the formed product may mimic this “hairy like” geometry, or at least create tiny elements on the surface of the formed product that may improve the interactions with skin.

Thus, in one or some embodiments, on a border perspective, the high resolution of the laser (e.g., on the micron-scale, or less than 1 mm) may be used to modify the surface geometrically to meet predetermined requirements and properties. Thus, in one or some embodiments, the laser ablation may affect the surface of the formed product (e.g., a surface of the sheath 112 in the formed product).

Alternatively, or in addition, the laser ablation may produce an effect within the formed product, such as: (i) within the sheath of the layer(s) of the formed product (such as affecting fibers and/or particles (e.g., fibers/particles 123) to have a more pronounced or prominent effect (after 3D printing) on the end-user of the formed product); and/or (ii) within the core of the layer(s) of the formed product. As one example, the laser ablation may expose the protruding fibers by ablating the thin polymeric film that coats the fibers' and/or particles' surface. Exposing the fibers/particles within the sheath of a respective layer (e.g., the layer that is the uppermost layer thereby exposed to the skin) may thus improve the interactions with the skin due to the intimate contact, thus allowing to improve or to maximize the potential of the fibers/particles that are embedded in the sheath layer. Exposing the fibers and/or particles may also tune “surface chemistry” in order to control/tune the hydrophilic/hydrophobic nature of the surface. In this way, the laser heat may expose the fibers and/or particles closer to or up to the surface of the formed product and thereby affect the feel of the product. Alternatively, or in addition, various additives, such as fibers/particles 123, in the sheath may be affected by the laser heat (e.g., the fibers/particles 123 may be activated by the laser heat). Thus, in one or some embodiments, the hydrophilic/hydrophobic nature of the surface may be dictated by any one, any combination, or all of: (i) creating a pattern on the surface of one or more layers of the formed product; (ii) exposing the fibers/particles in the sheath; or (iii) activating or changing the chemistry of the materials in the sheath.

As another example, laser ablation may be used on a formed product that includes a core (such as core 111), which may be composed of a single substance and/or which may have additives (e.g., fibers and/or particles) within and which may not have any sheath. In such an instance, the laser ablation may affect the surface of the formed product (e.g., a surface of the core 111), with the fibers and/or particles in the core having a more pronounced effect on the user after laser ablation. In this way, laser ablation may affect one or more surfaces of the formed product, thereby potentially exposing the fibers and/or particles to be more readily in contact with the skin of the end user. Alternatively, or in addition, the additive(s) in the core 111 may likewise be activated via the laser heat. Still alternatively, a formed product that includes layers that comprise (or consist) of a core with a single material may be modified by laser ablation by potentially removing parts of the core material, thereby mechanically affecting layers (such as outer layers and/or inner layers) of the formed product.

As discussed above, the laser ablation may affect one or more layers of the formed product. As one example, the laser ablation may affect the surface of the printed fabric, which may directly contact the skin of a user. Alternatively, or in addition, the laser ablation may affect interior layers (e.g., effectively hidden layers from the perspective of the user) of the formed product. In particular, laser ablation may be applied on different directions on the “hidden” layers of the formed product that may be offset from the main linear body, or may not directly contact with the skin (e.g., offsetting one or more of the printed layers from the direction of the linear body that is in contact with the skin). Thus, by selectively ablating hidden surfaces, properties such as moisture management (e.g., wicking and moisture uptake) and drapability may be tuned.

As discussed in more detail below, the laser radiation generated by the laser may be controlled in order to be directed in a controlled manner in any part of the formed product, such that the laser radiation may affect the surface of one or more layers of the formed product and/or may affect an interior (e.g., within the sheath and/or within the core) of one or more layers of the formed product.

In this way, laser ablation may modify the formed product in one of several ways including modifying the surface (e.g., creating different roughness, different textures, different patterns) and/or modifying the interior (e.g., activating additives therein and/or removing materials thereby modifying the mechanical structure and/or enhancing remaining materials). In one particular example, the roughness/texture of the layer(s) of the formed product may be dictated by any one, any combination, or all of: the ablated regime; processing parameters; or the response of the material to the laser. Generally speaking, the finer the details (e.g., desired texture), the lower the roughness. In this regard, strategic and controlled application of laser ablation may provide for post-processing of the formed product after 3D printing. Thus, in one or some embodiments, the laser ablation, applied after 3D printing, may effectively alter or improve the 3D printing process. In practice, filaments, such as monofilaments or multifilaments, prior to 3D printing may have predefined properties (e.g., roughness). 3D printing may change those properties, such as changing the roughness of the filament in generating the formed product. In this way, the laser ablation may control the properties of the surface, such as the roughness, either due to the 3D printing process or due to a desired predetermined feel of the surface after the 3D printing process.

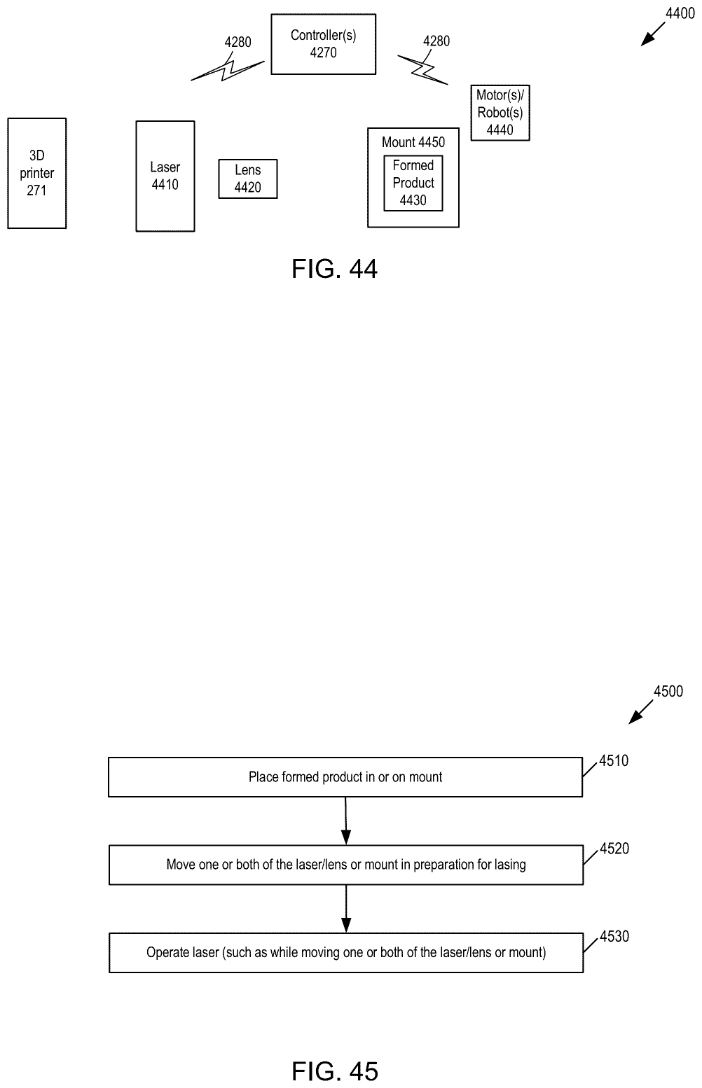

FIG. 44 illustrates a block diagram 4400 of one example laser radiation system that may be used in combination with a 3D printer 271. Specifically, FIG. 44 illustrates that a formed product may be printed by 3D printer 271. In one or some embodiments, the formed product may be automatically conveyed (such as by a conveyor or the like) to a laser radiation device which may comprise any one, any combination, or all of: laser 4410; lens 4420, mount 4450; motor(s)/robot(s) 4440; or controller(s) 4270. Alternatively, product may be manually conveyed to laser radiation system.

Further, it is contemplated that one or more lasers may be used, such as a single laser/lens combination, or multiple respective laser/lens combinations. In one or some embodiments, laser 4410 may comprise a UV laser. Alternatively, other wavelength lasers are contemplated. Further, laser 4410 may include one or more lasing parameters, which may be controlled by controller(s) 4270, as discussed further below. Further, aspects of the lens may be selected for predetermined application of laser radiation. In particular, any one, any combination, or all of the following laser parameters or lens parameters may be selected and/or controlled by controller(s) 4270: laser power and/or intensity; laser resolution (e.g., higher resolution may lead to a more accurate representation of patterns and finer details on the ablated surface); laser wavelength; lens dimensions (e.g., diameter); lens to substrate distance and/or focus position (e.g., which may be affected by movement of one or both of the lens 4420 or the mount 4450 by motor(s)/robot(s) 4440, as discussed further below); field size; scanning speed (e.g., a higher rate may result in faster processing; scanning speed may further affect potential heat accumulation in or on the layer(s) of the formed product); pulse energy (e.g., higher energy; deeper and wider features); pulse frequency (e.g., higher rate may result in faster processing; pulse frequency may further affect potential heat accumulation in or on the layer(s) of the formed product); geometry of the ablated pattern; distance between lines, line's depth, etc. (e.g., the geometrical pattern may only be the desired geometry/texture; however, the final texture may be dictated by a combination of processing parameters and the desired geometry); or geometrical pattern of the surface to be treated (e.g., printed fabric geometry).

Other processing parameters that may affect the application of laser radiation may include: material composition of the sheath layer; and/or core/sheath ratio. For example, with regard to the material composition of the sheath layer, the laser response to a substrate may be highly affected by material's chemistry. In this regard, different additives (which may be added to one or both of the core or the sheath) may be used to tune the response of the laser, to a certain extent. In this regard, additives may also be introduced into the sheath layer if it is sought for the laser to penetrate deeper into a respective layer to attain specific properties. Further, the core/sheath ratio may affect the laser response, such as when specific additives that may intensify the response are introduced into the sheath layer. Various materials or additives that react or modify responsive to laser radiation are contemplated. As one example, carbon-based materials, such as carbon black, may enhance the laser response. Alternatively, or in addition, different pigments may improve the laser response of polymers (e.g., one or both of Tin and Antimony may be used to increase the laser response of polymers). As still another example, shelf additives may be used to increase laser ablation response of polymers.

Further, the formed product 4430 may be held in or on mount 4450. In one or some embodiments, the formed product 4430 is composed of one or more layers. In one or some embodiments, one, some, or each of the layers of the formed product 4430 may be composed of the core/sheath construction. Alternatively, or in addition, one, some, or each of the layers of the formed product 4430 may consist of a core construction (without a sheath). In either case, the laser radiation generated by laser 4410 may affect one or more of the layers (e.g., on a respective layer surface and/or in an interior of a respective layer).

FIG. 44 further illustrates motor(s)/robot(s) 4440 and controller(s) 4270. As discussed above, controller(s) 4270 may be configured to control one or more devices, such as any one, any combination, or all of: laser 4410; mount 4450; or motor(s)/robot(s). In practice, controller(s) 4270 may be configured to control one or more parameters associated with the laser 4410 (e.g., any one, any combination, or all of: laser power/intensity; laser resolution; laser wavelength; scanning speed; pulse energy; pulse frequency; or the like. Alternatively, or in addition, controller(s) 4270 may be configured to control motor(s)/robot(s) 4440 in order to mechanically manipulate and/or move various objects. As one example, controller(s) 4270 may be configured to control motor(s)/robot(s) 4440 to move the formed product 4430 to mount 4450.

As another example, controller(s) 4270 may be configured to control motor(s)/robot(s) 4440 to move the lens 4420 and the laser 4410 relative to one another (e.g., keeping the laser 4410 stationary and moving the lens 4420; keeping the lens 4420 stationary and moving the laser 4410; moving both the laser 4410 and the lens 4420). In this way, relative movement of the laser 4410 and the lens 4420 may be achieved in one of several axis, such as along any one, any combination, or all of an x-axis, a y-axis, or a z-axis (e.g., defining movement in any direction).

As still another example, controller(s) 4270 may be configured to control motor(s)/robot(s) 4440 to move the laser 4410/lens 4420 and the mount 4450 (or the mount 4450/formed product 4430) relative to one another, by moving one or both of the laser 4410/lens 4420 and the mount 4450 (or the mount 4450/formed product 4430) (e.g., keeping the laser 4410/lens 4420 stationary and moving the mount 4450; keeping the mount 4450 stationary and moving the laser 4410/lens 4420; moving both the laser 4410/lens 4420 and the mount 4450). In this way, relative movement of the laser 4410/lens 4420 and the mount 4450 may be achieved in one of several axis, such as along any one, any combination, or all of an x-axis, a y-axis, or a z-axis (e.g., defining movement in any direction).

In one or some embodiments, controller(s) 4270 may be configured to control the focus of the laser radiation generated by the laser 4410 relative to the formed product 4430 in order to apply the laser radiation in a predetermined manner in or on various parts of the formed product 4430. As discussed above, laser radiation may be applied in order to modify one or more layers of the formed product 4430. In one example, an outer layer of the formed product (which may be in contact with the skin of a user) may be modified by the laser radiation. In such case, the laser radiation may modify the surface of the outer layer (e.g., the surface that directly contacts the skin of the user), resulting in a pattern, an etch, or the like. Alternatively, or in addition, the laser radiation may modify an interior of the outer layer (e.g., an interior of the sheath layer and/or the core in a sheath/core construction of the outer layer; an interior of the core in a core construction of the outer layer). As one example, the laser radiation may comprise laser ablation, effectively removing sections or materials of the outer layer(s). In one particular example, the laser radiation may ablate the TPU (or other materials) in a sheath of a respective outer layer, thereby potentially enhancing other materials (such as fibers and/or particles in a sheath of the outer layer) in the respective outer layer and/or potentially modifying the mechanical properties of the sheath of the respective outer layer. This may be akin to applying PVA (or another water-soluble material) to an outer layer, whereby after washing, the PVA may be removed from the outer layer (e.g., from the sheath of the outer layer). In contrast, because the laser radiation may be controlled or directed, the ablated sections may be more tightly controlled in order to more selectively remove material from the outer layer(s). Alternatively, or in addition, in another particular example, the laser radiation may ablate the TPU (or other materials) in a core of a respective outer layer, thereby potentially enhancing other materials in the core of the respective outer layer or potentially modifying the mechanical properties of the core of the respective outer layer. In yet another particular example, the laser radiation may modify specific additive(s) in the respective outer layer (e.g., in the sheath and/or the core), that may effectively intensify the response of the specific additive(s).

In another example, an inner layer of the formed product 4430 (which may not be in contact with the skin of a user) may be modified by the laser radiation. As discussed above, the inner (or hidden) layer(s) of the formed product 4430 may be modified to selectively apply laser radiation to hidden surfaces or selectively ablate portion(s) on a surface or in the interior of a respective inner layer to modify properties of the formed product 4430, such as moisture management and/or drapability. In one particular example, the laser radiation may effectively remove sections or materials of the inner layers (e.g., removing some of the TPU in a respective inner layer), which may affect the mechanical properties of the inner layers and/or enhance other materials in the inner layers (in the sheath of a respective inner layer and/or in the core of the respective inner layer). In this regard, because the laser radiation may be controlled or directed, the ablated sections may be more tightly controlled in order to more selectively remove material from the hidden layers. In yet another particular example, the laser radiation may modify specific additive(s) in the respective inner layer (e.g., in the sheath and/or the core), that may effectively intensify the response of the specific additive(s).

As discussed above, the controller(s) 4270 may be configured to direct the laser radiation generated by the laser 4410 to a predetermined section in or on the formed product 4430. For example, the focus of the laser radiation generated by the laser 4410 may be modified by the controller(s) 4270, as discussed above. In this regard, the focus of the laser radiation may be positioned in a predetermined manner relative to a respective layer (e.g., an outer layer and/or an inner layer) in the formed product 4430 to affect the respective layer in the formed product 4430. Thus, the focus of the laser radiation may be positioned in one of several ways relative to the respective layer, including any one, any combination, or all of “above” the respective layer (e.g., closer to the laser 4410), within the respective layer, or “below” the respective layer (e.g., further from the laser 4410). In this way, the controller(s) 4270 may direct the laser radiation in a very directed, pinpoint manner to achieve the results discussed herein.

To that end, FIG. 45 illustrates on example flow chart 4500 to perform laser ablation. At 4510, the formed product is placed in or on the mount. At 4520, one or both of the laser/lens or the mount is moved in preparation for lasing. At 4530, the laser is operated (e.g., while moving one or both of the laser/lens or mount and/or while the laser/lens and the mount is stationary) in order to direct laser radiation to a predetermined layer on or in the formed product.

Plasma treatment is another example of post processing of the formed product. In one or some embodiments, a plasma surface treatment may be used to modify surface properties of the formed product, such as surface energy, functionalization and cleaning the surface (e.g., cleaning from contaminates). In this regard, plasma treatment may be used to perform any one or both of: modifying sheath layer composition (e.g., chemistry in the sheath layer may be tuned to increase/decrease reactivity and response to plasma; and generating a geometrical pattern on the surface to be treated. Various parameters of the plasma treatment may be modified, such as any one, any combination, or all of: tuning of plasma power (e.g., higher power may result in more extensive modification and/or potential degradation); duration of plasma exposure; modifying plasma pressure (e.g., lower pressure: higher energy particles, deeper modification); gas composition (e.g., which may determine reactive species, leading to specific surface modifications).

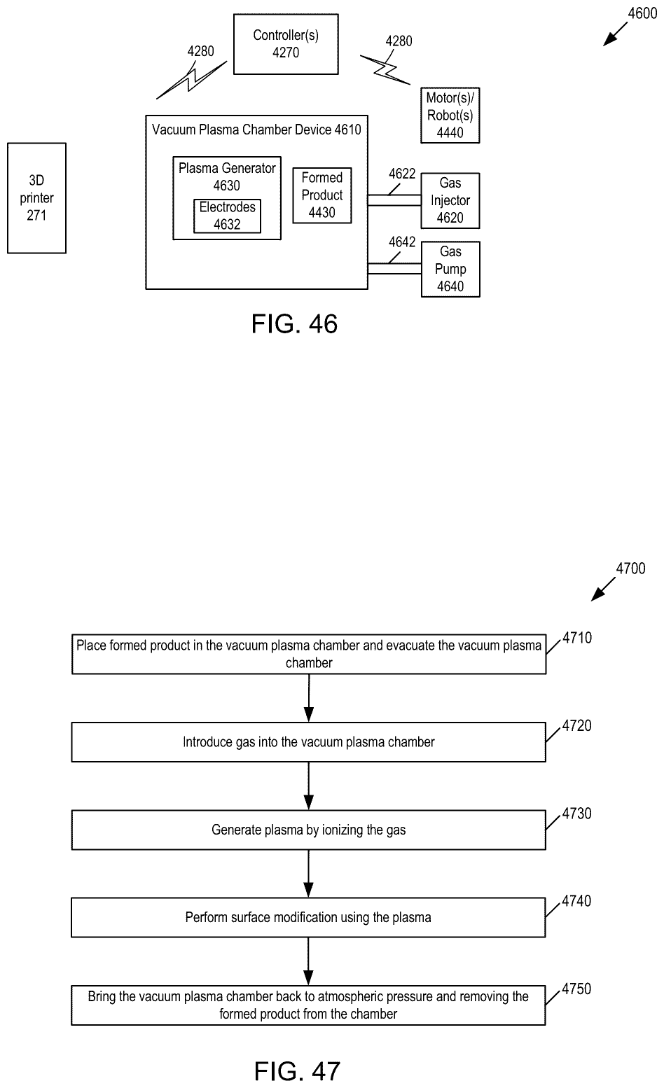

Various hardware is contemplated to perform the plasma treatment, an example of which is illustrated in the block diagram 4600 of FIG. 46. Specifically, FIG. 46 illustrates that a formed product may be printed by 3D printer 271. In one or some embodiments, the formed product may be automatically conveyed (such as by a conveyor or the like) to a plasma treatment device, which may comprise any one, any combination, or all of: vacuum plasma chamber device 4610; gas injector 4620; gas pump 4640; motor(s)/robot(s) 4440; or controller(s) 4270. Alternatively, product may be manually conveyed to plasma treatment device.

In particular, FIG. 46 illustrates a vacuum plasma chamber device 4610 (interchangeably termed a plasma chamber or plasma enclosure) that includes a plasma generator 4630 and electrodes 4632, and into which formed product 4430 may be placed. In one or some embodiments, plasma treatment may be performed in the vacuum plasma chamber device 4610 that is evacuated (e.g., vacuum plasma). The air within the chamber or enclosure may be pumped out using gas pump 4640 and gas line 4642 prior to letting gas in. The gas may then flow using gas injector 4620 and gas line 4622 in the vacuum plasma chamber device 4610 at a low pressure. This may be performed before any energy (e.g., electrical power) is applied. Thus, plasma treatment performed at low temperature may process materials, such as within one or more layers of the formed product 4430, that are heat sensitive.

In one or some embodiments, plasma generator(s) 4630 may produce the requisite radio frequency (RF) power to create and maintain plasma within the plasma chambers of the vacuum plasma chamber device 4610. Production of plasma may be accomplished by adding sufficient energy to a gas using gas injector 4620 in the vacuum plasma chamber device 4610 to free electrons from their atoms or molecules and to allow both the resulting ions and electrons to exist together. As such, in one or some embodiments, one way to generate this ionized gas, or plasma, is by introducing a gas using gas injector 4620 into a space between two parallel electrodes 4632. One electrode may be grounded, while the other electrode may be energized by power from an RF generator. The capacitive or inductive coupling between the electrodes may thus excite the gas, creating plasma. In one or some embodiments, RF power frequency used to produce plasma may be 13.56 MHz. Other frequencies are contemplated, such as 40 kHz and 2.45 GHz.

FIG. 46 further illustrates controller(s) 4270, which may be configured to control any one, any combination, or all of vacuum plasma chamber device 4610, motor(s)/robot(s) 4440, gas injector 4620, or gas pump 4640. For example, controller(s) 4270 may control motor(s)/robot(s) to move formed product 4430 into and/or out of vacuum plasma chamber device 4610. As another example, controller(s) 4270 may control gas pump 4640 in order to pump gas from vacuum plasma chamber device 4610 (e.g., before and/or after plasma treatment). As still another example, controller(s) 4270 may control gas injector 4620 in order to pump gas into vacuum plasma chamber device 4610. As yet another example, controller(s) 4270 may control vacuum plasma chamber device 4610 in order to generate the plasma.

FIG. 47 illustrates an example flow chart 4700 for performing the plasma treatment. At 4710, the formed product to be treated is introduced into the plasma chamber, which is typically a vacuum chamber. The chamber is then evacuated to create a low-pressure environment.

At 4720, the gas is introduced into the vacuum plasma chamber. In one or some embodiment, the gas may comprise argon, oxygen or nitrogen. Further, in one or some embodiments, the gas may be introduced into the vacuum plasma chamber with a flow rate that guarantees a correct process pressure to yield a stable plasma.

At 4730, the plasmas is generated by ionizing the gas. In particular, the gas may be ionized using an electrical signal which may be DC (direct current), RF (radio-frequency) or Microwave, thereby creating a plasma. The plasma may comprise (or consists of) a cloud of ionized gas containing ions, electrons, and neutral atoms or molecules.

At 4740, surface modification is performed using the plasma. In particular, as the plasma comes into contact with the material, the plasma may chemically modify the surface of an outer layer of the formed product. Further, the plasma may be used to add or remove functional groups, increase wettability, or improve adhesion, among other things, of an outer layer of the formed product.

At 4750, the vacuum plasma chamber is brought back to atmospheric pressure and the formed product is removed from the vacuum plasma chamber. In particular, once the desired surface modification has been achieved, the vacuum plasma chamber may be brought back to atmospheric pressure using air or nitrogen gas, and the formed product may then be removed from the vacuum plasma chamber.

Separate from, or in addition, to laser ablation and/or plasma treatment, other processes may be performed. As one example, in one or some embodiments, the flocking process may be a relatively quick process that may immediately change the properties of the printed object/surface, while imparting any one, any combination, or all of the following properties (depending on the flocked fiber/s): textile feel; softness and pleasant touch; wicking effect; tuning/changing surface polarity (e.g., hydrophilic/hydrophobic nature); more natural feel to the skin; breathability; moisture transmission; quick drying; warmth feeling; antibacterial; gradient/gradation of properties in the same product (e.g., by selective flocking); controlled density as a way to tune surface properties; or flexibility in design (custom-made/tailor-made).

Moreover, in one or some embodiments, other properties that may not be recognized with textile applications, but potentially may be improved by flocking a printed article may include any one, any combination, or all of: thermal insulation; electrical conductivity and antistatic behavior; or acoustic absorbance

Clothing created using comfort fibers may include one or more of the desirable qualities of comfort fibers described herein. With the development/progress of new techniques for 3D printing that are based on melt processing, direct extrusion and co-extrusion that are based on robotic arms may be used as a part of the creation process of comfort fibers and textile creation. One aspect includes using one or more robotic arms (as part of one or more robots) for direct extrusion/co-extrusion. In addition to creating the finished material by 3D printing, the filament (comfort fiber) may also be used to make comfort fiber materials utilizing other textile applications such as any one, any combination, or all of bonding, heat press, weaving, knitting, crocheting, braiding, non-woven, and other textile techniques. These techniques may be made with the filament in its original form (e.g., non-printed) or by printing the filament into a yarn, or other geometrical patterns, and using the printed yarn/patterns form for the textile techniques. Additional heating and/or welding and/or bonding techniques (such as heat press, hot air, high frequency welding, adhesives etc.) may be applied to help bonding/welding or set the material and add additional properties.

In one aspect, moisture % regain may be a measure of how pleasant a material feels to the touch. The following is a list of moisture % regain for different materials: wool: 15; cotton: 8.5; ramie: 12; polyester: 0.4; nylon: 4.5; polypropylene: 0; and TPU: 0.4-0.8%. Generally speaking, the higher moisture % regain gives a nicer hand feel.

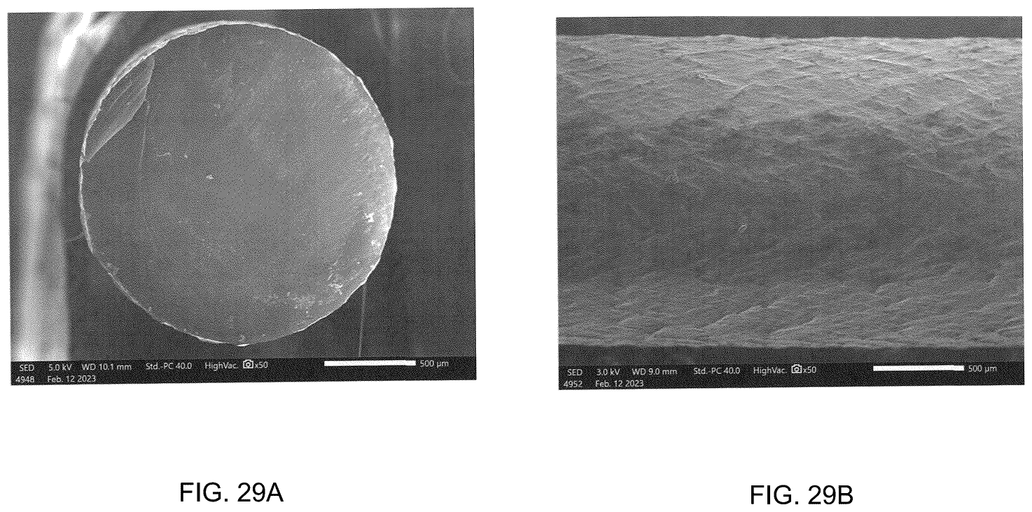

Scanning electron microscope (SEM) images of different kinds of fibers are presented in FIGS. 29A-38B. FIGS. 29A-B depict a monofilament based on TPU. A cross-section view (depicted in FIG. 29A) and an outer surface view (depicted in FIG. 29B) are presented. The cross-section view of a mono-filament based on TPU in FIG. 29A displays a clear and homogeneous cross section, while magnification of the outer surface in FIG. 29B reveals smooth topology, with a minor roughness.

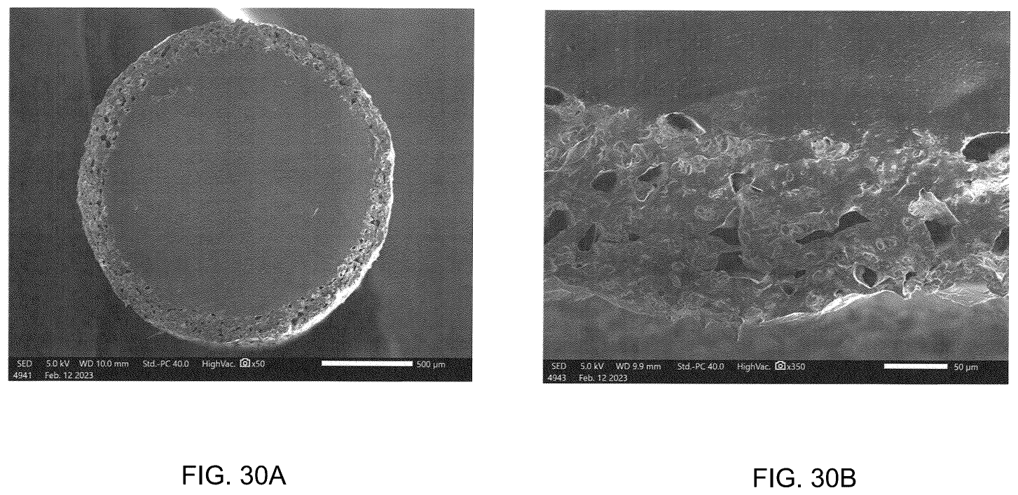

FIGS. 30A-B depict a core/sheath filament with cotton powder in the sheath layer. A cross-section view (depicted in FIG. 30A) and an outer surface view as a magnification of the sheath layer (depicted in FIG. 30B) are presented. The filament presented in FIGS. 30A-B is a 1.75 mm filament. The cross-section view (depicted in FIG. 30A) demonstrates one aspect of the concept of core/sheath, such as the concept of a core encapsulated axially in a sheath. Particles may be clearly seen exclusively in the sheath layer. In the magnified outer surface view of the sheath layer (depicted in FIG. 30B), the cotton particles may be clearly seen inside the sheath layer. Such a filament may be used to construct a comfort filament.

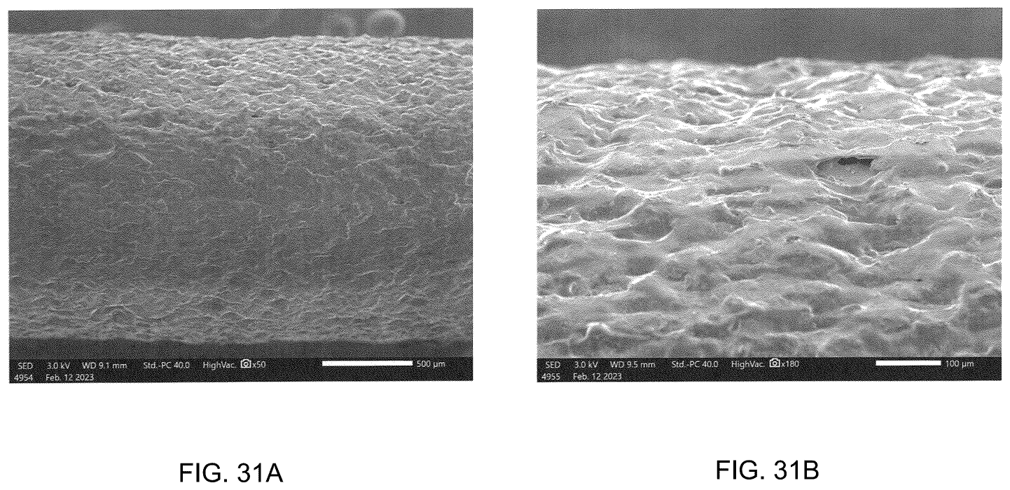

FIGS. 31A-B depict different scaled magnified views of an outer surface of a core/sheath filament with cotton particles (see cotton powder) in the sheath layer. FIG. 31A illustrates a view depicting the outer surface of the filament, demonstrating the roughness created on the periphery of the sheath layer due to the presence of the particles. FIG. 31B illustrates a further magnified view of the outer surface that reveals the roughness topology, which is in the range of micron scale. Such a filament may be used to construct a comfort filament.

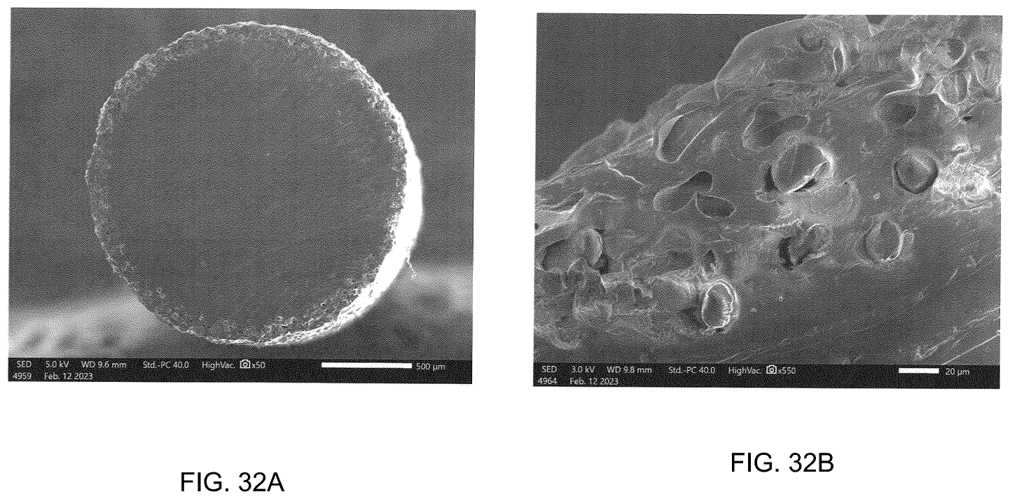

FIGS. 32A-B depict a core/sheath filament with wool particles in the sheath layer. A cross-section view (depicted in FIG. 32A) and an outer surface view (depicted in FIG. 32B) are presented. The filament presented in FIGS. 32A-B is a 1.75 mm filament. The cross-section view (depicted in FIG. 32A) demonstrates one aspect of the concept of core/sheath, such as the concept of a core encapsulated axially in a sheath. In FIG. 32A, particles may be clearly seen exclusively in the sheath layer. In the magnified outer surface view (depicted in FIG. 32B as a magnification of the sheath layer), the wool particles may be clearly seen inside the sheath layer. Such a filament may be used to construct a comfort filament.

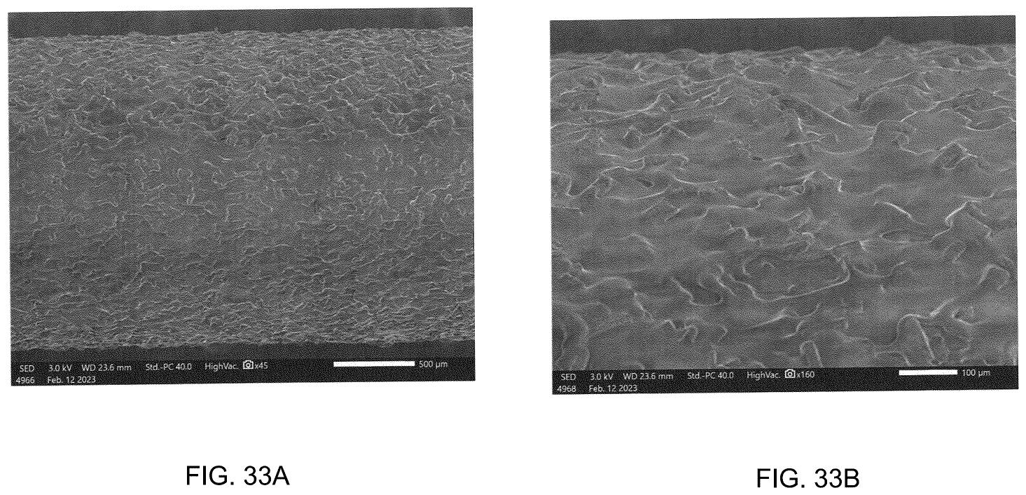

FIGS. 33A-B depict magnified views of an outer surface of a core/sheath filament with wool particles in the sheath layer. FIG. 33A illustrates a view depicting the outer surface of the filament, demonstrating the roughness created on the periphery of the sheath layer due to the presence of the particles. FIG. 33B illustrates a further magnified view of the outer surface that reveals the roughness topology, which is in the range of micron scale. Such a filament may be used to construct a comfort filament.

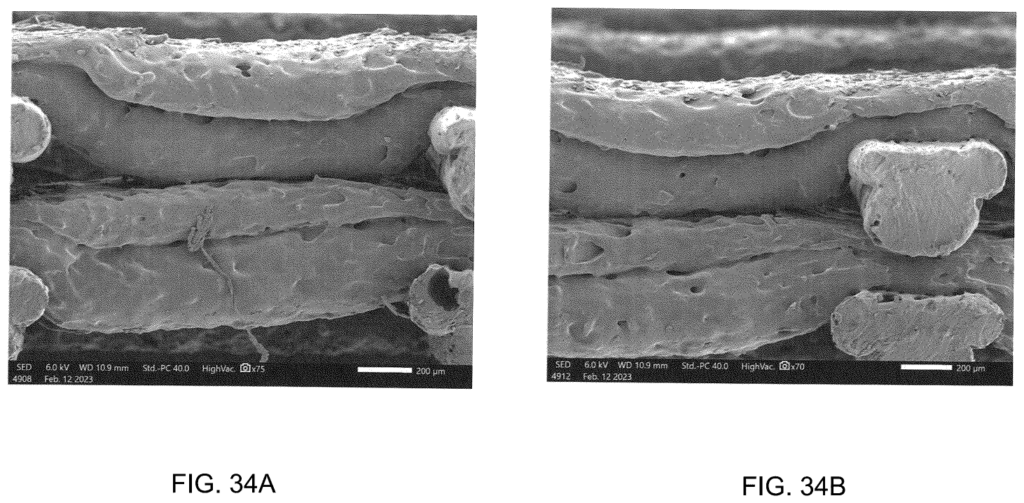

FIGS. 34A-B depict a cross-section view of a 3D printed fabric based on a core/sheath filament (e.g., a comfort filament) with cotton particles in the sheath layer. FIG. 34A illustrates a cross-section of a printed article based on a core/sheath filament, with cotton particles in the sheath layer. In particular, FIG. 34A depicts a cross-section view of a first portion of fabric. More particularly, FIG. 34A depicts a cross-section of a printed article based on core/sheath filament, with cotton particles in the sheath layer. The roughness created by the particles is clearly seen in the outer surface of the printed layers. FIG. 34B illustrates a similar view of a different portion of the fabric. In particular, FIG. 34B depicts a cross-section of a printed article based on core/sheath filament, with cotton particles in the sheath layer. The roughness created by the particles is clearly seen in the outer surface of the printed layers.

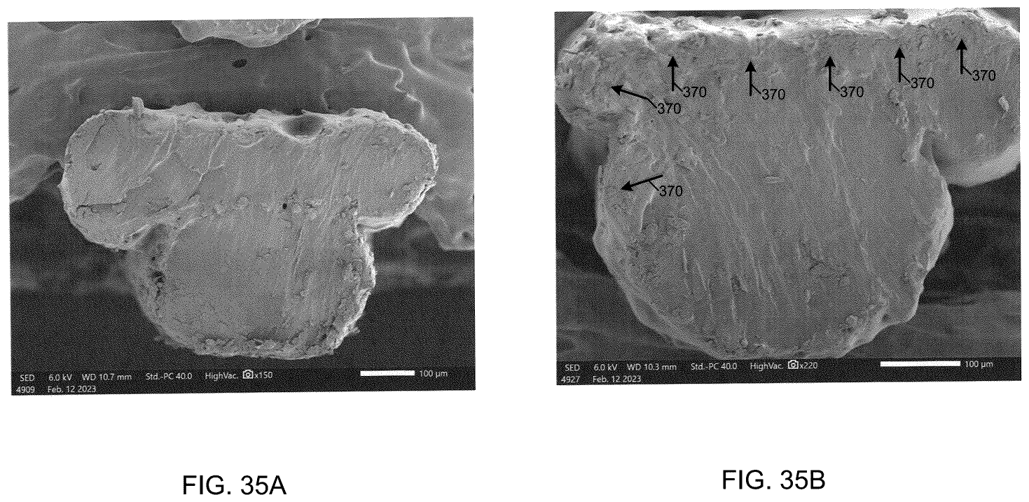

FIGS. 35A-B depict cross-section views of a 3D printed fabric based on a core/sheath filament (e.g., a comfort filament) with cotton particles in the sheath layer. FIG. 35A depicts a cross-section view of a printed article based on a core/sheath filament, with cotton particles in the sheath layer. Particles may be clearly seen in the periphery of the sheath layer. FIG. 35B depicts a magnification of a cross-section view of the printed article. The cotton particles (as shown by arrows 370 in FIG. 35B) may be clearly seen in the periphery and in the outer surface.

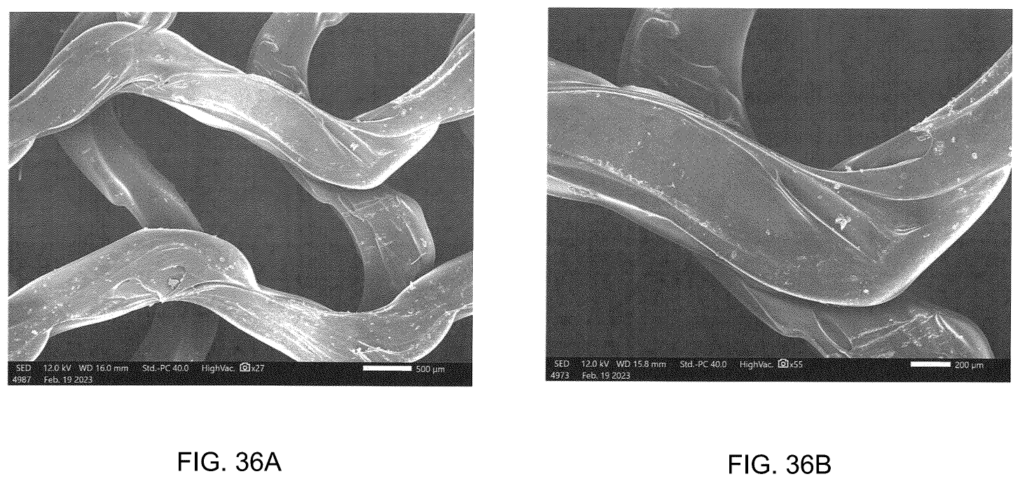

FIGS. 36A-B depict a printed fabric based on a TPU monofilament (e.g., a contemporary filament). FIG. 36A illustrates a top view of a printed article based on TPU mono-filament. The smooth surface of the printed layers may be clearly seen from the photo in FIG. 36A. FIG. 36B illustrates a magnification of the top view, demonstrating the smooth surface of the printed layer.

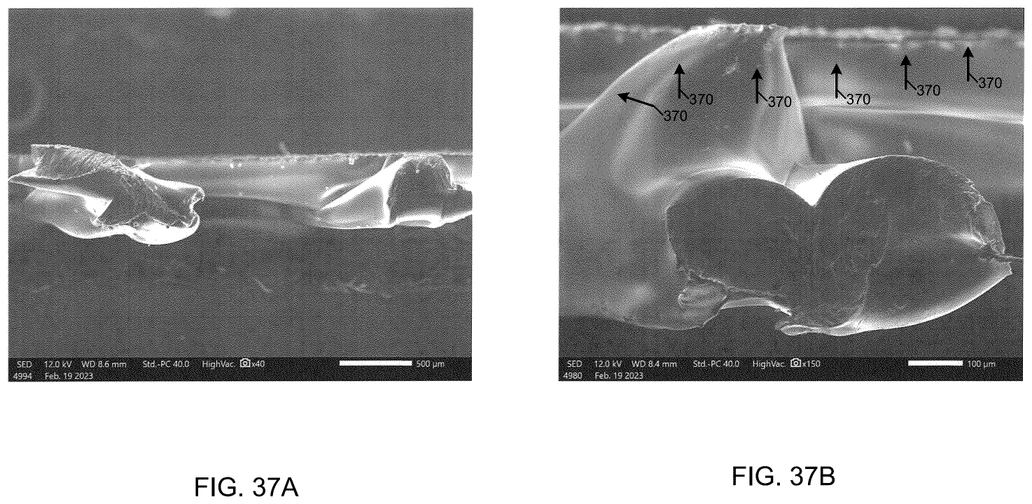

FIGS. 37A-B depict cross-section views of the printed fabric based on a TPU monofilament presented in FIGS. 36A-B. FIG. 37A illustrates a cross-section view of a printed article based on using a TPU monofilament fiber. The outer surface of the filament is smooth, excluding the shear bands that appear on the cross-section due to scissoring of the sample during the preparation process. FIG. 37B illustrates a magnification of the cross-section view of the printed article based on the TPU mono-filament, demonstrating that the outer surface of the printed article is smooth, having a minimum roughness.

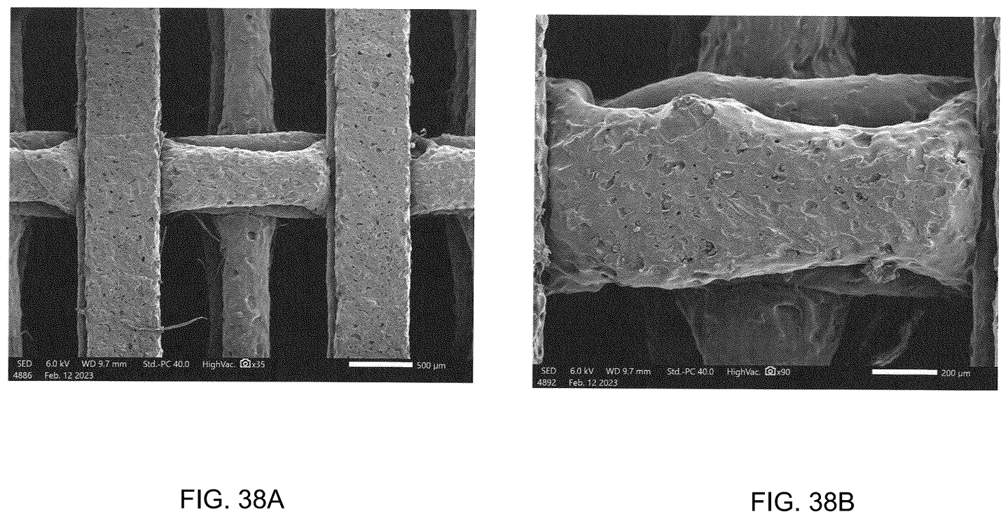

FIGS. 38A-B depict a final product (e.g., a printed fabric) based on a core/sheath filament (e.g., a comfort fiber) with cotton particles in the sheath layer. FIG. 38A illustrates a top view of the printing bed side, with a plurality of layers. FIG. 38A illustrates a top view of the printed article based on the comfort fiber, with cotton particles in the sheath layer. The protruded cotton particles and the high porosity (e.g., holes) created on the surface may expedite the absorption of moisture and water molecules from the skin (e.g., resulting in moisture wicking-like effect). FIG. 38B depicts a magnification of the top view, demonstrating how the particles protrude from the surface and how these particles, together with the porous structure that is created on the surface, expedite the absorption of moisture and/or water molecules from the skin (e.g., resulting in moisture wicking-like effect).

### Chemical Resistance to Sea Water (Salt Water) and Chlorinated Water

Different laboratory tests were performed in order to analyze the effect of different water/aqueous media on the chemical resistance of different comfort filaments. The two mediums that were tested in this aspect were:

(1) sea water (e.g., salt water): chemical resistance was determined using tensile test before and after exposure, measuring the stress (e.g., modulus) at the following elongations: 100, 200 and 300%.

(2) chlorinated water (test executed according to ISO 17608:2015): chemical resistance was determined using tensile test before and after exposure, measuring the stress (e.g., modulus) at the following elongations: 100, 200 and 300%.

The filaments/comfort fibers that tested were: (i) TPU monofilament (Ø=1.75 mm); (ii) Core/sheath filament based on TPU with wool powder in its sheath layer (Ø=1.75 mm); and (iii) Core/sheath filament based on TPU with cotton powder in its sheath layer (Ø=1.75 mm). According to test results, it was found that core/sheath filaments outperform a TPU monofilament in neutral/room conditions (23° C., 50% RH), demonstrating higher modulus at 100, 200 and 300% elongation.

A similar trend is observed in the case of exposing the filaments into sea water medium, with higher modulus at 100, 200 and 300% elongation for both wool and cotton core/sheath filaments. Test results confirm that core/sheath filament have better chemical resistance to sea-water in comparison to a TPU monofilament reflecting higher modulus and dimensional stability.

The core/sheath comfort filament demonstrates a similar trend in chlorinated water, confirming that the addition of wool-based sheath layer may have better chemical resistance in comparison to a TPU monofilament. For all tested chlorinated mediums (according to ISO 17608:2015 standard), the modulus at 100, 200 and 300% elongation is higher for the wool-based sheath layer, meaning that the material may be less sensitive to a chlorinated environment. This, in turn, confirms that the wool-based sheath filament may have better chemical resistance as compared to TPU monofilament. This aspect may offer the advantage that a fabric constructed using the comfort filament technology may outlast a fabric made with conventional TPU fibers. In this regard, environments, such as washing (e.g., laundry), exposure to sea water, etc. may wear out a garment constructed from TPU fibers faster than a garment constructed from comfort fibers.

Concluding from the mentioned above confirm that core/sheath structure may have not only higher modulus and dimensional stability, but may also have improved chemical resistance that is less affected by the tested mediums.

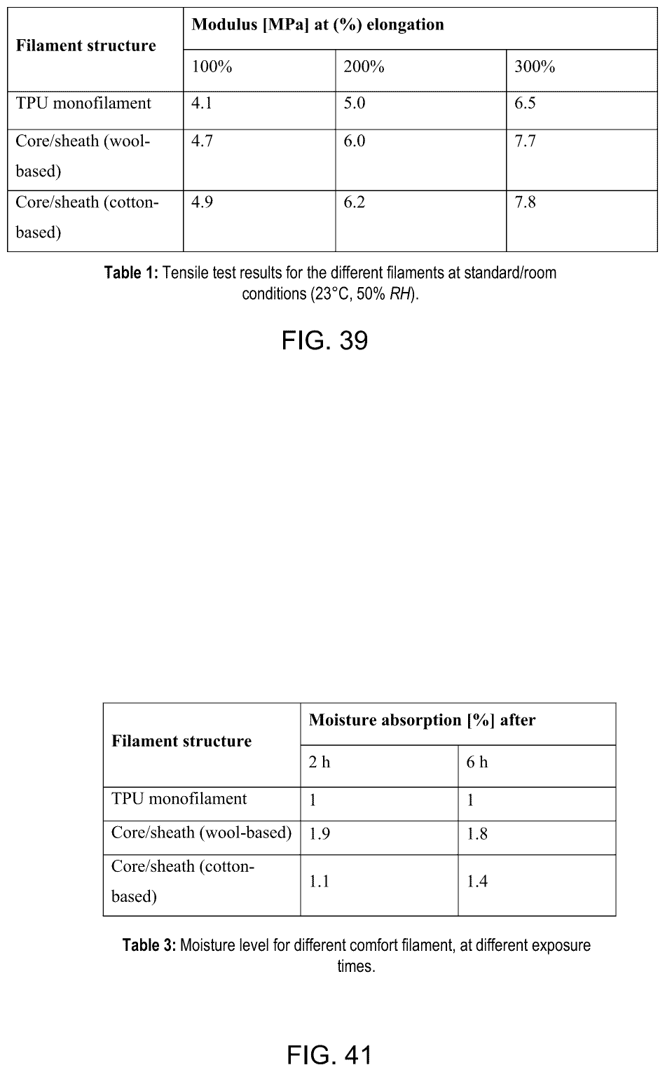

Table 1, as illustrated in FIG. 39, summarizes tensile test results for 100, 200 and 300% elongation at standard conditions (23° C., 50% RH). Data presented as absolute modulus (MPa units).

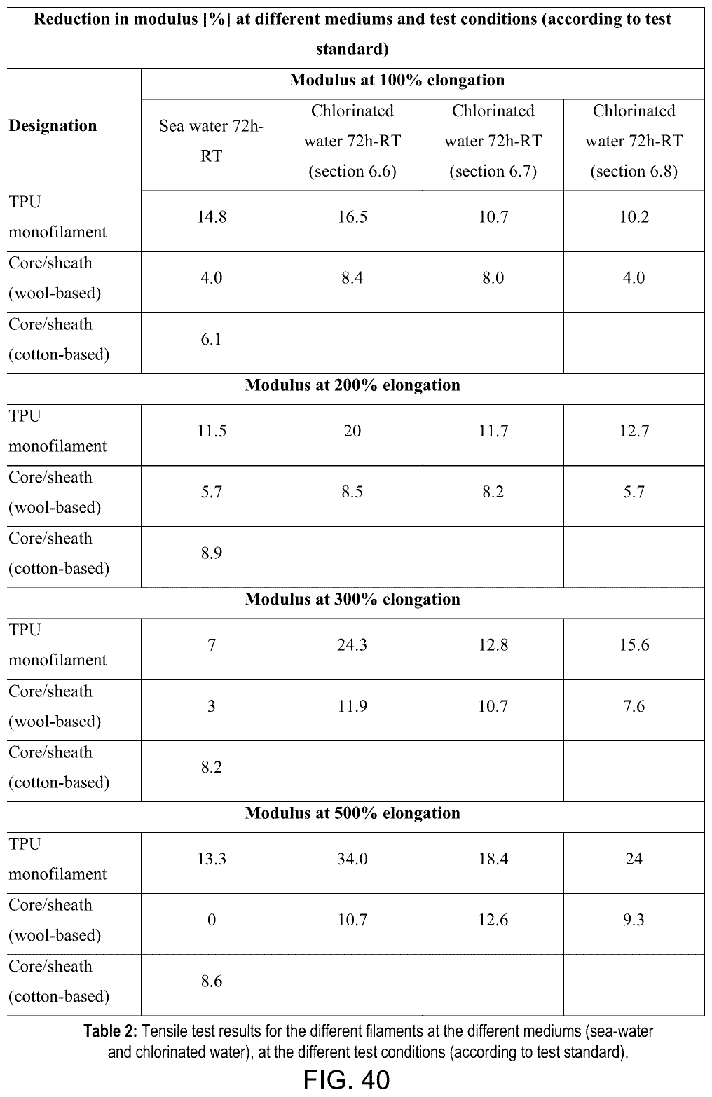

Table 2, as illustrated in FIG. 40, summarizes tensile test results for the chemical resistance to sea-water and chlorinated water, considering the modulus (recorded stress) at 100, 200 and 300% elongation as a measure to chemical resistance. Data (modulus) presented as reduction (%) in modulus in comparison to the reference sample of the same series/filament (23° C., 50% RH).

### Moisture Absorption of Comfort Filaments

The moisture absorption of different comfort filaments was studied in order to investigate any advantages of the core/sheath structure with respect to moisture absorption. Moisture absorption, in turn, may be correlated with the comfort feel of fibers and fabrics.

The test was performed in a humidity chamber, at 40° C. and 95% relative humidity at time periods of 2 h and 6 h. Samples were dried first, weighed, and then introduced into the humidity chamber.

Three different types of filaments/comfort fibers were tested: (i) TPU monofilament (Ø=1.75 mm); (ii) Core/sheath filament based on TPU with wool powder in the sheath layer (Ø=1.75 mm); and (iii) Core/sheath filament based on TPU with cotton powder in its sheath layer (Ø=1.75 mm).

According to test results summarized in Table 3 in FIG. 41, it is seen that core/sheath structure absorbed higher levels of moisture, specifically in the case of wool-based sheath layer that almost double the moisture content (90% higher) in comparison to TPU monofilament. The cotton-based sheath layer also demonstrates higher moisture level in comparison to TPU monofilament, but absorption rate is slower compared to the wool-based layer. This evidence supports the concept that core/sheath filament in the form of a comfort fiber/filament may be an appropriate candidate for textile applications, such as for apparel and skin contact fabrics/fibers due to the associated high moisture absorption.

Considering a maximum moisture absorption value of 0.8% for PET (Polyethylene terephthalate), the test results confirm that the comfort filament may outperform other multifilaments, highlighting their advantages for textile applications.

The present disclosure is not limited to the above embodiments, but may be substantially replaced by a configuration substantially identical to the configuration shown in the above embodiments, a configuration having the same effect, or a configuration capable of achieving the same purpose.

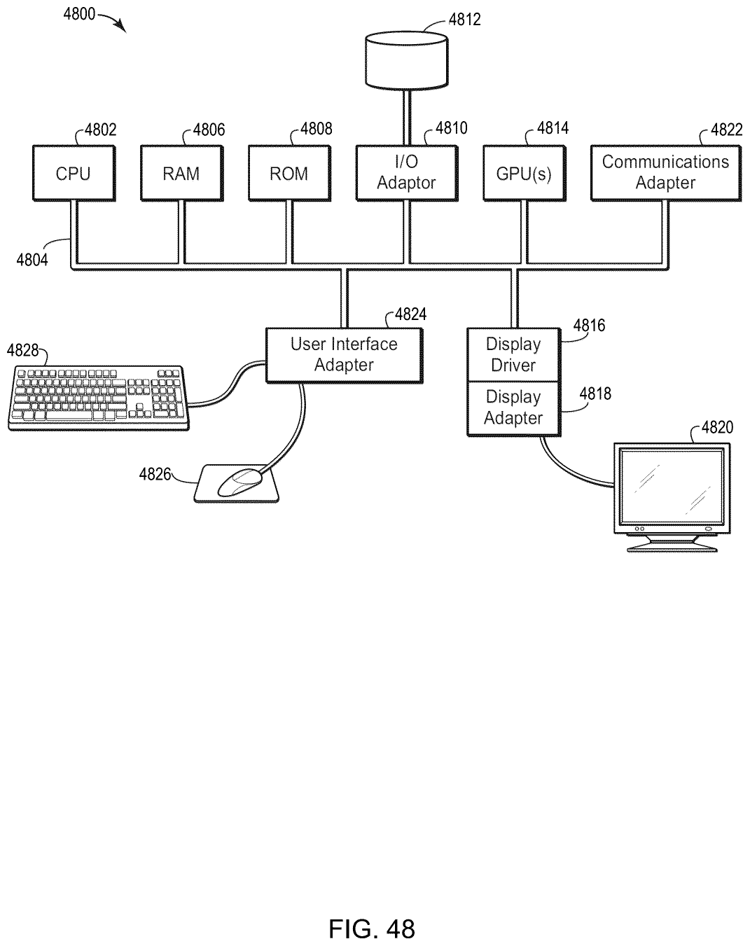

As discussed above, various aspects of processing may be computer-controlled. In this regard, in such computer-controlled applications, the present technological advancement must be used in conjunction with a computer, programmed in accordance with the disclosures herein. Merely by way of example, various devices disclosed in the present application may comprise a computer or may work in combination with a computer (e.g., executed by a computer), such as, for example, in FIGS. 19, 22, 42, 44, and 46. For example, computing functionality may be manifested in the control electronics 285 or controller(s) 4270. As such, computing functionality may be resident within any of the electronic devices discussed herein. Merely by way of example, FIG. 48 is a diagram of an exemplary computer system 4800 that may be utilized to implement methods, including the flow diagrams, described herein. A central processing unit (CPU) 4802 is coupled to system bus 4804. The CPU 4802 may be any general-purpose CPU, although other types of architectures of CPU 4802 (or other components of exemplary computer system 4800) may be used as long as CPU 4802 (and other components of computer system 4800) supports the operations as described herein. Those of ordinary skill in the art will appreciate that, while only a single CPU 4802 is shown in FIG. 48, additional CPUs may be present. Moreover, the computer system 4800 may comprise a networked, multi-processor computer system that may include a hybrid parallel CPU/GPU system. The CPU 4802 may execute the various logical instructions according to various teachings disclosed herein. For example, the CPU 4802 may execute machine-level instructions for performing processing according to the operational flow described herein.

The computer system 4800 may also include computer components such as non-transitory, computer-readable media. Examples of computer-readable media include computer-readable non-transitory storage media, such as a random-access memory (RAM) 4806, which may be SRAM, DRAM, SDRAM, or the like. The computer system 4800 may also include additional non-transitory, computer-readable storage media such as a read-only memory (ROM) 4808, which may be PROM, EPROM, EEPROM, or the like. RAM 4806 and ROM 4808 hold user and system data and programs, as is known in the art. In this regard, computer-readable media may comprise executable instructions to perform any one, any combination, or all of the blocks in the flow charts in FIGS. 23, 28, 43, 45, and 47. The computer system 4800 may also include an input/output (I/O) adapter 4810, a graphics processing unit (GPU) 4814, a communications adapter 4822, a user interface adapter 4824, a display driver 4816, and a display adapter 4818.

The I/O adapter 4810 may connect additional non-transitory, computer-readable media such as storage device(s) 4812, including, for example, a hard drive, a compact disc (CD) drive, a floppy disk drive, a tape drive, and the like to computer system 4800. The storage device(s) may be used when RAM 4806 is insufficient for the memory requirements associated with storing data for operations of the present techniques. The data storage of the computer system 4800 may be used for storing information and/or other data used or generated as disclosed herein. For example, storage device(s) 4812 may be used to store configuration information or additional plug-ins in accordance with the present techniques. Further, user interface adapter 4824 couples user input devices, such as a keyboard 4828, a pointing device 4826 and/or output devices to the computer system 4800. The display adapter 4818 is driven by the CPU 4802 to control the display on a display device 4820 to, for example, present information to the user such as images generated according to methods described herein.

The architecture of computer system 4800 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 4800 may include various plug-ins and library files. Input data may additionally include configuration information.

It is intended that the foregoing detailed description be understood as an illustration of selected forms that the invention may take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

The following example embodiments of the invention are also disclosed:

### Embodiment 1

A core/sheath structure composing a forming material or a formed product which is generated from the forming material, comprising:
a core having a linear shape and an outer peripheral surface and including at least one thermoplastic polymer; and
a sheath at least partly covering the outer peripheral surface and including one or both of fibers or particles.

### Embodiment 2

The core/sheath structure of embodiment 1:
wherein the at least one thermoplastic polymer of the core comprising a first thermoplastic polymer; and
wherein the sheath further includes a second thermoplastic polymer with the one or both of fibers or particles dispersed in the second thermoplastic polymer.

### Embodiment 3

The core/sheath structure of embodiments 1 or 2:

wherein the first thermoplastic polymer and the second thermoplastic polymer are a same type of thermoplastic elastomer.

### Embodiment 4

The core/sheath structure of any of embodiments 1-3:

wherein the first thermoplastic polymer and the second thermoplastic polymer are different types of thermoplastic elastomers.

### Embodiment 5

The core/sheath structure of any of embodiments 1-4:

wherein the sheath further includes a water-soluble substance so that after exposure to water, at least a part of the water-soluble substance is removed in the sheath.

### Embodiment 6

The core/sheath structure of any of embodiments 1-5:

wherein the sheath is entirely covering the outer peripheral surface.

### Embodiment 7

The core/sheath structure of any of embodiments 1-6:
wherein the core/sheath structure composes the forming material; and
at least one of the core and the sheath comprising one or more of a foaming agent and a whipping agent.

### Embodiment 8

The core/sheath structure of any of embodiments 1-7:

wherein the core is a porous body.

### Embodiment 9

The core/sheath structure of any of embodiments 1-8:

wherein at least one of the core or the sheath include a reinforcing component.

### Embodiment 10

The core/sheath structure of any of embodiments 1-9:

wherein the one or both of fibers or particles are natural materials.

### Embodiment 11

The core/sheath structure of any of embodiments 1-10:

wherein the one or both of fibers or particles are synthetic materials.

### Embodiment 12

The core/sheath structure of any of embodiments 1-11:

wherein a diameter of the core is at least five times greater than a thickness of the sheath.

### Embodiment 13

A formed product comprising:
one or more layers, the one or more layers comprising at least one core/sheath structure comprising:
   a core having a linear shape and an outer peripheral surface and including at least one thermoplastic polymer; and
   a sheath at least partly covering the outer peripheral surface and including one or both of fibers or particles.

### Embodiment 14

The formed product of embodiment 13:

wherein the formed product is formed by 3D printing.

### Embodiment 15

The formed product of embodiments 13 or 14:

wherein the formed product is formed by 3D printing using at least one filament with the at least one core/sheath structure.

### Embodiment 16

The formed product of any of embodiments 13-15:
wherein the at least one thermoplastic polymer of the core comprising a first thermoplastic polymer; and
wherein the sheath further includes a second thermoplastic polymer with the one or both of fibers or particles dispersed in the second thermoplastic polymer.

### Embodiment 17

The formed product of any of embodiments 13-16:

wherein the sheath further includes a water-soluble substance so that after exposure to water, at least a part of the water-soluble substance is removed in the sheath.

### Embodiment 18

The formed product of any of embodiments 13-17:

wherein the sheath is entirely covering the outer peripheral surface.

### Embodiment 19

A method (such as an at least partly or an entirely computer-implemented method) for manufacturing a flock product comprising:
arranging an adhesive layer on a surface of a material to be treated composed a forming material including a thermoplastic polymer or a formed product which is a melted and cured product of the forming material;
abutting at least one flock to or piercing the at least one flock into the adhesive layer; and
after abutting the at least one flock to or piercing the at least one flock into the adhesive layer, curing the adhesive layer.

### Embodiment 20

The method of embodiment 19:

wherein the at least one flock is pierced into the adhesive layer.

### Embodiment 21

The method of embodiments 19 or 20:

wherein the at least one flock is pierced into the adhesive layer by electrostatic deposition.

### Embodiment 22

The method of any of embodiments 19-21:

wherein the at least one flock is pierced into the adhesive layer so that, after piercing, the at least one flock at least partly protrudes from the adhesive layer.

### Embodiment 23

The method of any of embodiments 19-22:

wherein the flock includes one or more of fibers and particles.

### Embodiment 24

The method of any of embodiments 19-23:
wherein the material to be treated includes a thermoplastic polyurethane; and
wherein the adhesive layer includes a polyurethane.

### Embodiment 25

A flock product comprising:
a main body having a surface and composed of a forming material including a thermoplastic polymer or a formed product which is a melted and cured product of the forming material;
an adhesive layer arranged on the surface; and
a flock abutting on or pierced into the adhesive layer.

### Embodiment 26

The flock product of embodiment 25:
wherein the flock is pierced into the adhesive layer; and
wherein the flock at least partly protrudes from the adhesive layer.

### Embodiment 27

The flock product of embodiments 25 or 26:

wherein the flock includes one or both of fibers or particles.

### Embodiment 28

The flock product of any of embodiments 25-27:
wherein the main body includes a thermoplastic polyurethane; and
wherein the adhesive layer includes a polyurethane.

### Embodiment 29

A method (such as an at least partly or an entirely computer-implemented method) for producing a filament comprising:
using one or more extruders to extrude a first set of materials for a core of the filament and a second set of materials for a sheath of the filament, wherein the second set of materials comprises at least one or both of fibers or particles;
using a core section and a sheath section of at least one die head in order to route the first set of materials and the second set of materials, respectively, that are extruded from the one or more extruders; and
during or after using the core section and the sheath section of the at least one die head, forming the filament by cooling the first set of materials and the second set of materials.

### Embodiment 30

The method of embodiment 29:
wherein the one or more extruders comprises at least first extruder to melt, mix, and extrude the first set of materials and at least second extruder to melt, mix, and extrude the second set of materials; and
wherein the at least second extruder comprise a twin-screw extruder.

### Embodiment 31

The method of embodiments 29 or 30:

wherein the second set of materials comprises at least one thermoplastic polymer and the at least one or both of the fibers or the particles.

### Embodiment 32

The method of any of embodiments 29-31:

wherein the second set of materials further comprises a water-soluble polymer.

### Embodiment 33

The method of any of embodiments 29-32:

wherein a diameter of the core section of the at least one die head is at least five times greater than a thickness of the sheath section of the at least one die head.

### Embodiment 34

A method (such as an at least partly or an entirely computer-implemented method) for processing a 3D printed formed product, the method comprising:
receiving a formed product that has been 3D printed; and
after receiving the formed product, performing at least one of laser radiation treatment or plasma treatment on the formed product.

### Embodiment 35

The method of embodiment 34:
wherein the formed product comprises one or more layers; and
wherein, after 3D printing the formed product, laser radiation is applied on a surface or an interior of at least one of the one or more layers.

### Embodiment 36

The method of embodiments 34 or 35:
wherein the one or more layers comprises an outer layer with a surface configured to contact skin of a user of the formed product; and
wherein applying the laser radiation comprises laser ablation that forms a pattern on the surface of the outer layer in order to modify a feel of the outer layer when contacting the skin of the user.

### Embodiment 37

The method of any of embodiments 34-36:
wherein the one or more layers comprises an outer layer with a surface configured to contact skin of a user of the formed product; and
wherein applying the laser radiation modifies an interior of the outer layer.

### Embodiment 38

The method of any of embodiments 34-37:

wherein applying the laser radiation comprises laser ablation of at least a part of the interior of the outer layer.

### Embodiment 39

The method of any of embodiments 34-38:
wherein the interior of the outer layer comprises at least one thermoplastic polymer and one or both of fibers or particles; and
wherein the laser ablation comprises removing at least a part of the at least one thermoplastic polymer in order to enhance an effect on skin of a user of the formed product.

### Embodiment 40

The method of any of embodiments 34-39:
wherein the one or more layers comprises an inner layer with a surface that is not configured to contact skin of a user of the formed product; and
wherein the laser radiation is applied to the inner layer of the formed product.

### Embodiment 41

The method of any of embodiments 34-40:

wherein the laser radiation is applied to the inner layer of the formed product in order to ablate at least a part of the inner layer.

### Embodiment 42

The method of any of embodiments 34-41:

wherein ablating the at least a part of the inner layer modifies at least one of moisture management or drapability of the formed product.

### Embodiment 43

The method of any of embodiments 34-42:
wherein the formed product comprises one or more layers; and
wherein, after 3D printing the formed product, the plasma treatment is applied on a surface of at least one of the one or more layers.

### Embodiment 44

The method of any of embodiments 34-43:

wherein the plasma treatment cleans the surface of at least one of the one or more layers.

### Embodiment 45

An apparatus configured to process a 3D printed formed product, the apparatus comprising:
at least one of a laser radiation device or a plasma treatment device configured to receive a formed product 3D printed from at least one 3D printer; and
at least one controller configured to control the at least one of the laser radiation device or the plasma treatment device in order to apply laser radiation or plasma treatment on the formed product.

### Embodiment 46

The apparatus of embodiment 45:
wherein the formed product comprises one or more layers; and
wherein the at least one controller is configured to control the laser radiation device to apply laser radiation on a surface or an interior of at least one of the one or more layers.

### Embodiment 47

The apparatus of embodiments 45 or 46:
wherein the one or more layers comprises an outer layer with a surface configured to contact skin of a user of the formed product; and
wherein the at least one controller is configured to control the laser radiation device to apply the laser radiation by laser ablating that forms a pattern on the surface of the outer layer in order to modify a feel of the outer layer when contacting the skin of the user.

### Embodiment 48

The apparatus of any of embodiments 45-47:
wherein the one or more layers comprises an outer layer with a surface configured to contact skin of a user of the formed product; and
wherein the at least one controller is configured to control the laser radiation device to apply the laser radiation in order to modify an interior of the outer layer.

### Embodiment 49

The apparatus of any of embodiments 45-48:

wherein the at least one controller is configured to control the laser radiation device to apply the laser radiation by laser ablating at least a part of the interior of the outer layer.

### Embodiment 50

The apparatus of any of embodiments 45-49:
wherein the interior of the outer layer comprises at least one thermoplastic polymer and one or both of fibers or particles; and
wherein the at least one controller is configured to control the laser radiation device to remove at least a part of the at least one thermoplastic polymer in order to enhance an effect on skin of a user of the formed product.

### Embodiment 51

The apparatus of any of embodiments 45-50:
wherein the one or more layers comprises an inner layer with a surface that is not configured to contact skin of a user of the formed product; and
wherein the at least one controller is configured to control the laser radiation device to apply the laser radiation to the inner layer of the formed product.

### Embodiment 52

The apparatus of any of embodiments 45-51:

wherein the at least one controller is configured to control the laser radiation device to apply the laser radiation to the inner layer of the formed product in order to ablate at least a part of the inner layer.

### Embodiment 53

The apparatus of any of embodiments 45-52:

wherein the at least one controller is configured to control the laser radiation device to apply the laser radiation to modify at least one of moisture management or drapability of the formed product.

### Embodiment 54

The apparatus of any of embodiments 45-53:
wherein the formed product comprises one or more layers; and
wherein the at least one controller is configured to control the plasma treatment device in order to apply the plasma treatment on a surface of at least one of the one or more layers.

### Embodiment 55

A core/sheath structure composing a forming material or a formed product which is generated from the forming material, comprising:
a core having a linear shape and an outer peripheral surface and including at least one thermoplastic polymer; and
a sheath at least partly covering the outer peripheral surface and including: (i) one or both of fibers or particles; and (ii) at least one of: a soluble substance; an antimicrobial substance; an ultraviolet protection substance; an odor management substance; or a moisture management substance.

### Embodiment 56

The core/sheath structure of embodiment 55:
wherein the core/sheath structure is configured for 3D printing; and
wherein the sheath includes a water-soluble substance.

### Embodiment 57

The core/sheath structure of embodiments 55 or 56:

wherein the water-soluble substance comprises polyvinyl alcohol.

What is claimed is:

1. A core/sheath structure composing a forming material or a formed product which is generated from the forming material, comprising:
a core having a linear shape and an outer peripheral surface and including at least one thermoplastic polymer; and
a sheath at least partly covering the outer peripheral surface and including one or both of fibers or particles.

2. The core/sheath structure of claim 1, wherein the at least one thermoplastic polymer of the core comprising a first thermoplastic polymer; and
wherein the sheath further includes a second thermoplastic polymer with the one or both of fibers or particles dispersed in the second thermoplastic polymer.

3. The core/sheath structure of claim 2, wherein the first thermoplastic polymer and the second thermoplastic polymer are a same type of thermoplastic elastomer.

4. The core/sheath structure of claim 2, wherein the first thermoplastic polymer and the second thermoplastic polymer are different types of thermoplastic elastomers.

5. The core/sheath structure of claim 2, wherein the sheath further includes a water-soluble substance so that after exposure to water, at least a part of the water-soluble substance is removed in the sheath.

6. The core/sheath structure of claim 1, wherein the sheath is entirely covering the outer peripheral surface.

7. The core/sheath structure of claim 1, wherein the core/sheath structure composes the forming material; and
at least one of the core and the sheath comprising one or more of a foaming agent and a whipping agent.

8. The core/sheath structure of claim 1, wherein at least one of the core or the sheath include a reinforcing component.

9. The core/sheath structure of claim 1, wherein the one or both of fibers or particles are one or both of natural materials or synthetic materials.

10. The core/sheath structure of claim 1, wherein a diameter of the core is at least five times greater than a thickness of the sheath.

11. A formed product comprising:
one or more layers, the one or more layers comprising at least one core/sheath structure comprising:
a core having a linear shape and an outer peripheral surface and including at least one thermoplastic polymer; and
a sheath at least partly covering the outer peripheral surface and including one or both of fibers or particles.

12. The formed product of claim 11, wherein the formed product is formed by 3D printing.

13. The formed product of claim 11, wherein the formed product is formed by 3D printing using at least one filament with the at least one core/sheath structure.

14. The formed product of claim 13, wherein the at least one thermoplastic polymer of the core comprising a first thermoplastic polymer; and
wherein the sheath further includes a second thermoplastic polymer with the one or both of fibers or particles dispersed in the second thermoplastic polymer.

15. The formed product of claim 12, wherein the sheath further includes a water-soluble substance so that after exposure to water, at least a part of the water-soluble substance is removed in the sheath.

16. The formed product of claim 12, wherein the sheath is entirely covering the outer peripheral surface.

17. A method for producing a filament comprising:
using one or more extruders to extrude a first set of materials for a core of the filament and a second set of materials for a sheath of the filament, wherein the second set of materials comprises at least one or both of fibers or particles;
using a core section and a sheath section of at least one die head in order to route the first set of materials and the second set of materials, respectively, that are extruded from the one or more extruders; and
during or after using the core section and the sheath section of the at least one die head, forming the filament by cooling the first set of materials and the second set of materials.

18. The method of claim 17, wherein the one or more extruders comprises at least first extruder to melt, mix, and extrude the first set of materials and at least second extruder to melt, mix, and extrude the second set of materials; and
wherein the at least second extruder comprise a twin-screw extruder.

19. The method of claim 18, wherein the second set of materials comprises at least one thermoplastic polymer and the at least one or both of the fibers or the particles.

20. The method of claim 19, wherein the second set of materials further comprises a water-soluble polymer.
